(19) United States
(12) Patent Application Publication
(10) Pub. No.: US 2019/0244461 A1
(43) Pub. Date: Aug. 8, 2019

(54) Chamber having at least one remotely controlled door and system for securely passing or delivering goods or securely passing people

(71) Applicant: Gopal Nandakumar, San Antonio, TX (US)

(72) Inventor: Gopal Nandakumar, San Antonio, TX (US)

(21) Appl. No.: 16/268,077

(22) Filed: Feb. 5, 2019

Related U.S. Application Data
(63) Continuation of application No. PCT/US17/45799, filed on Aug. 7, 2017.
(60) Provisional application No. 62/371,530, filed on Aug. 5, 2016.
(60) Provisional application No. 62/371,506, filed on Aug. 5, 2016.
(60) Provisional application No. 62/371,518, filed on Aug. 5, 2016.

(51) Int. Cl. G07C 9/00; G06K 9/00

(52) U.S. Cl. CPC G07C 9/00912; G07C 2009/0092; G06K 9/00369; G07C 9/00158

(57) ABSTRACT

The present invention relates to a security chamber and system for 1) passage or delivery of goods between a seller and buyer; 2) passage of goods, with or without a scan, between an unsecured location and a secured location; and 3) passage of persons, with or without a scan, between an unsecured location and a secured location using at least one remotely controlled doors and authorization codes. In accordance with the foregoing objects, an embodiment of the present invention generally comprises a service provider, a service client, an operator (seller or inspector), an end user (buyer or end user), and at least one chamber having at least one remotely controlled electronic door in communication with a service provider, service client, and/or operator.

### CROSS REFERENCES TO RELATED APPLICATIONS

This application claims the benefit of PCT Application Serial No. PCT/US17/45799 filed Aug. 7, 2017, which is an international application that claims the benefit of and priority to U.S. Provisional Application Ser. No. 62/371,530 filed Aug. 5, 2016 entitled Electronic Security Storage Stations With One Or More Electronic Security Storage Boxes With One Or More Remotely Controlled Electronic Doors, Accessible To One Or More Users; U.S. Provisional Application Ser. No. 62/371,506 filed Aug. 5, 2016 entitled Self-service security goods scanning stations with one or more self-service security goods scanner chambers with two or more remotely controlled electronic doors, accessible to one or more users with or without one or more security x-ray scanners; and U.S. Provisional Application Ser. No. 62/371,518 filed Aug. 5, 2016 entitled Self-service security body scanning stations with one or more self-service security body scanner chambers with three or more remotely controlled electronic doors, accessible to one or more users, and with one or more security body scanners; which are all incorporated by reference herein.

### STATEMENT REGARDING FEDERALLY SPONSORED RESEARCH OR DEVELOPMENT

Not applicable.

### FIELD OF THE INVENTION

The present invention relates to a chamber or box and a system for providing access to the chamber or box upon the generation and acceptance of an authorization code.

### BACKGROUND OF THE INVENTION

Handing over goods by sellers to buyers is an essential part of any sales transaction. Generally, unless an item is delivered to an office or residence, there is a requirement for an agent of the seller to physically hand over the goods to the buyer or buyer's agent. For a retailer this requires substantial or inefficient employee time as a retailer must wait for the buyer to pick up the goods. For example, in the restaurant environment, a buyer may order, and pay for, a take-out order through the internet or telephone. When the order is ready, an employee of the retailer must physically handover the goods to the buyer once the buyer arrives. This is inefficient use of employee time as it cannot always be planned when a buyer will arrive for their goods. As a result, an employee may be busy doing something else when a buyer arrives to pick up goods causing inherent inefficiencies of time. Moreover, buyers may have inefficient use of their time as they still must wait in a line to pick up their orders. Buyers must do this even if they paid for the order during the ordering process. There is additional risk and inefficiency in the shipping environment. If a delivery requires a signature, generally due to need for proof of delivery or security, the shipper must hope the buyer is present at the designated location or otherwise make subsequent return trips. If a signature is not required, the shipper and retailer run the risk of the delivered goods being stolen or damaged by weather if the goods are left in the elements.

An essential part of any security check point process is securing and authorizing goods and users to pass from unsecured areas to secured areas. Goods are typically placed on conveyor belts that pass through security x-ray scanners whereas persons pass through metal detectors or separate body scanners. Because of the space constraint to accommodate conveyor belts, x-ray scanners, and security body scanners, only a few of each modality may be present and are often paired together. This slows the security process significantly.

Furthermore, the goods passing through the security check point cannot be positively linked (or attached) to the person passing the goods through the security check point. If the goods passing through security check points become separated from the persons also passing through security check points, the said goods may be vulnerable for mishandling or become lost.

It is the object of the present invention to provide a system and related method by which goods or people may be stored and/or passed through an unsecured area to a secured area using a chamber having specific authorization codes to permit unlocking and locking door(s) on the security chamber. Also, if body scanning images positively linked to users are available, then by integrating goods scanning images scanned in accordance with the present invention with the said body scanning images, both goods and body scanning images may be positively linked to users passing through the secured check points which may improve the quality of check point security considerably.

### BRIEF SUMMARY OF THE INVENTION

The present invention relates to a security chamber and system for 1) passage or delivery of goods between a seller and buyer; 2) passage of goods, with or without a scan, between an unsecured location and a secured location; and 3) passage of persons, with or without a scan, between an unsecured location and a secured location using at least one remotely controlled doors and authorization codes. In accordance with the foregoing objects, an embodiment of the present invention generally comprises a service provider, a service client, an operator (seller or inspector), an end user (buyer or end user), and at least one chamber having at least one remotely controlled electronic door in communication with a service provider, service client, and/or operator.

One embodiment relates to an electronic goods pick-up box system for secure transfer of goods from a service client (i.e. merchant) through an operator (employee or shipping agent) to an end user (i.e. buyer). This embodiment comprises at least one goods pick-up box having at least one remotely controlled electronic doors accessible to interior of the goods pick-up box. This embodiment generally comprises a means for service clients to 1) assign a unique external and internal identification number to each goods pick-up box and each remotely controlled electronic door connected to the goods pick-up box; 2) register the external and internal identifiers of goods pick-up boxes with a service provider; 3) register sellers with the service provider; 4) to update sellers profile; and 5) register a transaction number and a one-time authorization code with the service provider. This embodiment further comprises a means for operators (sellers) to 1) update profile information; 2) request for a one-time authorization code for each transaction; 3) select an available electronic goods pick-up box; 4) place the sold goods in the selected electronic goods pick-up box; 5) lock all the remotely controlled electronic doors connected to the goods pick-up box; and 6) register a transaction number, the external identifier of an electronic goods pick-up box, and a one-time authorization code assigned for the transaction with the service provider. This embodiment further comprises a means for buyers to 1) receive the external identifier of the goods pick-up box and a one-time authorization code from the seller and/or service provider; 2) access the selected goods pick-up box with the one-time authorization code; and 3) pick up the sold goods from the goods pick-up box.

Another embodiment relates to a system for a self-serve security scanning station for goods to permit the secure passing of goods from an unsecured area to a secured area. This embodiment comprises at least one scanning chamber having at least two remotely controlled electronic doors accessible to interior of the scanning chamber wherein the scanning chamber may have at least one security x-ray scanners for scanning the interior. This embodiment generally comprises a means for service clients to 1) assign a unique external and internal identification number to each scanning chamber and each remotely controlled electronic door connected to the scanning chamber; 2) register the external and internal identifiers of scanning chamber with a service provider; 3) register inspectors with the service provider; and 4) update inspectors' profiles. This embodiment further comprises a means for inspectors to 1) update profile information; 2) identify available scanning chambers; 3) lock all remotely controlled electronic doors connected to any scanning chamber; 4) view some or all of the authentication credentials of an end user; and 5) authorize or deny the passage of the goods. This embodiment further comprises a means for end users to 1) locate an available scanning chamber from an unsecured area; 2) submit to the scanning chamber from the unsecured area end user credentials to positively identify the end user; 3) securely unlock the remotely controlled electronic door of the scanning chamber facing the unsecured area; 4) securely place the goods from unsecured area into the scanning chamber; 5) securely lock the door of scanning chamber facing the unsecured area; 6) submit to the scanning chamber from the secured area end user credentials to positively identify the end user; 7) securely unlock the door of scanning chamber facing the secured area; and 8) securely pick-up the goods from the scanning chamber from the secured area.

Another embodiment relates to a system for a self-serve security body scanning to permit the secure passage of a person from an unsecured area to a secured area. This embodiment comprises at least one scanning chamber having at least three remotely controlled electronic doors accessible to interior of the scanning chamber wherein the scanning chamber may have at least one security body scanners for scanning the interior. This embodiment generally comprises a means for service clients to 1) assign a unique external and internal identification number to each scanning chamber and each remotely controlled electronic door connected to the scanning chamber; 2) register the external and internal identifiers of scanning chamber with a service provider; 3) register inspectors with the service provider; and 4) update inspectors' profiles. This embodiment further comprises a means for inspectors to 1) update profile information; 2) identify available scanning chambers; 3) lock all remotely controlled electronic doors connected to any scanning chamber; 4) scan and/or view the images captured by one or more security body scanners attached to the scanning chamber; 5) view some or all of the authentication credentials of an end user; and 6) authorize or deny the passage of the end user. This embodiment further comprises a means for end users to 1) locate an available scanning chamber from an unsecured area; 2) submit to the scanning chamber from the unsecured area end user credentials to positively identify the end user; 3) securely unlock the remotely controlled electronic door of the scanning chamber facing the unsecured area; 4) securely enter from unsecured area into the scanning chamber; 5) securely lock the door of scanning chamber facing the unsecured area; 6) perform a self-service body scan; 7) securely unlock the door of scanning chamber facing the secured area or the door facing the holding area; and 8) securely exit the scanning chamber into the secured area or holding area.

### BRIEF DESCRIPTION OF THE SEVERAL VIEWS OF THE DRAWINGS

FIG. 1-1 is a user case diagram showing the basic functionality implemented for the electronic goods pick-up box system and method embodiment.

FIG. 1-2 is a flow chart showing the various steps to add/update an electronic goods pick-up box for the electronic goods pick-up box system and method embodiment.

FIG. 1-3 is a flow chart showing the various steps to add/update sellers for the electronic goods pick-up box system and method embodiment.

FIG. 1-4 is a flow chart showing the various steps to update a seller's profile for the electronic goods pick-up box system and method embodiment.

FIG. 1-5 is a flow chart showing the various steps to request an authorization code for the electronic goods pick-up box system and method embodiment.

FIG. 1-6 is a flow chart showing the various steps for a seller to update pick-up ready information for the electronic goods pick-up box system and method embodiment.

FIG. 1-7 is a flow chart showing the various steps for a buyer to open the electronic goods pick-up box for the electronic goods pick-up box system and method embodiment.

FIG. 1-8 are embodiments of an electronic goods pick-up box for the electronic goods pick-up box system and method embodiment.

FIG. 1-9 is a schematic diagram of an electronic kit for the electronic goods pick-up box system and method embodiment.

FIG. 1-10 is a schematic diagram of a network for the electronic goods pick-up box system and method embodiment.

FIG. 1-11 is a class diagram of a representative service client database for the electronic goods pick-up box system and method embodiment.

FIG. 1-12 is a class diagram of a representative electronic goods pick-up box database for the electronic goods pick-up box system and method embodiment.

FIG. 1-13 is a class diagram of a representative seller database for the electronic goods pick-up box system and method embodiment.

FIG. 1-14 is a class diagram of a representative authorization code database for the electronic goods pick-up box system and method embodiment.

FIGS. 1-15L and 1-15 are class diagrams of a representative form to update service client and corresponding login form for the electronic goods pick-up box system and method embodiment.

FIGS. 1-16L and 1-16 are class diagrams of a representative form to add/update electronic goods pick-up boxes and corresponding login form for the electronic goods pick-up box system and method embodiment.

FIGS. 1-17L and 1-17 are class diagrams of a representative form to add/update sellers and corresponding login form for the electronic goods pick-up box system and method embodiment.

FIGS. 1-18L and 1-18 are class diagrams of a representative form to update sellers' profiles and corresponding login form for the electronic goods pick-up box system and method embodiment.

FIGS. 1-19L and 1-19 are class diagrams of a representative form to request an authorization code and corresponding login form for the electronic goods pick-up box system and method embodiment.

FIG. 1-20 is a sample receipt provided to a buyer for the electronic goods pick-up box system and method embodiment.

FIGS. 1-21L and 1-21 are class diagrams of a representative form to add pickup ready information and corresponding login form for the electronic goods pick-up box system and method embodiment.

FIG. 1-22 is a sample display monitor for the electronic goods pick-up box system and method embodiment.

FIG. 1-23 is a sample arrangement of electronic goods pickup box station for the electronic goods pick-up box system and method embodiment.

FIG. 1-24 is a deployment diagram of an exemplary hardware and software implementation for the electronic goods pick-up box system and method embodiment.

FIG. 1-25 is a deployment diagram of an exemplary user interface for use in connection with the exemplary hardware and software implementation for the electronic goods pick-up box system and method embodiment.

FIG. 2-1 is a user case diagram showing the basic functionality implemented for the self-serve security scanning station for goods embodiment.

FIG. 2-2 is a flow chart showing the various steps to add/update scanning chamber for the self-serve security scanning station for goods embodiment.

FIG. 2-3 is a flow chart showing the various steps to add/update inspectors for the self-serve security scanning station for goods embodiment.

FIG. 2-4 is a flow chart showing the various steps to update an inspector's profile for the self-serve security scanning station for goods embodiment.

FIG. 2-5 is a flow chart showing the various steps for an end user to load goods for the self-serve security scanning station for goods embodiment.

FIG. 2-6 is a flow chart showing the various steps for an inspector to verify the loaded goods for the self-serve security scanning station for goods embodiment.

FIG. 2-7 is a flow chart showing the various steps for an end user to retrieve goods for the self-serve security scanning station for goods embodiment.

FIG. 2-8 are embodiments of a scanning chamber for the self-serve security scanning station for goods embodiment.

FIG. 2-9 is a schematic diagram of an electronic kit for the self-serve security scanning station for goods embodiment.

FIG. 2-10 is a schematic diagram of a network for the self-serve security scanning station for goods embodiment.

FIG. 2-11 is a class diagram of a representative service client database for the self-serve security scanning station for goods embodiment.

FIG. 2-12 is a class diagram of a representative scanner chamber database for the self-serve security scanning station for goods embodiment.

FIG. 2-13 is a class diagram of a representative inspector database for the self-serve security scanning station for goods embodiment.

FIG. 2-14 is a class diagram of a representative authorization code database for the self-serve security scanning station for goods embodiment.

FIGS. 2-15L and 2-15 are class diagrams of a representative form to update service client and corresponding login form for the self-serve security scanning station for goods embodiment.

FIGS. 2-16L and 2-16 are class diagrams of a representative form to add/update scanning chambers and corresponding login form for the self-serve security scanning station for goods embodiment.

FIGS. 2-17L and 2-17 are class diagrams of a representative form to add/update inspectors and corresponding login form for the self-serve security scanning station for goods embodiment.

FIGS. 2-18L and 2-18 are class diagrams of a representative form to update inspectors' profiles and corresponding login form for the self-serve security scanning station for goods embodiment.

FIG. 2-19 is a class diagram of a representative procedure for end users to load goods for the self-serve security scanning station for goods embodiment.

FIGS. 2-20L and 2-20 are class diagrams of a representative form for inspectors to verify goods and corresponding login form for the self-serve security scanning station for goods embodiment.

FIG. 2-21 is a class diagram of a representative procedure for end users to retrieve goods for the self-serve security scanning station for goods embodiment.

FIGS. 2-22U and 2-22S are a sample arrangement of scanning chambers in unsecured and secured area for the self-serve security scanning station for goods embodiment.

FIG. 2-23 is a flow chart showing the various steps to add/create a QR code for the self-serve security scanning station for goods embodiment.

FIG. 2-24 is a class diagram of a representative QR code database for the self-serve security scanning station for goods embodiment.

FIGS. 2-25L and 2-25 are class diagrams of a representative form to request a QR code and corresponding login form for the self-serve security scanning station for goods embodiment.

FIG. 2-26 is a deployment diagram of an exemplary hardware and software implementation for the self-serve security scanning station for goods embodiment.

FIG. 2-27 is a deployment diagram of an exemplary user interface for use in connection with the exemplary hardware and software implementation for the self-serve security scanning station for goods embodiment.

FIG. 3-1 is a user case diagram showing the basic functionality implemented for the self-serve security body scanning station embodiment.

FIG. 3-2 is a flow chart showing the various steps to add/update scanning chamber for the self-serve security body scanning station embodiment.

FIG. 3-3 is a flow chart showing the various steps to add/update inspectors for the self-serve security body scanning station embodiment.

FIG. 3-4 is a flow chart showing the various steps to update an inspector's profile for the self-serve security body scanning station embodiment.

FIG. 3-5 is a flow chart showing the various steps for an end user to enter the scanning chamber for the self-serve security body scanning station embodiment.

FIG. 3-6 is a flow chart showing the various steps for an inspector to approve end user admission into the security scanner for the self-serve security body scanning station embodiment.

FIG. 3-7 is a flow chart showing the various steps for an end user to exit the scanning chamber for the self-serve security body scanning station embodiment.

FIGS. 3-8U and 3-8S are embodiments of a scanning chamber for the self-serve security body scanning station embodiment.

FIG. 3-9 is a schematic diagram of an electronic kit for the self-serve security body scanning station embodiment.

FIG. 3-10 is a schematic diagram of a network for the self-serve security body scanning station embodiment.

FIG. 3-11 is a class diagram of a representative service client database for the self-serve security body scanning station embodiment.

FIG. 3-12 is a class diagram of a representative scanner chamber database for the self-serve security body scanning station embodiment.

FIG. 3-13 is a class diagram of a representative inspector database for the self-serve security body scanning station embodiment.

FIG. 3-14 is a class diagram of a representative authorization code database for the self-serve security body scanning station embodiment.

FIGS. 3-15L and 3-15 are class diagrams of a representative form to update service client and corresponding login form for the self-serve security body scanning station embodiment.

FIGS. 3-16L and 3-16 are class diagrams of a representative form to add/update scanning chambers and corresponding login form for the self-serve security body scanning station embodiment.

FIGS. 3-17L and 3-17 are class diagrams of a representative form to add/update inspectors and corresponding login form for the self-serve security body scanning station embodiment.

FIGS. 3-18L and 3-18 are class diagrams of a representative form to update inspectors' profiles and corresponding login form for the self-serve security body scanning station embodiment.

FIGS. 3-19L and 3-19 are class diagrams of a representative form for end user admission into the scanning chamber and corresponding login form for the self-serve security body scanning station embodiment.

FIGS. 3-20U, 3-20S, 3-20H are class diagrams of a representative procedure for end users use of the scanning chamber for the self-serve security body scanning station embodiment.

FIG. 3-21 is a sample arrangement of scanning chambers in unsecured, secured and holding areas for the self-serve security body scanning station embodiment.

FIG. 3-22 is a flow chart showing the various steps to add/create a QR code for the self-serve security body scanning station embodiment.

FIG. 3-23 is a class diagram of a representative QR code database for the self-serve security body scanning station embodiment.

FIGS. 3-24L and 3-24 are class diagrams of a representative form to request a QR code and corresponding login form for the self-serve security body scanning station embodiment.

FIG. 3-25 is a deployment diagram of an exemplary hardware and software implementation for the self-serve security body scanning station embodiment.

FIG. 3-26 is a deployment diagram of an exemplary user interface for use in connection with the exemplary hardware and software implementation for the self-serve security body scanning station embodiment.

### DETAILED DESCRIPTION OF THE INVENTION

Unless otherwise specified, communication as used in this disclosure refers to direct and/or wireless means. Although those of ordinary skill in the art will readily recognize many alternative embodiments especially in light of the illustrations provided herein, this detailed description is exemplary of the preferred embodiments of the present invention, the scope of which is limited only by the claims appended hereto.

### First Embodiment

This embodiment relates to an electronic goods pick-up box system for secure transfer of goods from a service client, through a seller, to a buyer utilizing a goods pick-up box having at least one remotely controlled door.

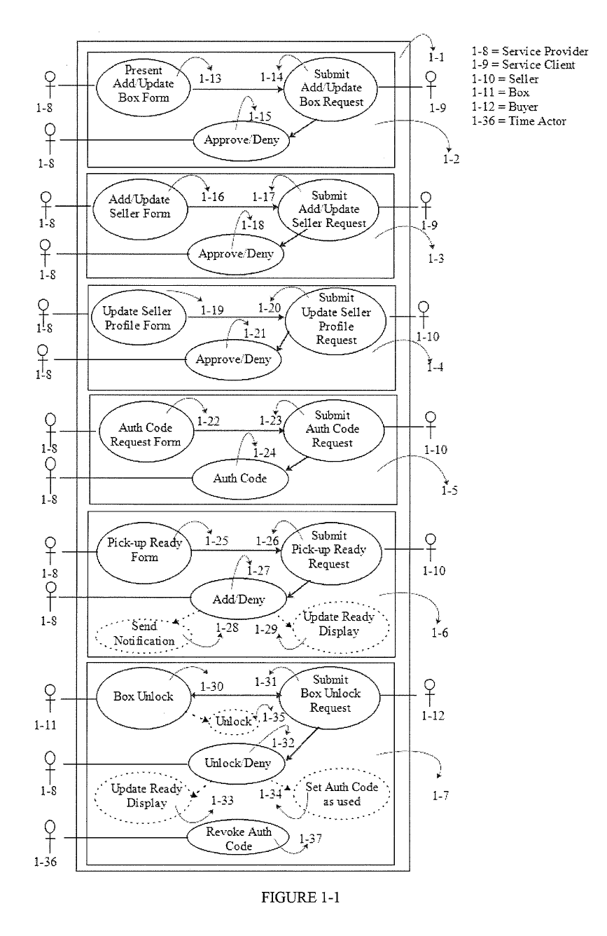

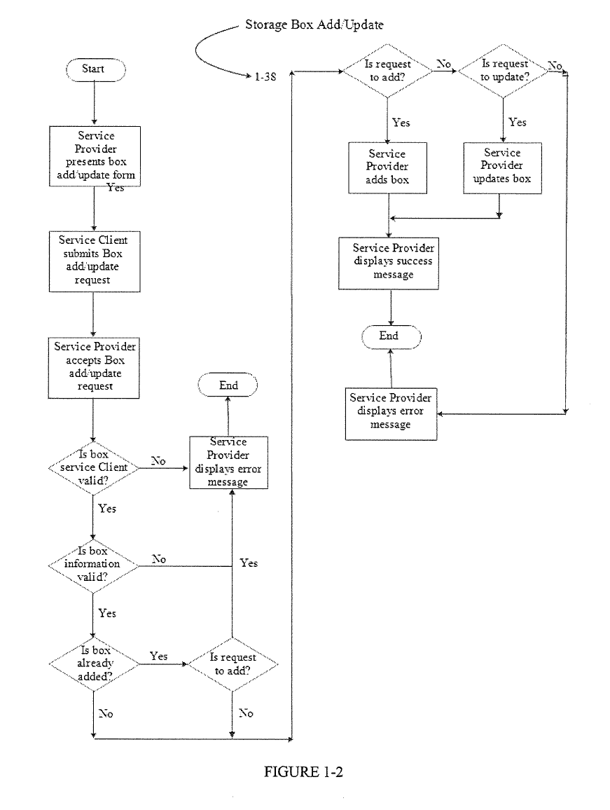

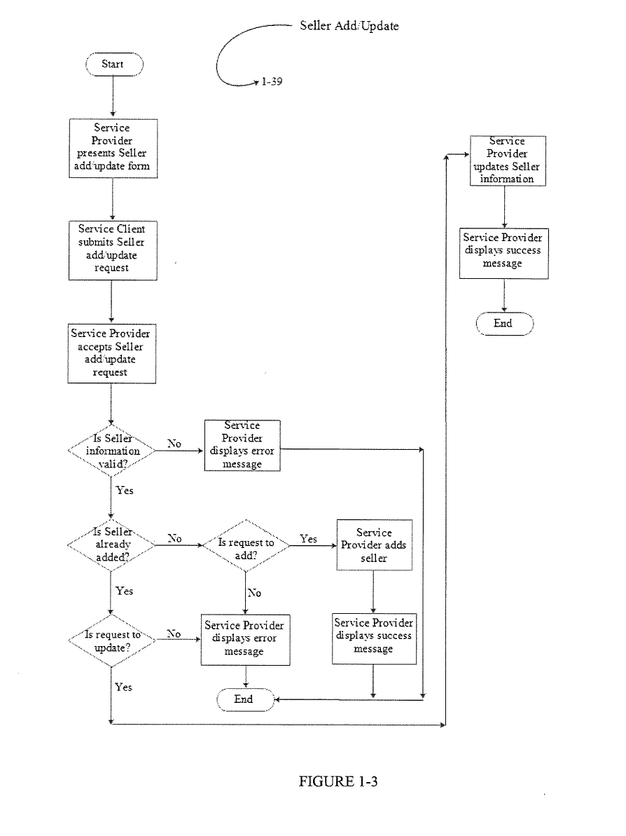

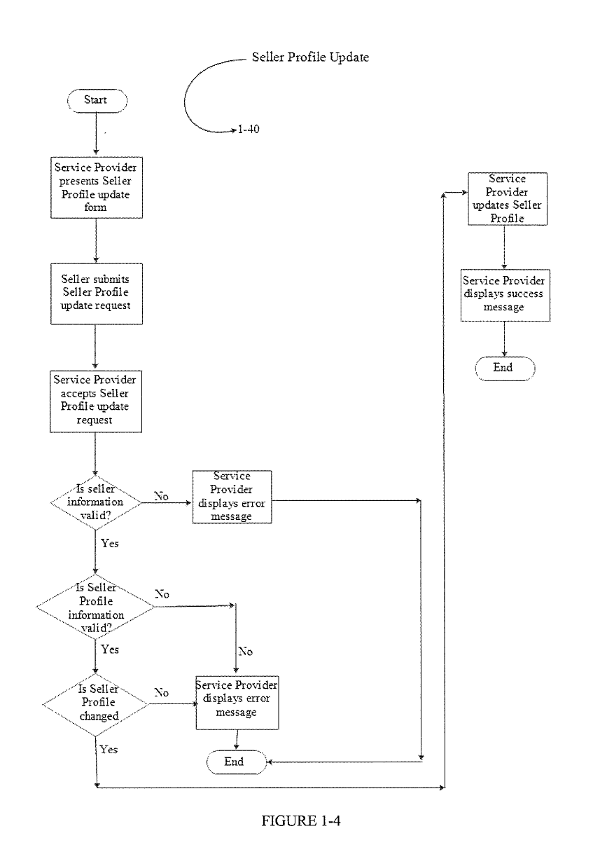

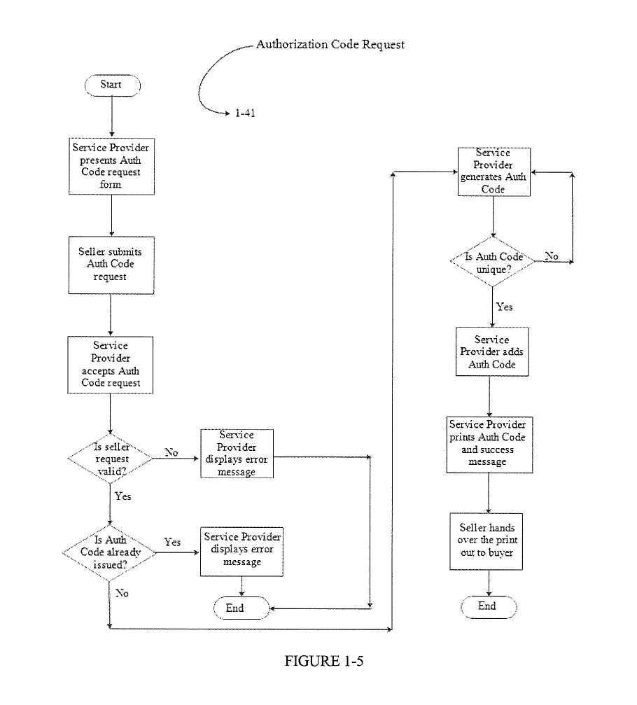

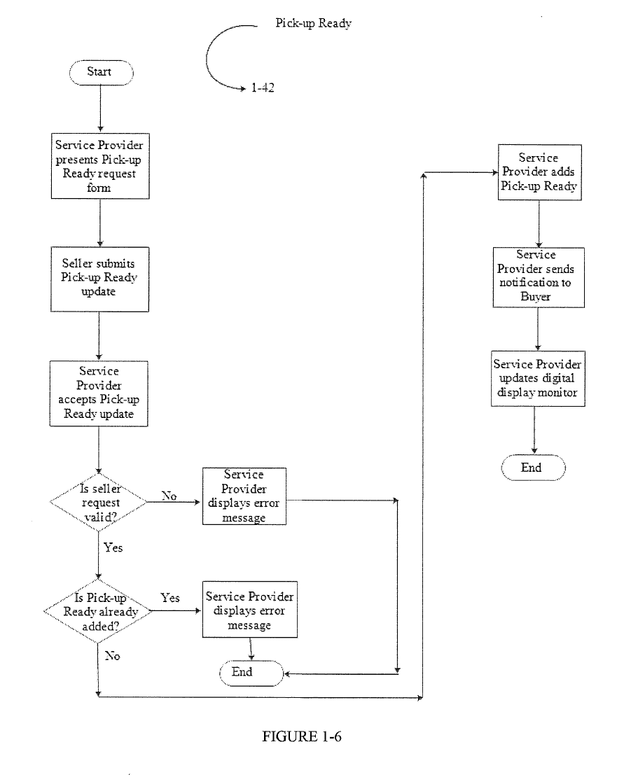

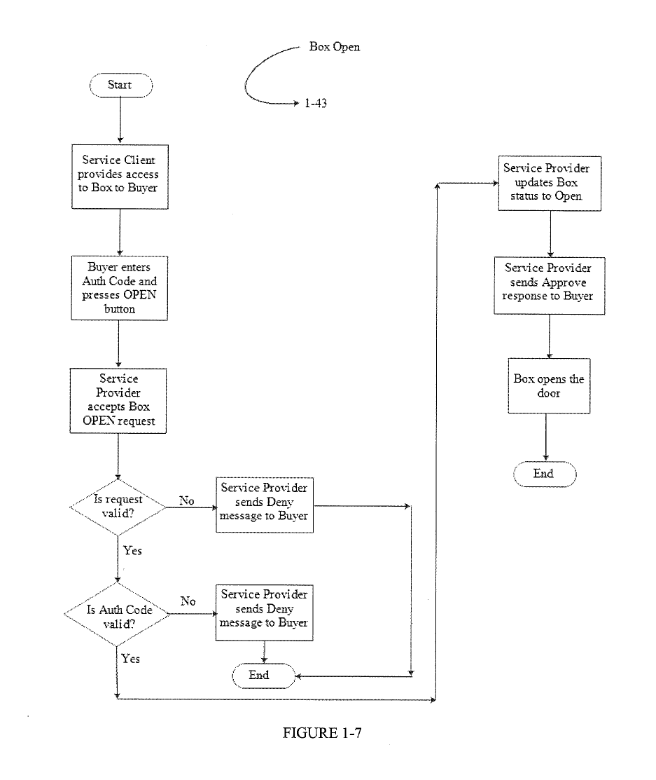

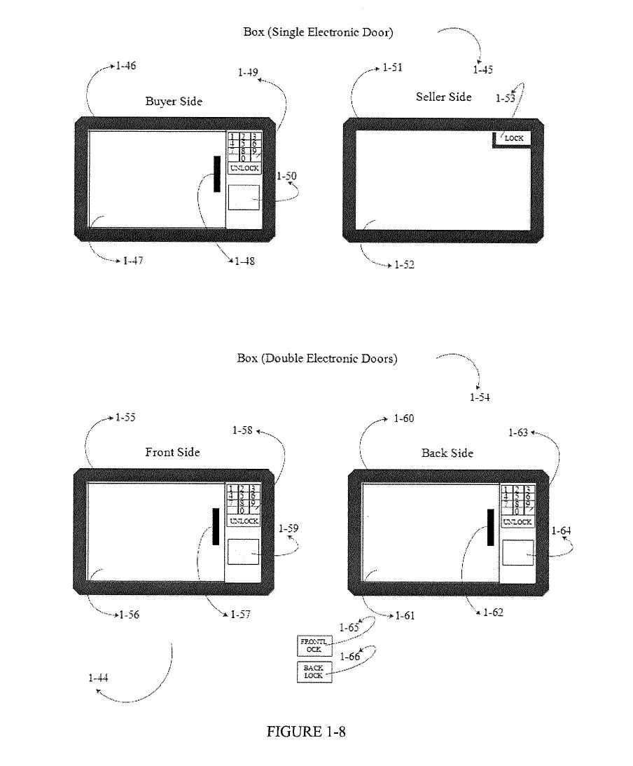

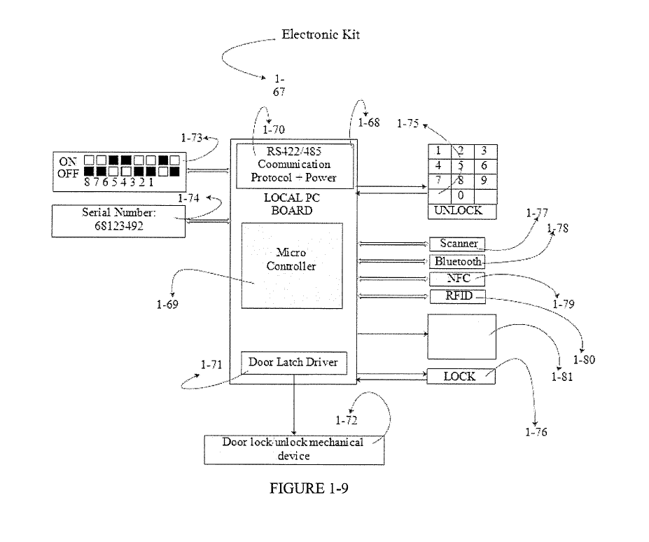

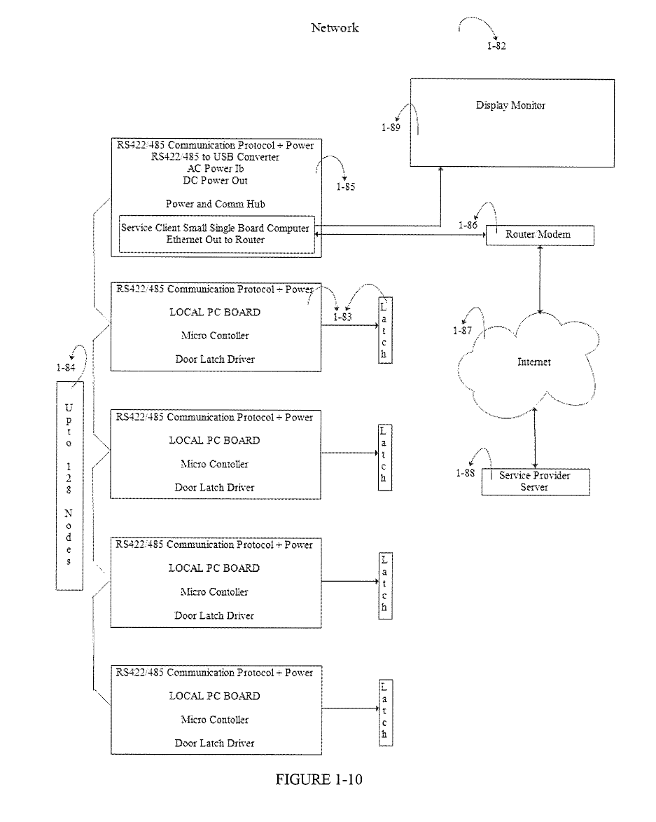

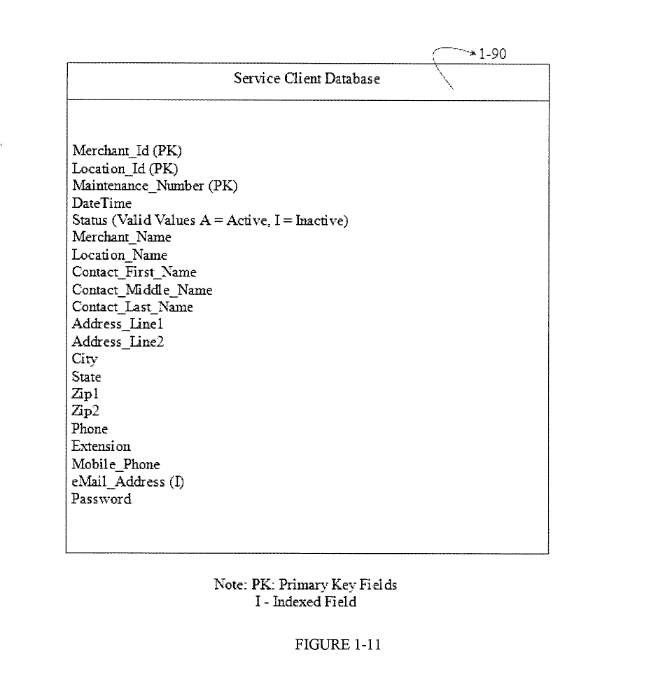

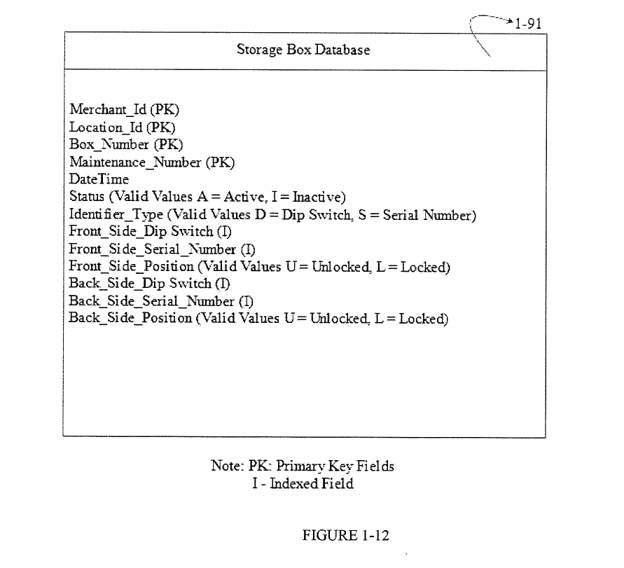

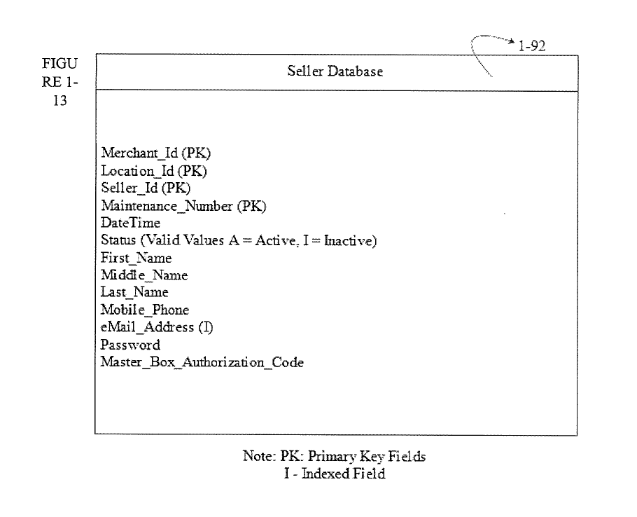

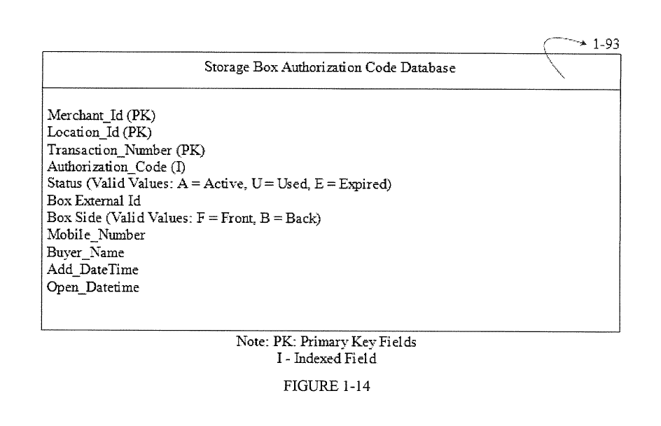

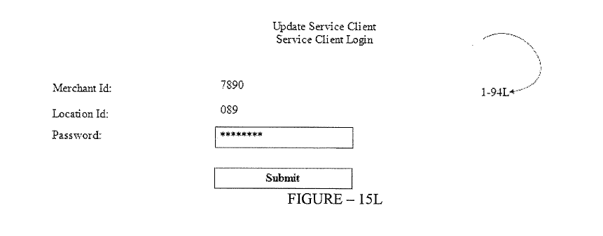

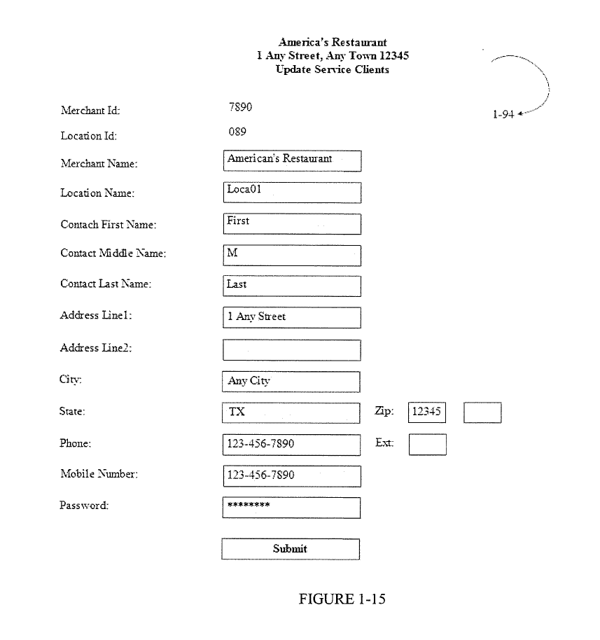

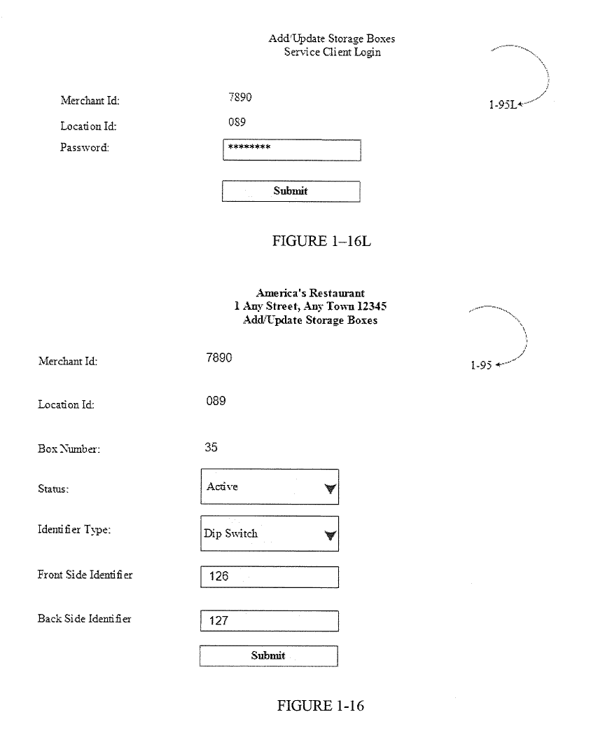

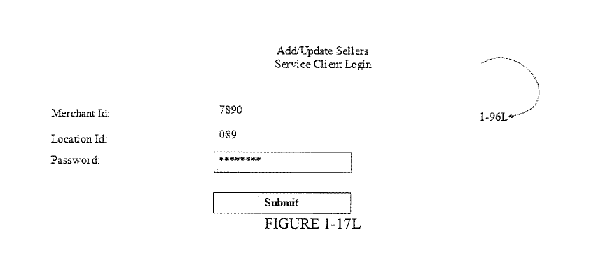

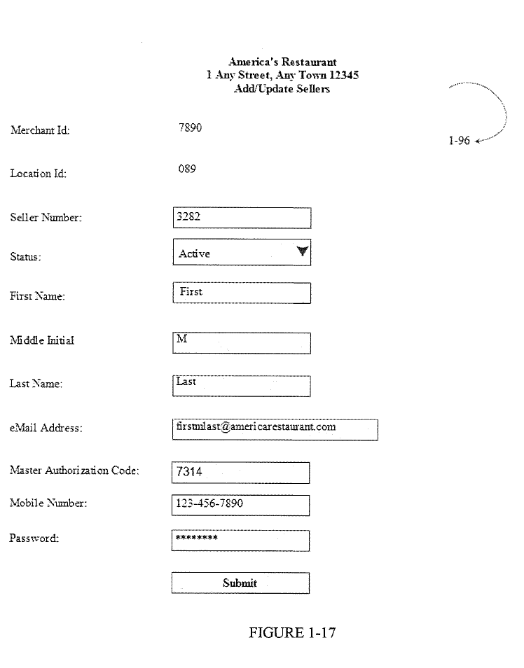

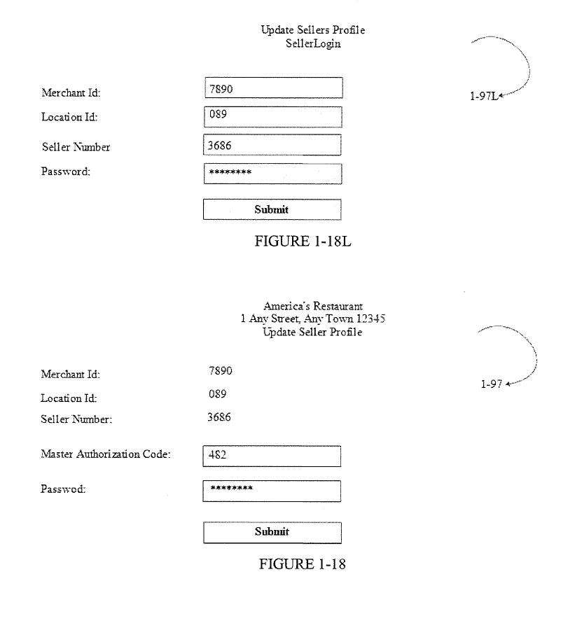

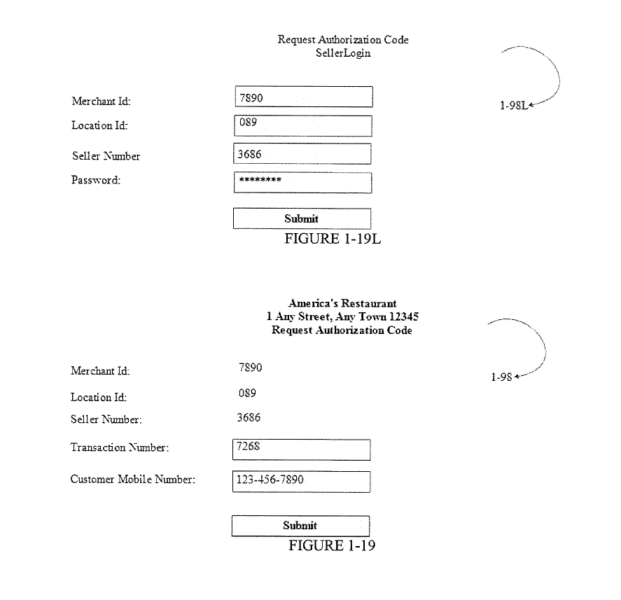

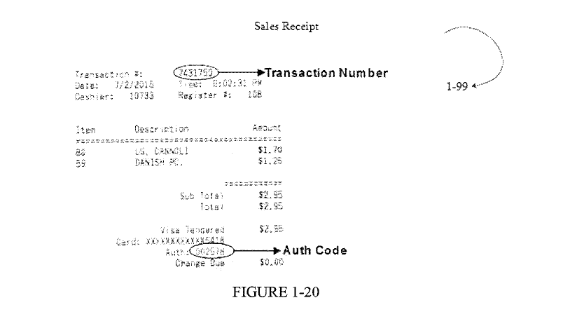

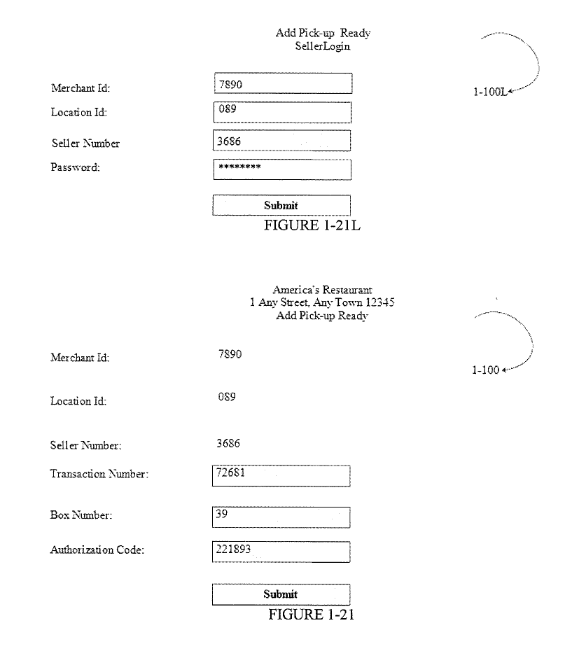

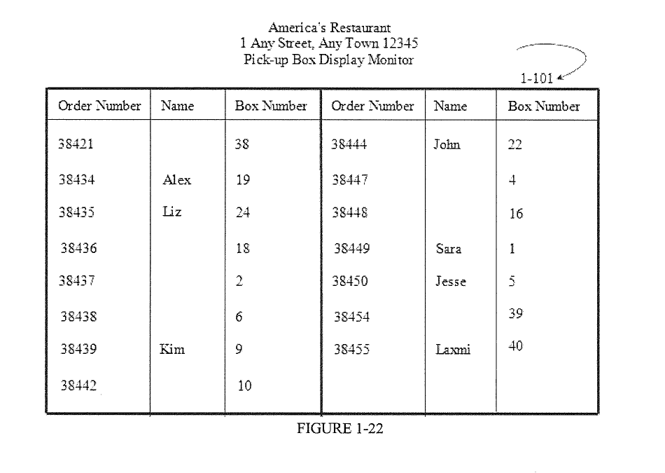

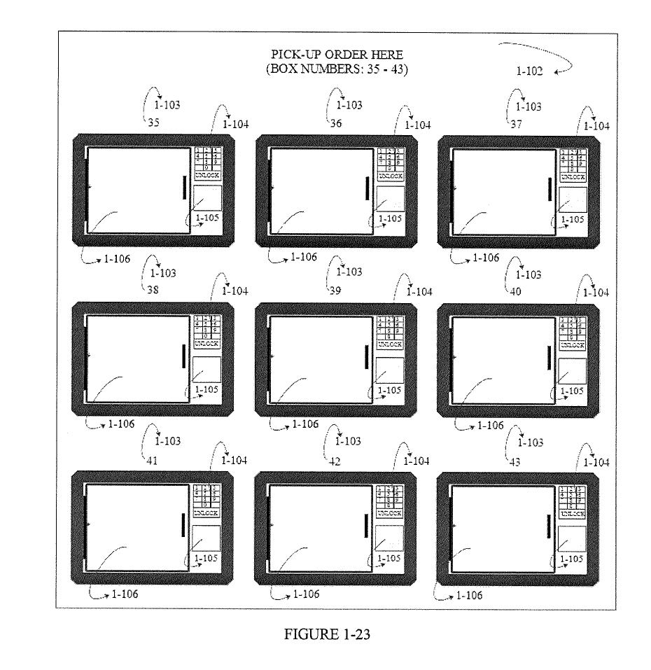

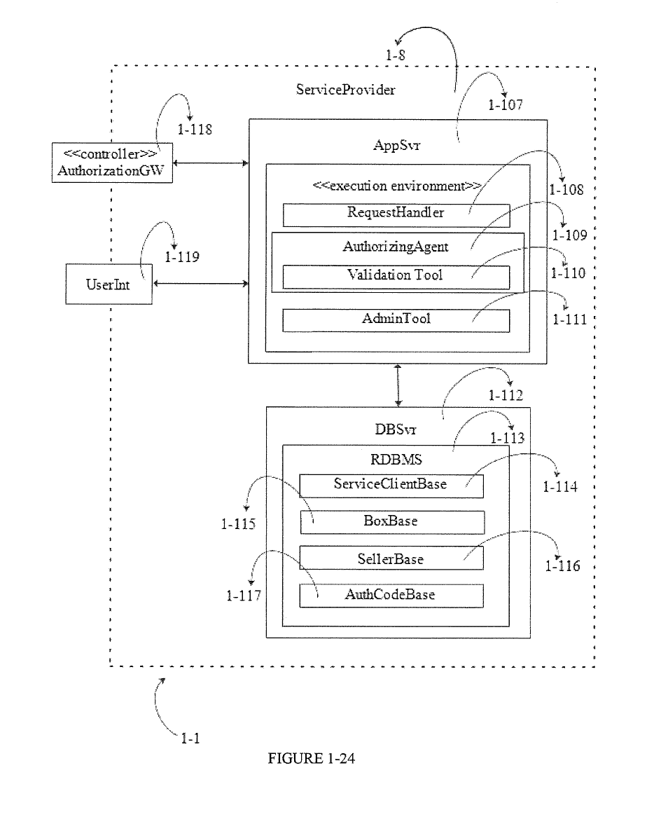

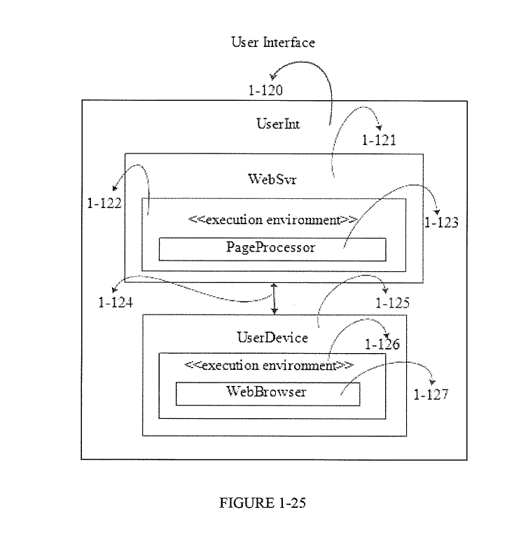

Referring to FIG. 1-1, the electronic goods pick-up box system 1-1 generally comprises a service provider 1-8, an operative combination of a plurality of service clients 1-9 with implemented use cases 1-2 and 1-3, a plurality of sellers 1-10 with implemented use cases 1-4, 1-5 and 1-6, and at least one buyer 1-12 with implemented use case 1-7. A service client is generally referred to as the provider of the goods such as a brick and mortar retail store, an online retail store, restaurant, etc. A seller is generally referred to as an agent or employee of the service client and may be a shipping agent. A service client may also be the seller. A service provider facilitates the services described herein by managing the hardware and software of the electronic goods pick-up box system 1-1. A service provider may also be the service client.

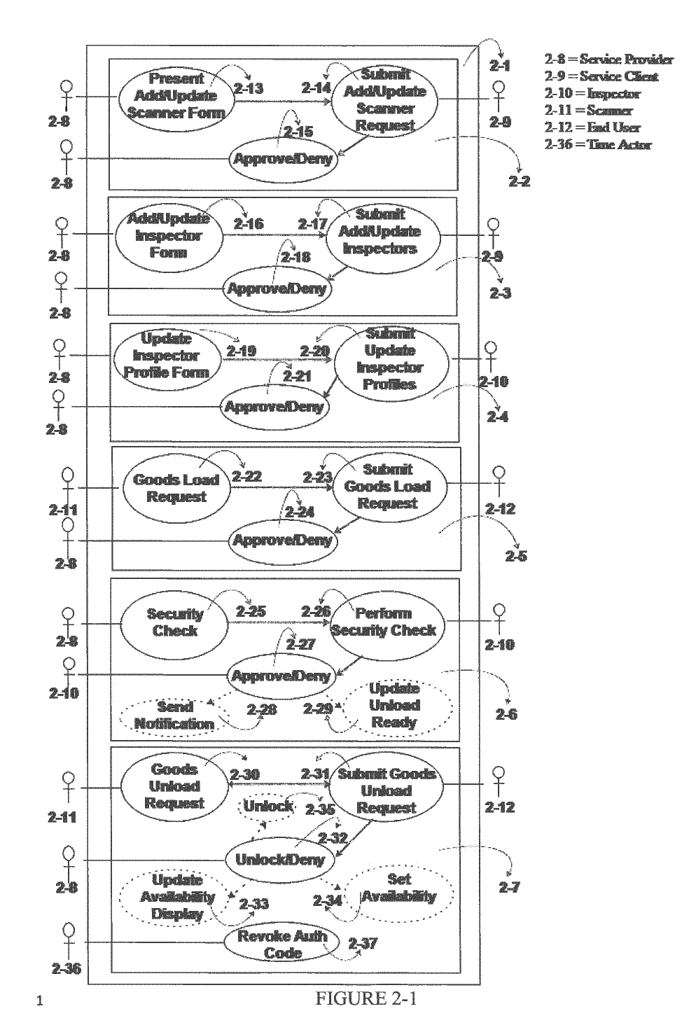

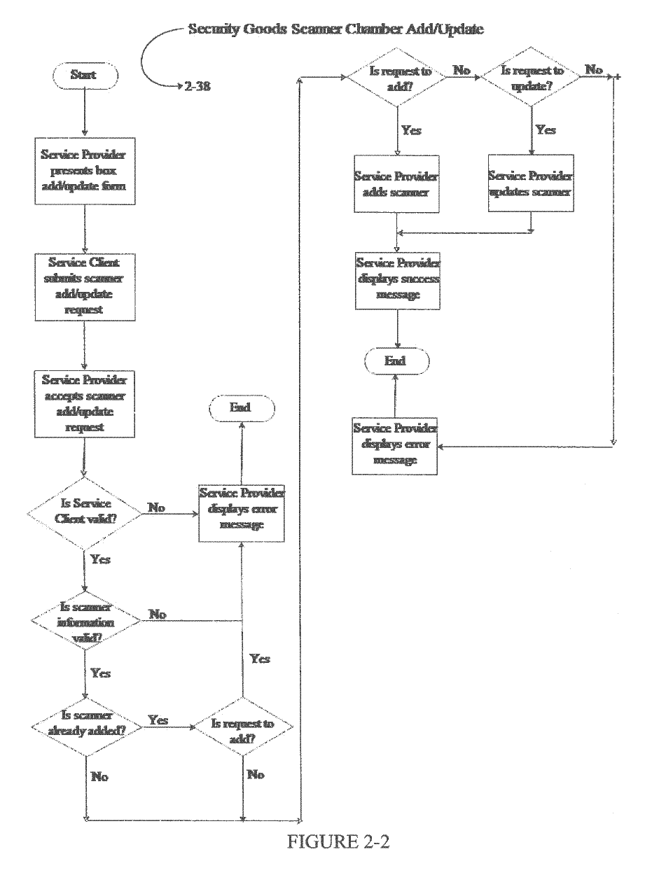

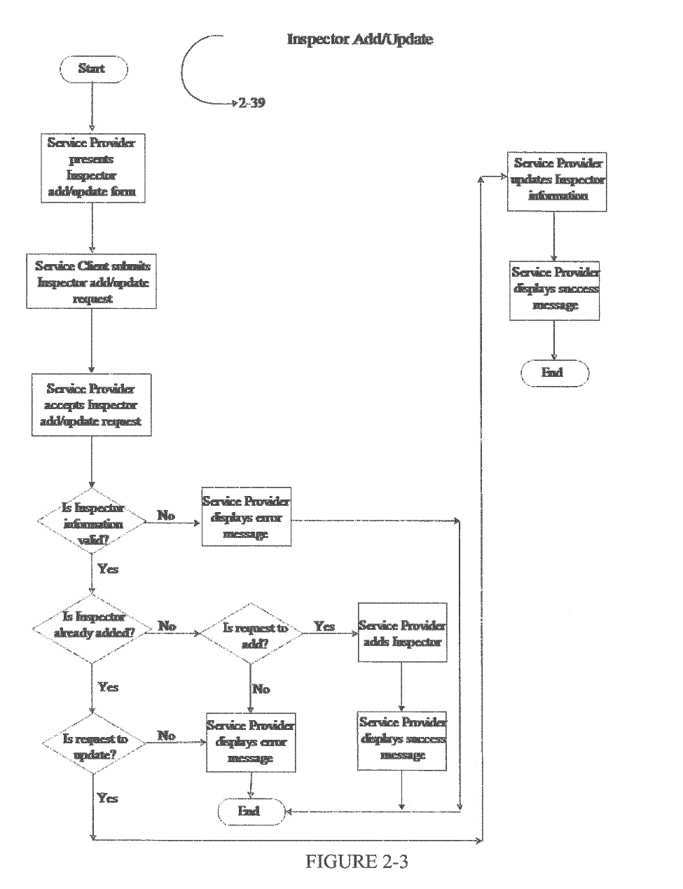

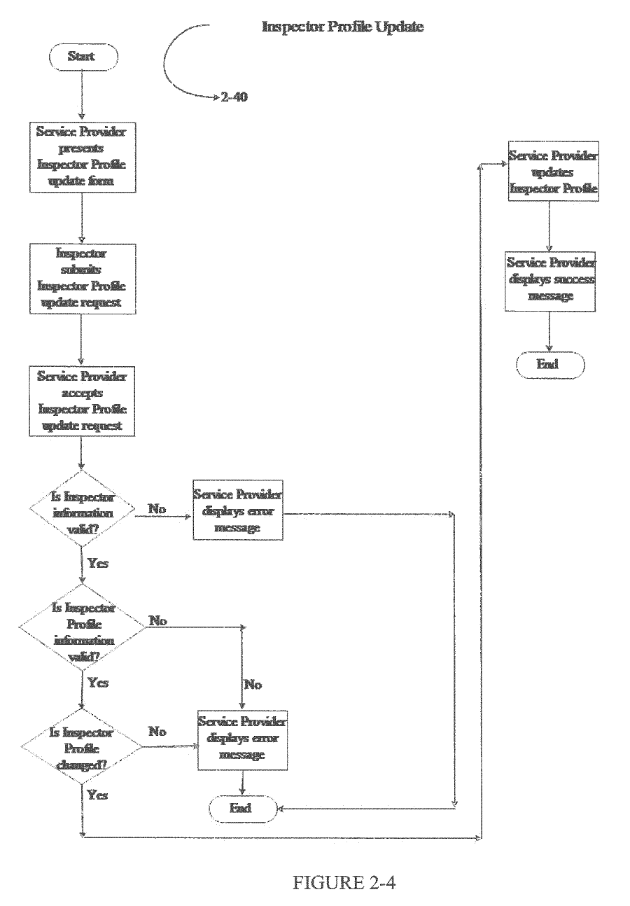

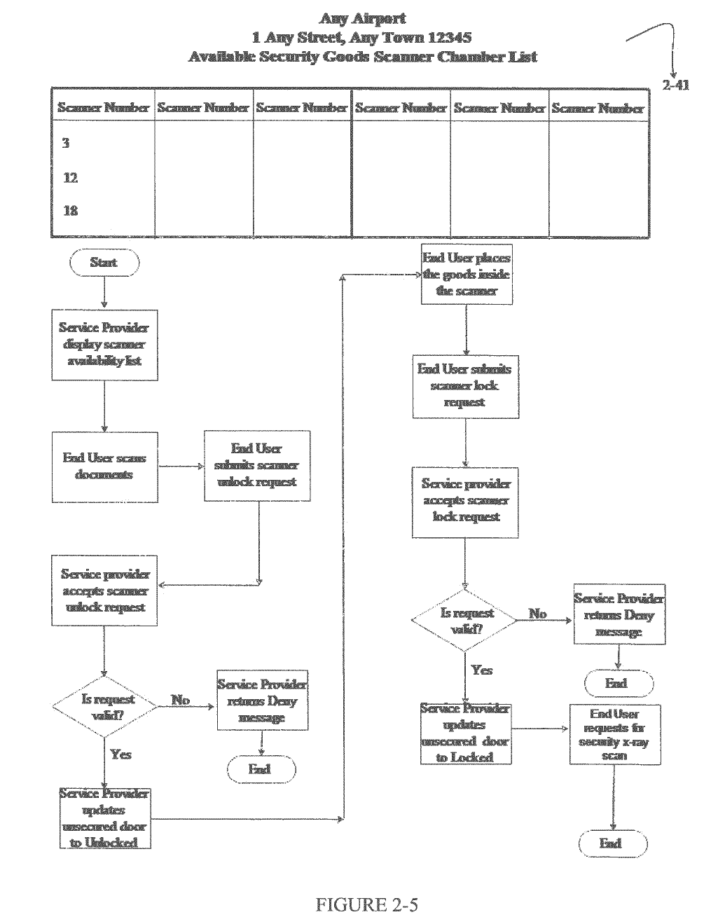

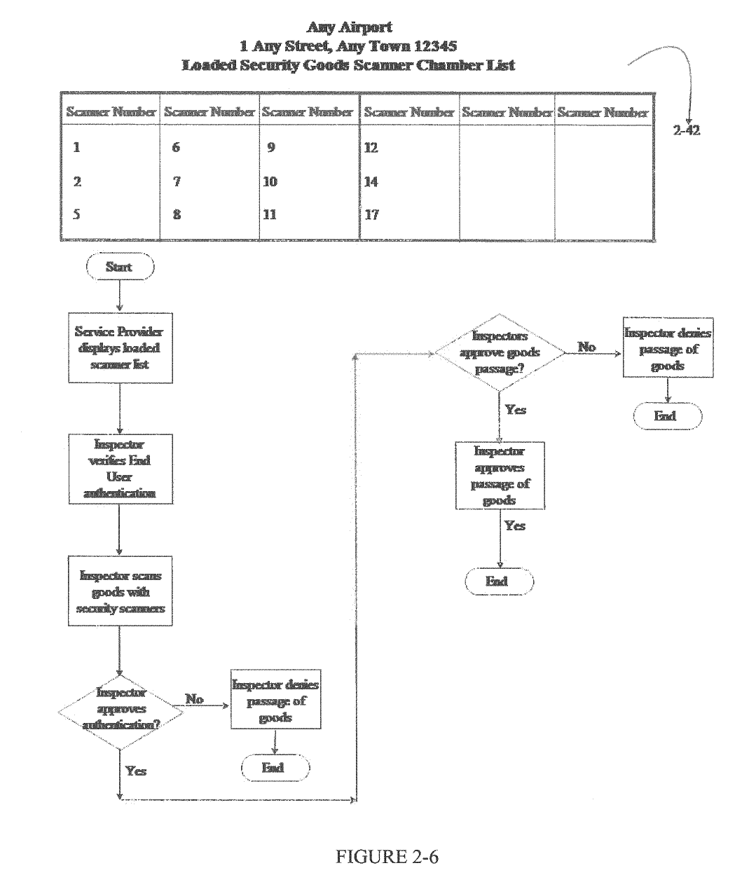

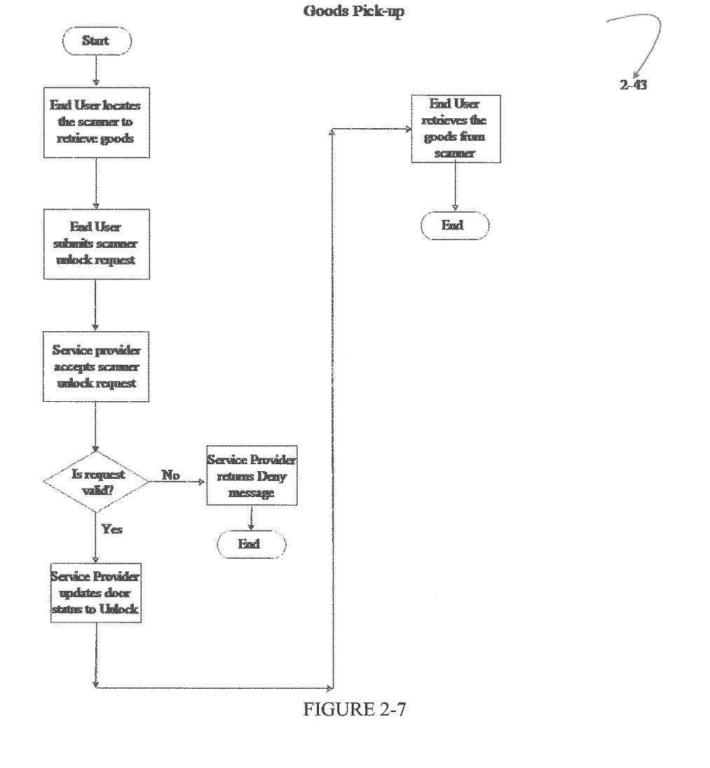

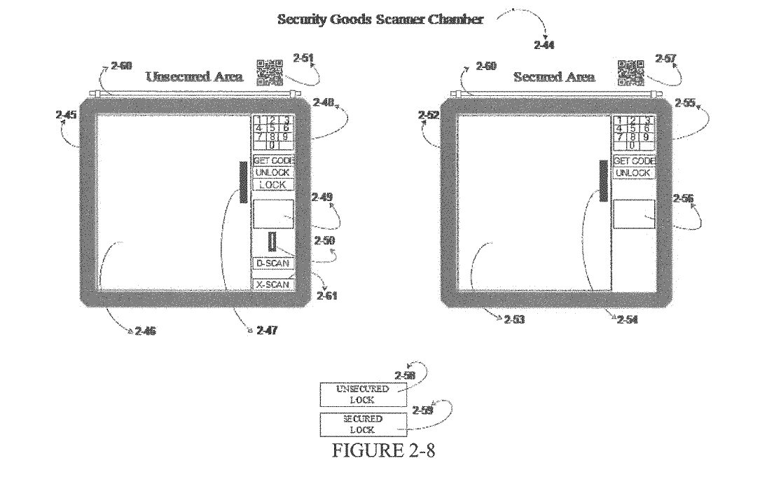

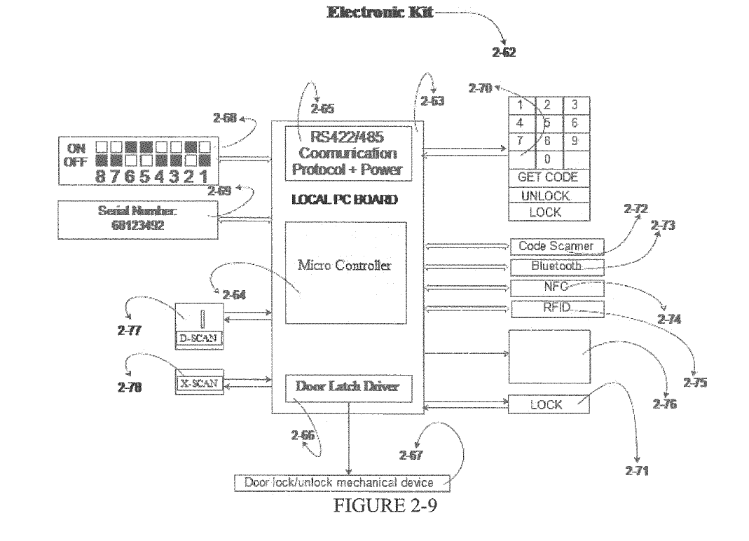

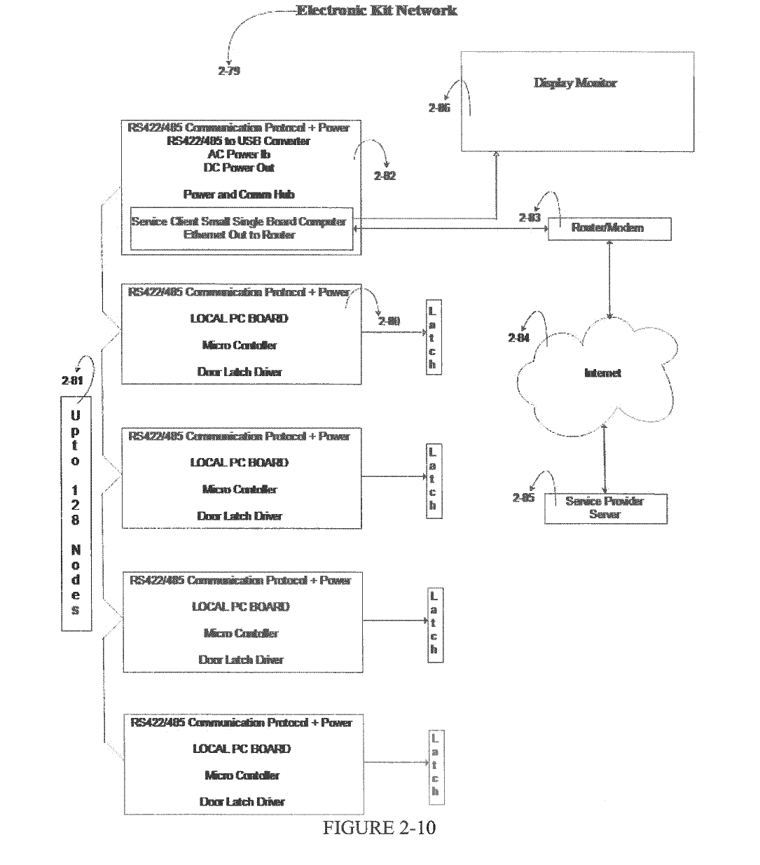

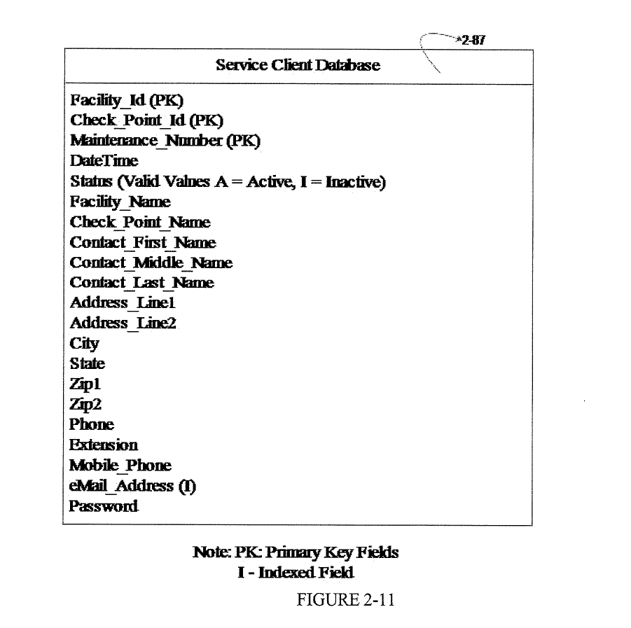

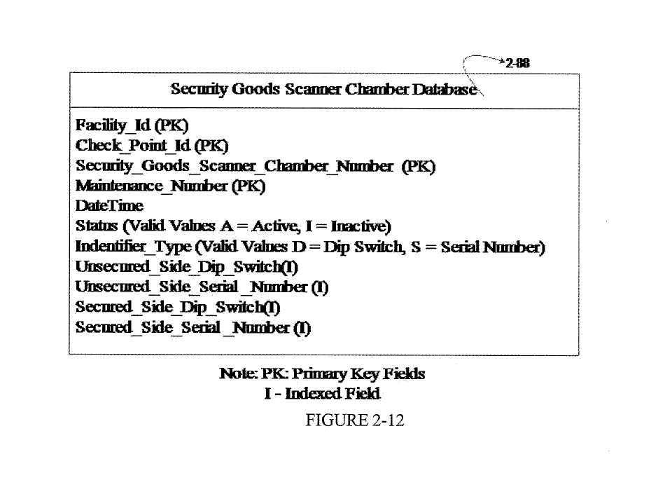

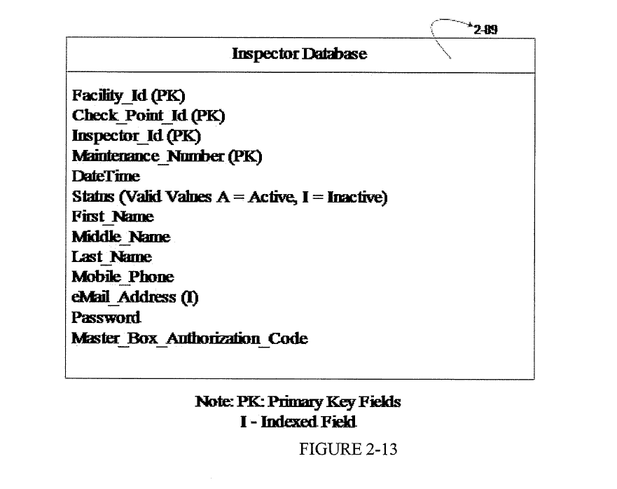

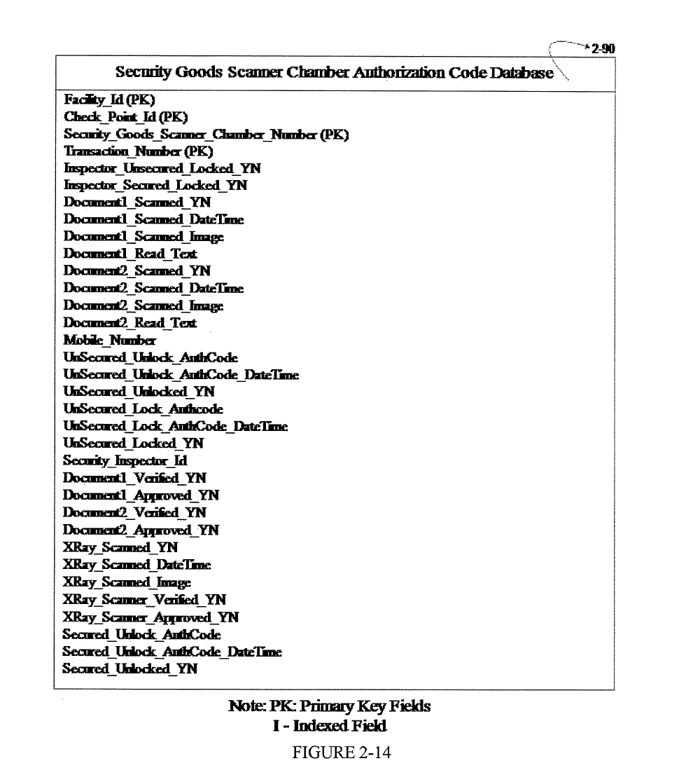

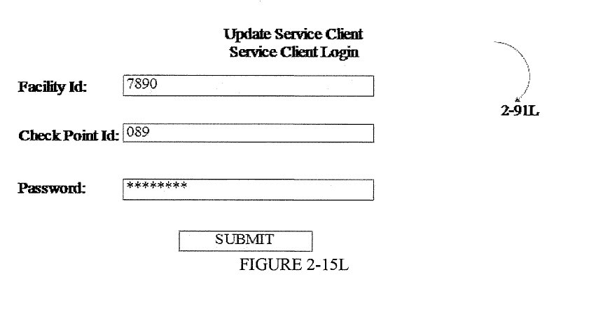

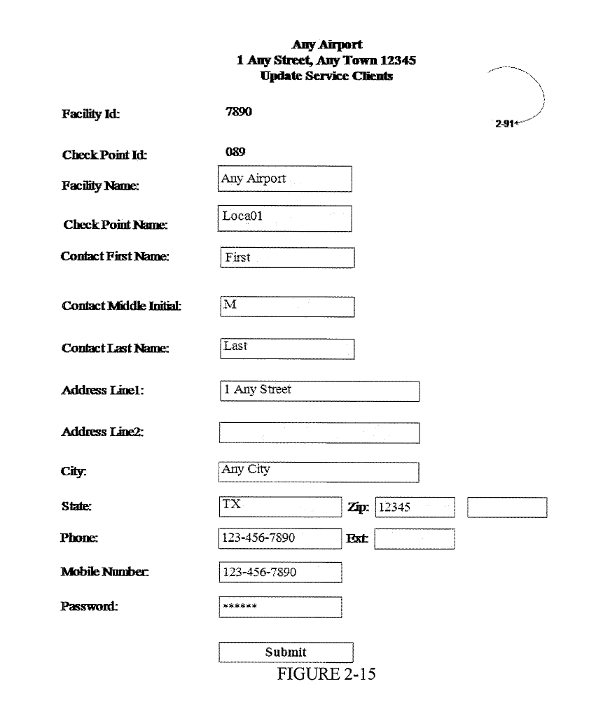

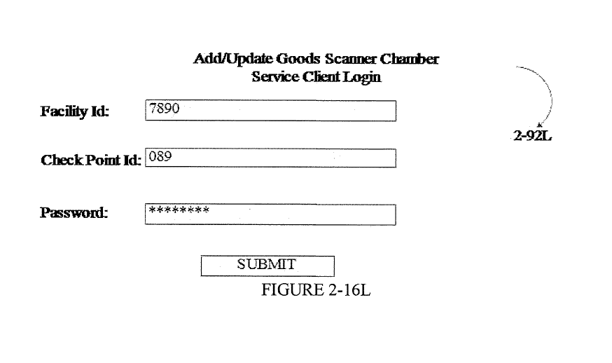

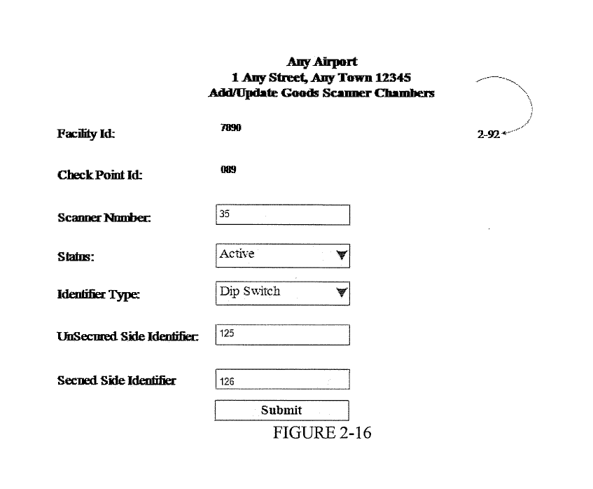

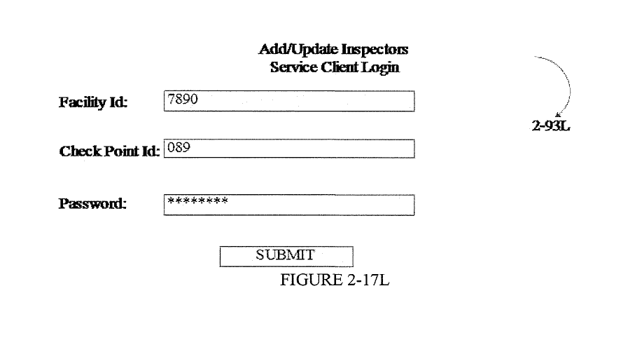

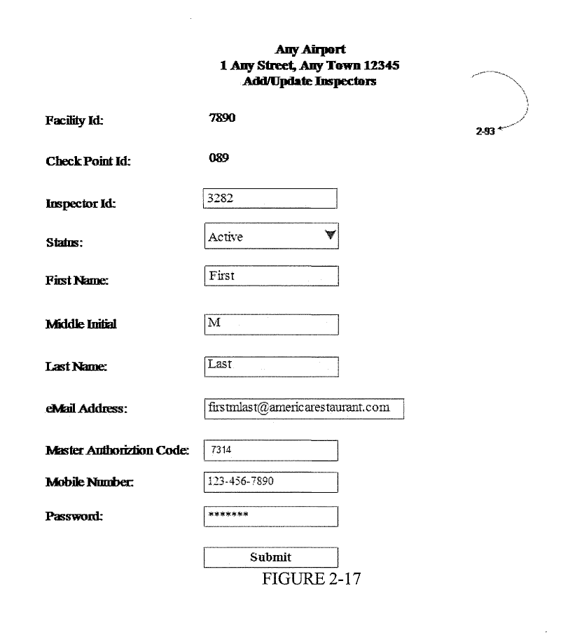

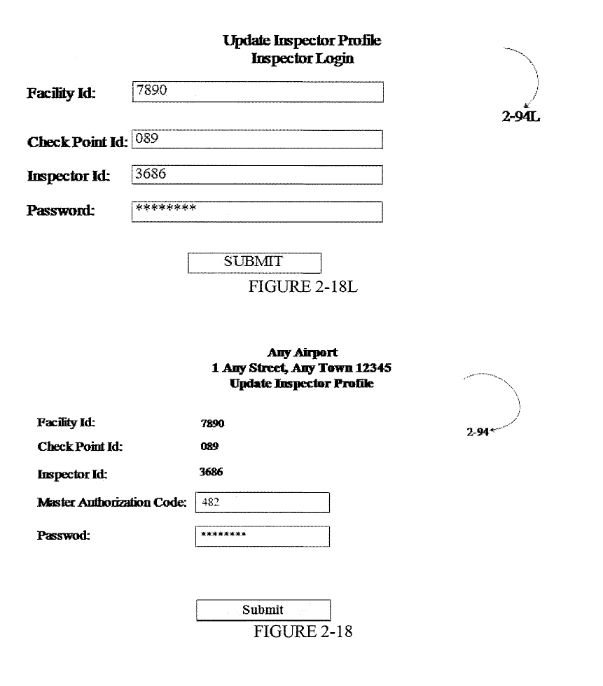

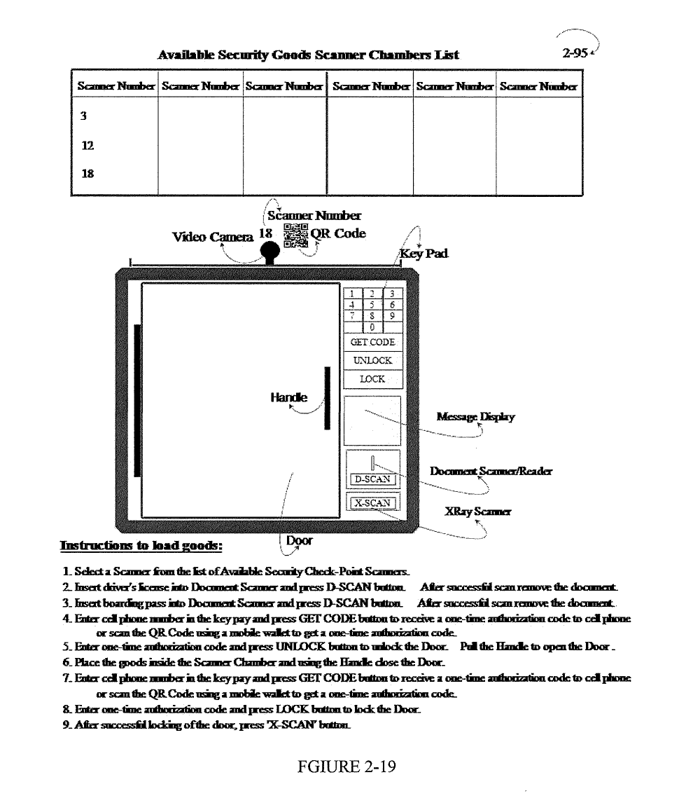

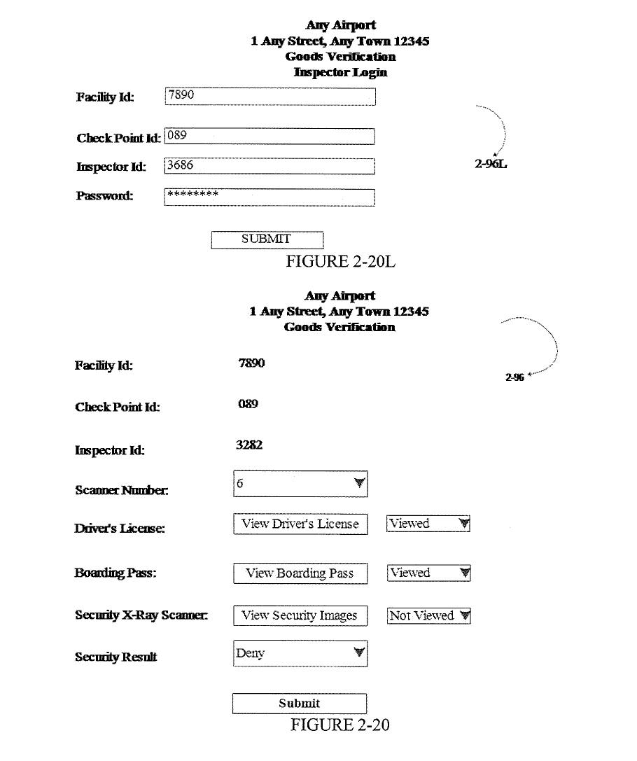

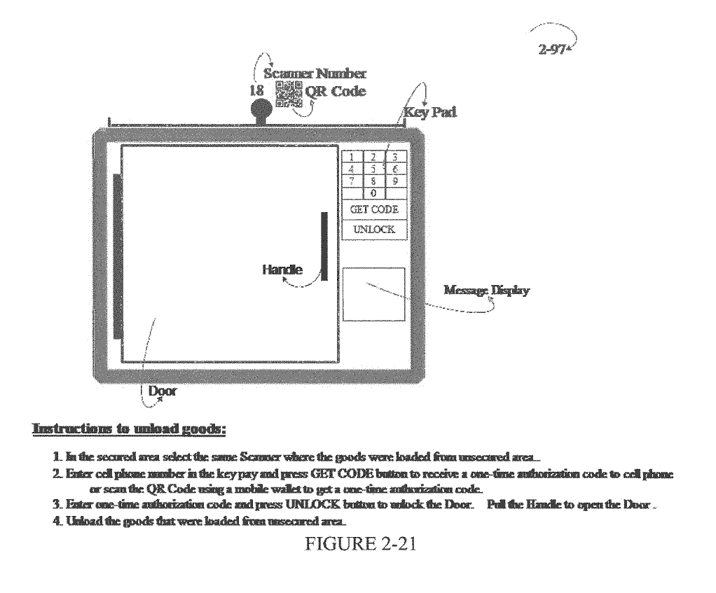

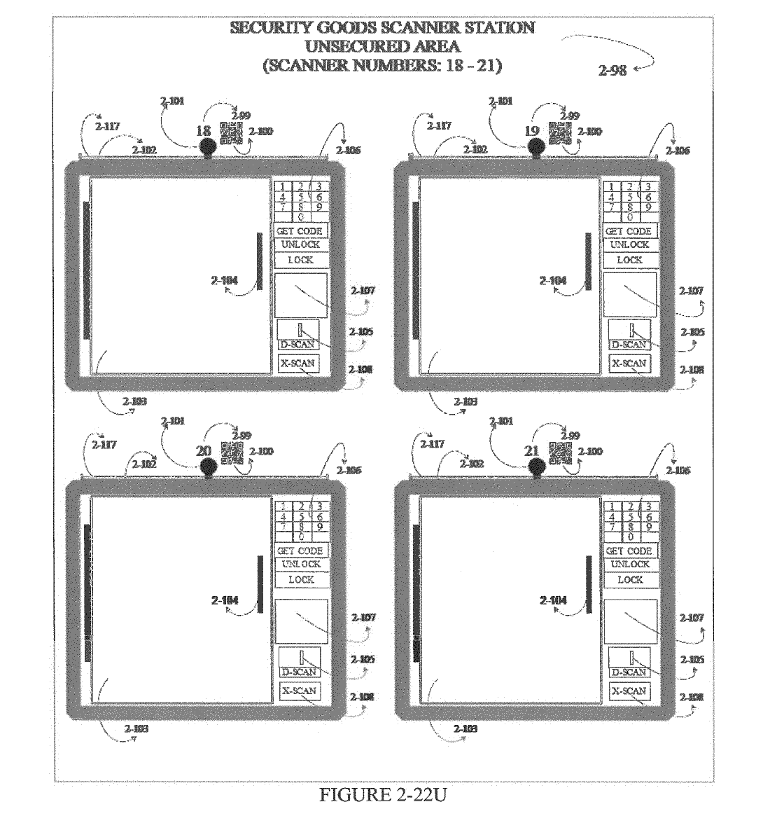

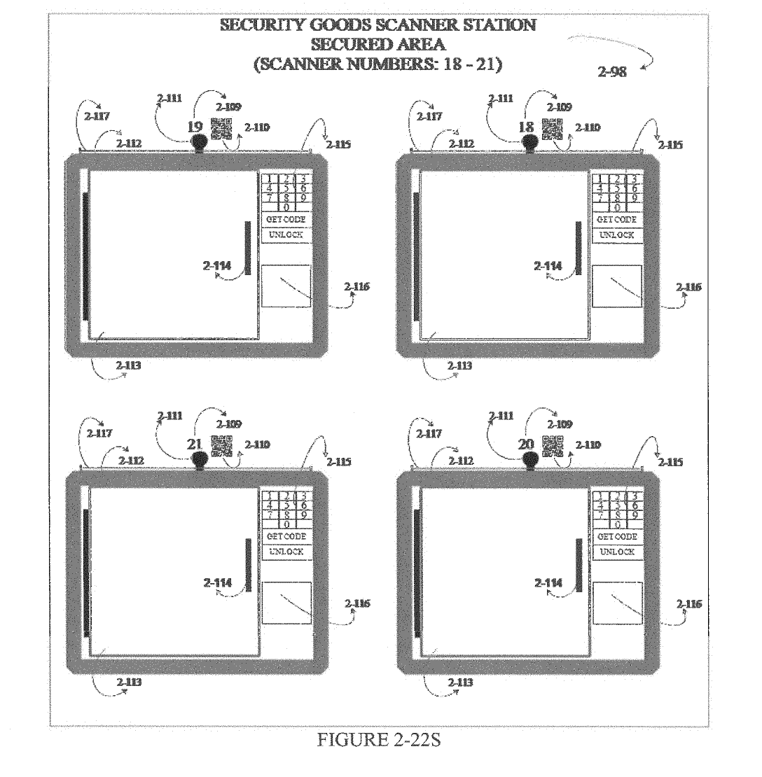

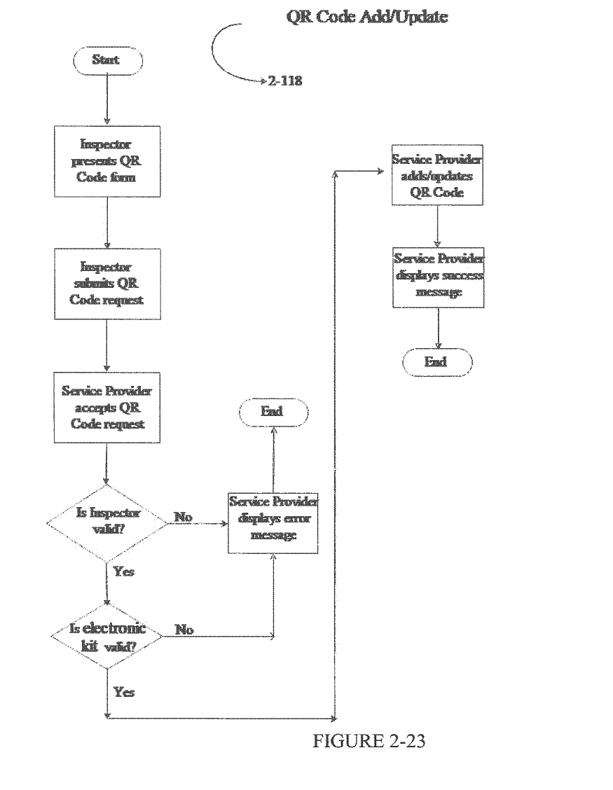

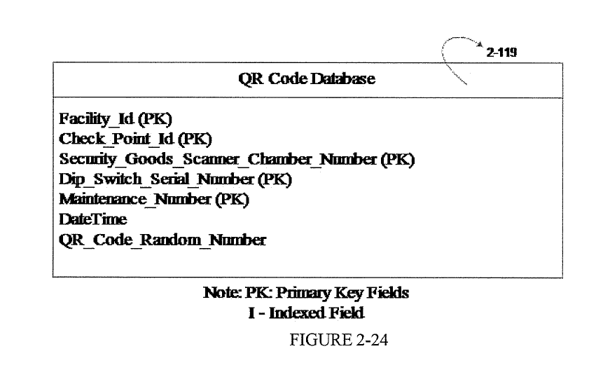

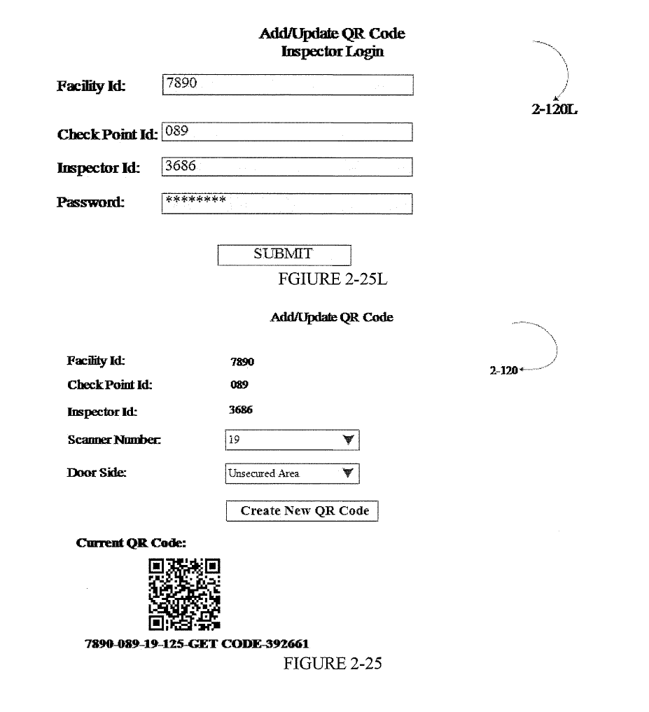

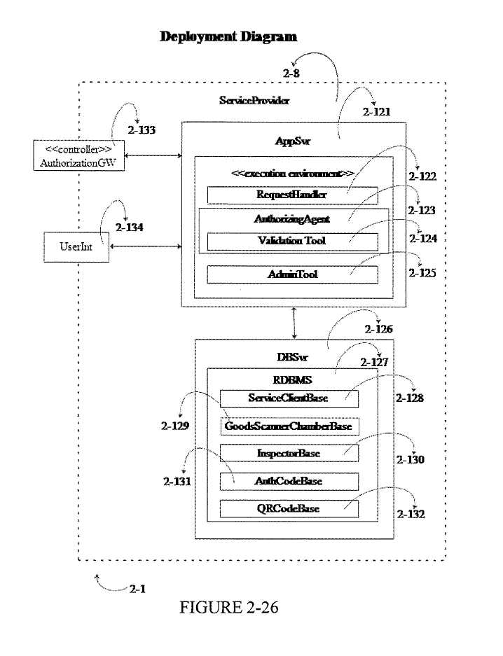

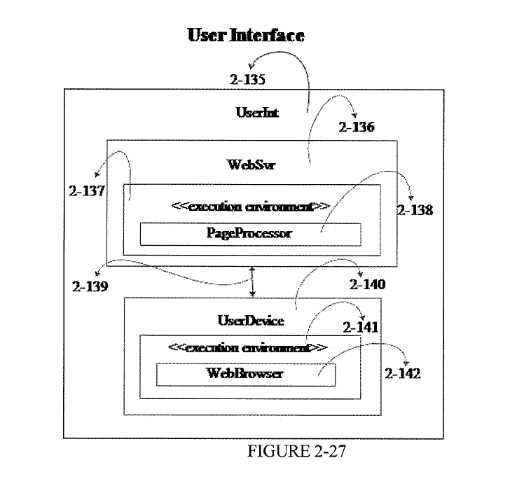

The service provider 1-8 generally provides a means 1-13 for service clients 1-9 to access a form to add/update the electronic goods pick-up box. The service client 1-9 generally uses the means 1-14 to submit the request to add/update the electronic goods pick-up box. The service provider 1-8 generally uses means 1-15 to approve/deny the service client's request. The use case 1-2 for adding/updating the electronic goods pick-up box 1-38 is further detailed in a flow chart in FIG. 1-2.

The service provider 1-8 generally provides a means 1-16 for service clients 1-9 to access a form to add/update seller information. The service client 1-9 generally uses the means 1-17 to submit the request to add/update seller information. The service provider 1-8 generally uses the means 1-18 to approve or deny the service client's request. The use case 1-3 for adding/updating sellers 1-39 is further detailed in a flow chart in FIG. 1-3.

The service provider 1-8 generally provides a means 1-19 for sellers 1-10 to access a form to update seller profile information. The seller 1-10 generally uses the means 1-20 to submit the request to update seller profile information. The service provider 1-8 generally uses the means 1-21 to approve or deny the seller's request. The use case 1-4 for updating seller profile 1-40 is further detailed in a flow chart in FIG. 1-4.

The service provider 1-8 generally provides a means 1-22 for a seller 1-10 to request a unique authorization code. The seller 1-10 generally uses the means 1-23 to submit the request for a unique authorization code. The service provider 1-8 generally uses the means 1-24 to provide a unique authorization code. The seller 1-10 requests a unique authorization code only if the service client cannot create one. The use case 1-5 is a request to assign a one-time authorization code for a transaction 1-41 is further detailed in a flow chart in FIG. 1-5.

The service provider 1-8 generally provides a means 1-25 for sellers 1-10 to access a form to add pick-up ready information. The seller 1-10 generally uses the means 1-26 to submit add pick-up ready information. The service provider 1-8 generally uses the means 1-27 to add or deny the seller's request. If the pick-up ready information is added, then service provider 1-8 generally uses the means 1-28 to send pick-up ready notification to buyers, if required. If order pick-up ready information is added, then service provider 1-8 generally uses the means 1-29 to update pick-up ready display monitor. The use case 1-6 for sellers to update pick-up ready information and/or update digital display monitor with or without pick-up ready notification to buyers 1-42 is further detailed in a flow chart in FIG. 1-6.

The goods pick-up box 1-11 generally provides a means 1-30 for the buyer 1-12 to access the key pad attached to the buyer side of the goods pick-up box 1-11. The buyer 1-12 generally uses the means 1-31 to submit the request to unlock the electronic goods pick-up box to service provider 1-8. The service provider 1-8 generally uses the means 1-32 to authorize or deny the request. If the service provider 1-8 authorizes the request, it generally uses means 1-33 to update display monitor and means 1-34 to set the authorization code as used. If the goods pick-up box 1-11 receives approval message, then the goods pick-up box generally uses a means 1-35 to unlock the goods pick-up box 1-11. Time 1-36, as an actor, generally uses the means 1-37 to revoke the authorization code if the pick-up order is not picked-up by buyers in a timely manner, in other words the authorization code may expire. A used or expired authorization code cannot be used again. The use case 1-7 for buyers to pick-up goods and to update digital display monitor 1-43 is further detailed in FIG. 1-7.

FIG. 1-8 shows two preferred embodiments of an goods pick-up box 1-11. In the first embodiment, a single door goods pick-up box 1-45 comprises a buyer side and a seller side. A door 1-47, having a handle 1-48, is attached to the door frame 1-46 on the buyer side. A key entry-pad 1-49 and a screen 1-50 are positioned on or within the door frame 1-46 adjacent to the door 1-47. The frame 1-51 would be attached to the seller side of the electronic goods pick-up box. The seller side of the single door goods pick-up box 1-45 comprises a hollow space 1-52 defined by frame 1-51. A lock button 1-53 is attached to the frame 1-51 and accessible on the seller side.

In the second embodiment, a double door goods pick-up box 1-54 comprises a front side and a back side. A first door 1-56, having a handle 1-57, is attached to the door frame 1-55 on the front side. A first key entry-pad 1-58 and a first screen 1-59 are positioned on or within the door frame 1-55 adjacent to the door 1-56. A second door 1-61, having a handle 1-62, is attached to the door frame 1-60 on the back side. A second key entry-pad 1-63 and a second screen 1-64 are positioned on or within the door frame 1-60 adjacent to the door 1-61. The front lock 1-65 and back lock 1-66 buttons are visible and accessible only to sellers 1-10.

In a third embodiment (not shown), fully enclosed single door goods pick-up box is a fully enclosed box with a single door having a handle 1-57, a key entry-pad, a screen, a lock button, and an unlock button. The screen may be a touch screen and serve as the key entry pad, lock button, and unlock button.

Each door 1-47, 1-56, 1-61 is capable of being locked by a door locking mechanism 1-72 (referenced in FIG. 1-9). The door locking mechanism 1-72 may be an electromagnet that holds the door in a locked position when the said electromagnet is magnetized. The door locking mechanism 1-72 may also be an electromagnet that moves a latch to hold the door in a locked position when the electromagnet is magnetized. The door locking mechanism 1-72 may also be a motor that physically moves the door to an open/closed position such as moving the door up/down or right/left. Any suitable mechanisms for locking or unlocking the door may be utilized so long as the control may be accomplished electronically and remotely.

As shown in FIG. 1-23, a pick-up order station 1-102 may be comprised of a plurality of goods pick-up boxes each having a unique external identifier 1-103. If electronic goods pick-up boxes with single door are used, then the electronic door should be accessible to buyers and the access to the doorless opening should be restricted only to sellers. If goods pick-up boxes with double doors are used, then both electronic doors may be accessible to buyers and sellers. The unique external identifier 1-103 may comprise a front side identifier and a back side identifier.

FIG. 1-9 shows the electronic kit 1-67 used by the service provider to lock/unlock the remotely controlled electronic doors 1-47, 1-56, and 1-61. The electronic kit 1-67 is comprised of various components to unlock/lock remotely controlled electronic doors including a local PC board 1-68, door locking mechanism 1-72, a bank of dip switches 1-73 and/or a serial number reader 1-74, external key pad 1-75, scanner reader 1-77, bluetooth reader 1-78, near field communication (NFC) reader 1-79, radio frequency identification (RFID) reader 1-80, external mini screen 1-81, external lock button 1-76. The door locking mechanism 1-72 must be physically within the electronic goods pick-up box to physically lock and unlock the door. The other components of the electronic kit 1-67 may be located within the goods pick-up box 1-11 or in communication therewith. The electronic kit 1-67 is configurable to connect to any number of electronic goods pick-up boxes to remotely control the door(s) connected to electronic goods pick-up boxes.

The local PC board 1-68 comprises a microcontroller 1-69, communication protocol plus power component 1-70, and a door latch driver 1-71. The power part of the communication protocol plus power component 1-70 supplies DC, either from a battery source or from conversion of AC power, to power the local PC board 1-68. The microcontroller 1-69 communicates, via the communication protocol of the said communication protocol plus power component 1-70, with a small single board computer, a general purpose computer (“personal computer”) 1-85 (as shown in FIG. 1-10), or directly with service provider server 1-88 through the internet. An example of a communication protocol plus power component capable of use with this embodiment is RS422/485 but other interface cards may be used. The door latch driver 1-71, based on instructions from the microcontroller 1-69 controls the door locking mechanism 1-72 that ultimately controls the locked/unlocked status of each door. The local PC board 1-68 is in communication with a bank of dip switches 1-73 and/or a serial number reader 1-74. The microcontroller 1-69 communicates information from the dip switches 1-73 and/or a serial number reader 1-74 when communicating with the personal computer 1-85 or service provider server 1-88 in order to identify the specific local PC board 1-68.

The microcontroller 1-69 may be in communication with at least one external key pad 1-75. The external key pad 1-75 may be physically attached to the goods pick-up box 1-11 such as key entry-pads 1-49, 1-58, and 1-63 as shown in FIG. 1-8 but physical attachment is not a requirement. The external key pad 1-75 receives inputs from service clients, sellers, and buyers and communicates such inputs to the microcontroller 1-69.

The microcontroller 1-69 may be in communication with a scanner reader 1-77 that is capable of scanning and reading a QR code, bar code, or any machine readable code; bluetooth reader 1-78; near field communication (NFC) reader 1-79; and/or a radio frequency identification (RFID) reader 1-80. The scanner reader 1-77, bluetooth reader 1-78, near field communication (NFC) reader 1-79, and radio frequency identification (RFID) reader 1-80 may be physically attached to the goods pick-up box 1-11 but physical attachment is not a requirement. The scanner reader 1-77, bluetooth reader 1-78, near field communication (NFC) reader 1-79, and radio frequency identification (RFID) reader 1-80 receive an input from service clients, sellers, and buyers, and communicates such inputs to the microcontroller 1-69. The scanner reader 1-77, bluetooth reader 1-78, near field communication (NFC) reader 1-79, and radio frequency identification (RFID) reader 1-80 may be used in lieu of or in conjunction with external key pad 1-75.

The microcontroller 1-69 may be in communication with an external button 1-76 located on the goods pick-up box 1-11. The external button 1-76 may be accessible to the service clients or sellers. The external button 1-76 may be a lock button such as lock buttons 1-53, 1-65, 1-66 disclosed in FIG. 1-8.

The microcontroller 1-69 may be in communication with an external screen 1-81 that is capable of displaying messages. The external screen 1-81 may be physically attached to the goods pick-up box 1-11 such as the screens 1-50, 1-59, 1-64 as shown in FIG. 1-8 but physical attachment is not a requirement. The screen 1-81 may also be a touch screen and function as a display for messages as well as the external key pad 1-75 or as the external button 1-76.

As shown in FIG. 1-10, the electronic kits 1-83, as shown in FIG. 1-9 as 1-67, may be arranged in a box network 1-82. The electronic kits 1-83, through a network 1-84, are in communication with a personal computer 1-85. The personal computer 85 may be in communication with a router/modem 1-86 which is in communication to the internet or an intranet 1-87 which is in communication with the service provider server 1-88. The personal computer 1-85 may also be connected to an external display monitor 1-89.

FIG. 1-24 shows the various elements of an exemplary hardware and software based implementation of the electronic goods pick-up box system 1-1. The implementation depicted in FIG. 1-24 is exemplary and not intended to be limiting as a variety of implementations are possible. While some elements in FIG. 1-24 are shown to comprise hardware and others software, virtually any element could be implemented in either hardware, software, or a combination thereof. Still further, it is noted that while for clarity of discussion various hardware elements are segregated between different machines and various software elements are segregated into various components, no such segregation should be deemed as required unless specifically stated herein and further or differing division into various particular components, modules, classes, objects or the like should be taken as within the scope of the present invention as limited only by the claims appended hereto. To the extent that any structural element (including software) is stated as being adapted to perform some function, such language is to be taken as a positive structural limitation imposed upon the referenced element whereby the element is required to be actually adapted, programed, configured or otherwise provided with the actual capability for performing the specified function. In no case shall such language be taken as merely a statement of intended use or the like, but to the contrary such language shall be in every case taken to read on all structures of the referenced element that are in any manner actually in the present tense configured to perform the specified function (as opposed to being merely capable of adaption for the conduct of the specified function). The deployment diagram of FIG. 1-24 may be locally hosted on a personal computer 85 as shown in FIG. 10 or may be remotely located and connected via an internet or intranet.

Turning then to FIG. 1-24, a service provider 1-8 is associated with one or more application servers 1-107 or database servers 1-112 upon which may be hosted software functionality necessary to operate within the framework of the embodiment. An application server 1-107 may accept inputs and deliver outputs through an authorization gateway 1-118 and user interface 1-119. The authorization inputs and outputs may be in any of a plurality of message formats such as, and not limited to, a comma or special character delimited message, an XML formatted message, a JASON formatted message, over any of a plurality of languages such as and not limited to, HTML (HTTP or HTTPS or SOAP), JavaScript, C programs, C++ programs, .NET and based on the Application Programming Interfaces (API) specification provided by the service provider 1-8. Preferably, the authorization gateway 1-118 is a unified authorization gateway. An application server 1-107 may host a request handler software component 1-108 adapted to handle authorization requests communicated through authorization gateway 1-118 and all other inputs through user interface 1-119 as well as to produce responses for authorization requests and for other inputs as may be necessary in the operation of the embodiment. Additionally, the application server 1-107 may host an authorizing agent 1-109 adapted to handle or otherwise control all aspects of the authorization process of the service provider 1-8, including receiving authorization requests, storing and/or retrieving data pertinent to the processing of such requests, and directing the validation of authorization codes submitted for authorization and respond based upon the results of such validations. In order to improve efficiency, the authorizing agent component 1-109 may comprise one or more further specialized components such as, for example, a validation tool 1-110 adapted to conduct the specialized task of comparing received authorization code with known buyer authorization code or buyer wallet authentication code or seller master box authorization code. Still further, the application server 1-107 may also host an administration tool 1-111 through which various aspects of the setup, maintenance and operation of the hardware and software systems of the service provider 1-8 may be managed.

In order to efficiently manage and handle the large quantity of data that may typically be stored in connection with an implementation of the present invention, one or more dedicated database servers 1-112 and hosting database management systems 1-113 are generally desired. As shown in FIG. 1-24, a typical database management system 1-113 may include a service client database 1-114 for storing a wide variety of generally service client centric data, a box database 1-115 for storing a wide variety of generally box centric data, a seller database 1-116 for storing a wide variety of generally seller centric data, and an authorization code database 1-117 for storing a wide variety of generally authorization code centric data associated with the individual transactions. Although those of ordinary skill in the art will recognize that virtually unlimited alternatives are possible, FIG. 1-11 shows a high level generally representative schema 1-90 for a service client database 1-114, FIG. 1-12 shows a high level generally representative schema 1-91 for a box database 1-115, FIG. 1-13 shows a high level generally representative schema 1-92 for a seller database 1-116, and FIG. 1-14 shows a high level generally representative schema 1-93 for an authorization code database 1-117, each of which will be described in greater detail further herein in connection with an exemplary description of the conduct of a typical transaction.

An exemplary user interface 1-119 may be implemented as a web interface 1-120 as shown in FIG. 1-25, comprising a page processor 1-123 hosted on an appropriate execution environment 1-122, installed on a dedicated web server 1-121, in communication 1-124 with a user device 1-125. The user device 1-125, such as a personal computer, smart phone, or tablet, has a hosted a web browser 1-127 running in a provided execution environment 1-126. As will be appreciated by those of ordinary skill in the art, the provision of a secured user interface 1-119 enables the various users, service clients 1-9, and sellers 1-10, to maintain and/or otherwise manage the data stored in the service client database 1-114, box database 1-115, seller database 1-116 and authorization code database 1-117 as may be appropriate as well as to generally manage and maintain the implemented authorization system 1-1.

Several initial step setups must occur prior to use of the present embodiment. Each service client 1-9 should be registered with the service provider 1-8 to receive a unique merchant ID and location ID. The service provider may assign unlimited number of unique merchant ids and unlimited number of unique location ids within each merchant ID so that service clients 1-9 can have unlimited number of locations within a merchant. Each service client 1-9 may populate the service client database 1-114, the box database 1-115, and the seller database 1-116 using a web site or a standalone computer.

In reference to FIGS. 1-11, 1-15, 1-15L, and 1-24, each service client 1-9 may populate the service client database 1-114 using form 1-94. The service client 1-9 may use a password provided by the service provider 1-8 and maintained by the service client 1-9 to access its information in service client database 1-114. The service client 1-9 may enter merchant ID, location ID, and password into a log in form 1-94L as shown in FIG. 1-15L. If the submitted credentials are valid, then the service client 1-9 may access form 1-94, if not valid then the login process is terminated. The service client 1-9 may access this information using a user interface 1-120 in FIG. 1-25 as described supra. Using form 1-94 the service client 1-9 may enter information into appropriate fields and click on submit button or review previously inputted information. The service provider 1-8 may validate the submitted information and if the submitted information is valid then the service provider 1-8 would update the service client database 1-114, otherwise the service provider 1-8 may terminate the validation process, display an error message and wait to receive the data again. The validation process includes validation of values of each individual field namely merchant name, location name, contact first name, contact last name, address line1, city, state, zip, phone, extension, mobile number and password. If merchant name or location name or contact first name or contact last name or address line1 or city or state or zip code or phone number is blank then, the said validation process will terminate otherwise, the validation process will continue. If the state is not a valid state then, the validation process will terminate otherwise, the validation process will continue. If the city is not a valid city then, the validation process will terminate otherwise, the validation process will continue. If the zip code is not a valid zip code then, the validation process will terminate otherwise the validation process will continue. If the phone number is not a valid phone number then, the validation process will terminate otherwise, the validation process will continue. If the extension is entered and is not valid then the validation process will terminate otherwise, the validation process will continue. If the mobile number is entered and is not valid then the validation process will terminate otherwise, the validation process will continue. If the password is entered and is not valid then the validation process will terminate otherwise, the validation process will continue. If the validation process terminates anytime during the validation process, an error message will be displayed in the form 1-94 and the service provider 1-8 will wait to receive the data again. If the validation process does not terminate and the entered values of all the fields in form 1-94 are valid, then the service provider updates the service client database 1-114 as per the schema 1-90. If the password is blank, then the last previously set password will be taken forward.

As shown in FIG. 1-2, the service provider 1-8 may use the flow chart 1-38 as per the use case 1-2 of the present embodiment for the service client 1-9 to add/update electronic goods pick-up boxes. In reference to FIGS. 1-12, 1-16, 1-16L, and 1-24, each service client 1-9 may populate the box database 1-115 using form 1-95. The service client 1-9 may use a password provided by the service provider 1-8 and maintained by the service client 1-9 to access the information in box database 1-115. The service client 1-9 may enter merchant ID, location ID, and password into a log in form 1-95L as shown in FIG. 1-16L. If the submitted credentials are valid, then the service client 1-9 may access form 1-95, if not valid then the login process is terminated. The service client 1-9 may access this information using a user interface 1-120 in FIG. 1-25 as described supra. To populate the fields in form 1-95, the service provider 1-8 may accept a box number form the service client 1-9 and obtain the most recent data for the box number from the box database 115. If the said box number does not exist in the said box database 115, then the service provider 1-8 would populate the fields in the form with blanks.

On form 1-95, the service client 1-9 may enter information into appropriate fields and click on submit button. The service provider 1-8 may validate the submitted information and if the submitted information is valid then the service provider 1-8 would update the electronic goods pick-up box database 1-115, otherwise the service provider 1-8 may terminate the validation process, display an error message and wait to receive the data again. The validation process includes validation of values of each individual field, namely box number, status, identifier type, front side identifier, and back side identifier. The box number is the electronic goods pick-up box unique external identifier provided by service client 1-9. The front side identifier is the unique internal identifier of the remotely controlled electronic door attached to the front side of the electronic goods pick-up box. The back side identifier is the unique internal identifier of the remotely controlled electronic door attached to the back side of the electronic goods pick-up box. The said unique internal identifier of any remotely controlled electronic door is the value of the dip switch settings 1-73 or serial number 1-74 of the microcontroller 1-69 board controlling the said remotely controlled electronic door, depending on the identifier type. If the box number is not blank and is an integer (number without decimals) then, the said validation process will continue otherwise, the validation process will terminate. If the status is Active or Inactive then, the said validation process will continue otherwise, the validation process will terminate. If the identifier type is Dip Switch or Serial Number then, the said validation process will continue otherwise, the validation process will terminate. If the front side identifier is blank or an integer then, the said validation process will continue otherwise, the validation process will terminate. If the back side identifier is blank or an integer then, the said validation process will continue otherwise, the validation process will terminate. If the front side identifier is an integer or back side identifier is an integer then, the said validation process will continue otherwise, the validation process will terminate. If the same internal identifier is used by any other remotely controlled electronic door attached to any electronic goods pick-up box within the location identified by merchant ID and location ID then, the validation process will terminate, otherwise it will continue. If the internal identifier type is serial number and if the same internal identifier is used by any other remotely controlled electronic door attached to any electronic goods pick-up box within any location identified by any merchant ID and by any location ID then, the validation process will terminate, otherwise it will continue. If the validation process terminates anytime during the validation process an error message will be displayed in the form 1-16 and the service provider 1-8 will wait to receive the data again. If the validation process does not terminate and the entered values of all the fields as shown in FIG. 1-16 are valid, then the service provider 1-8 would update the box database 1-115 as per the schema 1-91 shown in FIG. 1-12. If box (electronic goods pick-up box) number does not exist in the box database 1-115 then, the values for front side position and back side position will be set to otherwise the values for the said fields will be taken forward from the last previously set values. If box (electronic goods pick-up box) number does not exist in the box database 1-115 then, the box information will be added in the database 1-115 otherwise, the box information will be updated in the database 1-115.

Additional information for each electronic goods pickup box may be required or permitted such as dimensions of the box, scanners available such as Bluetooth, NFC. etc, and other characteristics of the box such as whether it has climate control capabilities like refrigeration or heating. Such information, if desired, would be requested on form 1-95 and stored in database 1-115.

In an alternative embodiment, if the service provider 1-8 owns, exercise control, or leases the electronic goods pick-up box, the box database may be prepopulated with the values identified in form 1-95. In this embodiment, a service client 1-95 would select an electronic goods pick-up box based on location or next available. Such selection will link the specific electronic goods pick-up box with the service client 1-9 and values of form 1-95 will be updated accordingly.

As shown in FIG. 1-3, the service provider 1-8 may use the flow chart 1-39 as per the use case 1-3 of the present embodiment for the service client 1-9 to add/update sellers 1-10. In reference to FIGS. 1-13, 1-17, 1-17L, and 1-24, each service client 1-9 may populate the seller database 1-116 using form 1-96. The service client 1-9 may use a password provided by the service provider 1-8 and maintained by the service client 1-9 to access the information in seller database 1-116. The service client 1-9 may enter merchant ID, location ID, and password into a log in form 1-96L as shown in FIG. 1-17L. If the submitted credentials are valid, then the service client 1-9 may access form 1-96, if not valid then the login process is terminated. The service client 1-9 may access this information using a user interface 1-120 in FIG. 1-25 as described supra. To populate the fields in form 1-96, the service provider 1-8 may accept a seller number from the service client 1-9 and obtain the most recent data for the seller number from the seller database 116. If the seller number does not exist, then the service provider 1-8 would populate the fields in the form 1-96 with blanks.

On form 1-96, the service client 1-9 may enter information into appropriate fields and click on submit button. The service provider 1-8 may validate the submitted information and if the submitted information is valid then the service provider 1-8 would update the seller database 1-116, otherwise the service provider 1-8 may terminate the validation process, display an error message and wait to receive the data again. The validation process includes validation of values of each individual field, namely seller number, status, first name, last name, email address, master authorization code, mobile number and password. The seller number is a unique number provided by service client 1-9 to each individual seller. If the seller number is not blank and is an integer then, the said validation process will continue otherwise, the validation process will terminate. If the status is Active or Inactive then, the said validation process will continue otherwise, the validation process will terminate. If the contact first name or contact last name or email address or master authorization code is blank, then the validation process will terminate otherwise it will continue. If email address is a valid email address, then the process will continue otherwise it will terminate. If mobile number is blank or valid mobile number then the process will continue, otherwise it will terminate. If mobile number is not blank and the same mobile number is used for more than one seller within a location identified by merchant ID and location ID then the process will terminate, otherwise it will continue. If the validation process terminates anytime during the validation process an error message will be displayed in the form 1-96 and the service provider 1-8 will wait to receive the data again. If the validation process does not terminate and the entered values of all the fields in form 1-96 are valid, then the service provider 1-8 would update the seller database 1-116 as per the schema 1-92 as shown in FIG. 1-13. If seller number does not exist in the seller database 1-116 then, the seller information will be added in the database 1-116 otherwise, the seller information will be updated in the database 1-116. If the password is blank, then the last previously set password will be taken forward.

As shown in FIG. 1-4, the service provider 1-8 may use the flow chart 1-40 as per the use case 1-4 of the present embodiment for the sellers 1-10 to update seller's profile. In reference to FIGS. 1-18 and 1-18L each sellers 1-10 may update its profile using form 1-97. The seller 1-10 may use a password provided by the service client 1-9. The seller 1-10 may enter merchant ID, location ID, seller number, and password into a log in form 1-97L as shown in FIG. 1-18L. If the submitted credentials are valid, then the seller 1-10 may access form 1-97, if not valid then the login process is terminated. The seller 1-10 may access this information using a user interface 1-120 in FIG. 1-25 as described supra.

On form 1-97, the seller 1-10 may enter information into appropriate fields and click on submit button. The service provider 1-8 may validate the submitted information and if the submitted information is valid then the service provider 1-8 would update the seller database 1-116, otherwise the service provider 1-8 may terminate the validation process, display an error message and wait to receive the data again. The validation process includes validation of values of each individual field, namely master authorization code and password. The seller number is a unique number provided by service client 1-9 to each individual seller. If the master authorization code is not blank, an integer and the same master authorization code is not currently being used by any other seller within the said merchant ID and location ID, then the validation process will continue, otherwise it will terminate. If the validation process terminates anytime during the validation process an error message will be displayed in the form 1-97 and the service provider 1-8 will wait to receive the data again. If the validation process does not terminate and the entered values of all the fields as shown in form 1-97 are valid, then the service provider 1-8 would update the seller database 1-116 as per the schema 1-92 as shown in FIG. 1-13. If the password is blank, then the last previously set password will be taken forward.

As shown in FIG. 1-5, the service provider 1-8 may use the flow chart 1-41 as per the use case 1-5 of the present embodiment to generate and store unique authorization codes. In reference to FIGS. 1-19 and 1-19L each seller 1-10 may request an authorization code using form 1-98. The seller 1-10 may use a password provided by the service client 1-9. The seller 1-10 may enter merchant ID, location ID, seller number, and password into a log in form 1-98L as shown in FIG. 1-19L. If the submitted credentials are valid, then the seller 1-10 may access form 1-98, if not valid then the login process is terminated. The seller 1-10 may access this information using a user interface 1-120 in FIG. 1-25 as described supra.

Once the form 1-98 as shown in FIG. 1-19 is presented, the sellers 1-10 would enter the required information into appropriate fields and click on submit button. The service provider 1-8 would validate the submitted information and if the submitted information is valid then the service provider 1-8 would update the authorization code database 1-117, otherwise the service provider 1-8 would terminate the validation process, display an error message and wait to receive the data again. The said validation process includes validation of values of each individual field namely transaction number and buyer's 1-12 mobile number. If the transaction number is blank or an integer, then the validation process will continue, otherwise it will terminate. If the transaction number is blank, then the service provider would assign a unique number, specific for the location identified by the merchant ID and location ID, using an incremental counter or a random number, to the transaction number. If the transaction number is an integer and have already been used, then the validation process will terminate otherwise it will continue. If the customer mobile number is blank or a valid phone number, then the validation process will continue, otherwise it will terminate. If the validation process does not terminate and the entered values of all the fields as shown in form 1-98 are valid, then the service provider 1-8 would create a unique authorization code and update the authorization code database 1-117 as per the schema 1-93 as shown in FIG. 1-14.

Other types of buyer's information may include mobile number, Bluetooth address, email address or other form of communication with the buyer. This information may be used to notify the buyer when the goods are ready and provide access for the buyer to utilize the authorization code.

Authorization codes in authorization code database 1-117 may expire based on data and time the authorization codes were added into the authorization code database 1-117. So the programmatically executable procedure to expire authorization codes, based on lapsed time, in the authorization code database 1-117 will be executed at a constant short interval of time. As shown in FIG. 1-1, the service provider 1-8 would use time 1-36 as an actor and provide a means 1-37 to expire the authorization codes as time elapses. The service provider 1-8 may constantly monitor the authorization code database 117 to expire the authorization codes based on the value in Open_DateTime and current date and time. The service provider 1-8 would read the values of Open_Datetime of all authorization codes with the value ‘A’ for status. Then the service provider 1-8 would calculate the elapsed time between the current date and time and the authorization code Open_DateTime. If the elapsed time is longer than a preset expiration time, then the service provider 1-8 would update the value of status to ‘E’ and the value of Open_Datetime to current date and time.

Upon successful completion of initial set up by service provider, 1-8, service client 1-9, and sellers 1-10, the service client 1-9 may proceed using the electronic goods pick-up box in accordance with the present embodiment.

The method of providing a secure pickup for goods processed through this system is generally described in reference to FIGS. 1-1, 1-5, 1-6, 1-7, 1-8, 1-9, 1-21, 1-22, 1-23, 1-24, and 1-25 in an exemplary embodiment for use. Broadly, there are three general steps in this process 1) order entry; 2) processing and delivering goods to the electronic goods pick-up box; and 3) buyer picking up the goods.

The order entry process may occur through any number of known order placement modalities so long as each order is tracked via a transaction number and the buyer identifies a modality in which the buyer elects to receive the authorization code. The buyer may also specify a pickup location or has the option to select a pickup location from the service client during the order processing. The order placement may occur manually by the service client in situations in which the buyer verbally tells the service client what order they wish to place either in person or telephonically. In this situation, the service client is entering the order information. The order entry may also occur through a point of sale system in which the buyer 1-12 inputs an order through an automated process at the place of pickup. The order entry may also occur through the internet with a buyer using an app or a website which is in communication with the service client 1-9 or operated by the service client. For internet based order, the order entry process requires access to the box database 1-115 such that a buyer may be able to specify a general geographic location for pickup.

Once the order is placed, the service client 1-9 processes the order and prepares the goods for placement in the electronic goods pick-up box. As described supra and in reference to use case 1-5 in FIG. 1-1, authorization code request 1-41 in FIG. 1-5, seller login form 1-98L in FIGS. 1-19L, and request authorization code form 1-98 in FIG. 1-19, a seller 1-10 requests and obtains an authorization code based on an individual transaction number that corresponds to the buyer's order. The authorization code database 1-117 is updated to identify a unique authorization code per unique individual transaction number.

As shown in FIG. 1-6, the service provider 1-8 may use the flow chart 1-42 as per the use case 1-6 of the present embodiment for the sellers 1-10 to add pick-up ready information. In reference to FIGS. 1-21 and 1-21L each seller 1-10 may update the pick-up ready information using form 1-100. The seller 1-10 may use a password provided by the service client 1-9. The seller 1-10 may enter merchant ID, location ID, seller number, and password into a login form 1-100L as shown in FIG. 1-21L. If the submitted credentials are valid, then the seller 1-10 may access form 1-100, if not valid then the login process is terminated. The seller 1-10 may access this information using a user interface 1-120 in FIG. 1-25 as described supra.

Once the form 1-100 as shown in FIG. 1-21 is presented, the sellers 1-10 would enter the required information into appropriate fields and click on submit button. The service provider 1-8 would validate the submitted information and if the submitted information is valid then the service provider 1-8 would update the authorization code database 1-117 with the pick-up ready information, otherwise the service provider 1-8 would terminate the validation process, display an error message and wait to receive the data again. The said validation process includes validation of values of each individual field namely transaction number, box number and authorization code. The service provider 1-8 would list all available box numbers in a drop down list from which the seller could select one. The seller 1-10 may then identify an electronic goods pick-up box. Such selection may occur manually by the seller 1-10 if certain characteristics of the box are desired or automatically based on next available electronic goods pick-up box. If the service client and seller are at the point of sale, such as a restaurant or kiosk ordering, the seller may know which electronic goods pick-up box it wishes to use. In remote ordering situations such as telephonically or internet based, the electronic goods pick-up box selection may be automatic. The door position fields of the box database 1-115, would identify the position of each door attached to each box. Any box in active status with at least one connected door in unlocked position would be considered as available. Only doors that have valid internal dip switch settings or valid internal serial number will be considered as connected door. If no box is available, then the validation process will terminate otherwise it will continue. The seller would enter or scan transaction number from merchant copy of the receipt. If the transaction number and authorization code have already been added into authorization code database 1-117, then the seller need not enter authorization code, otherwise the seller would enter or scan the authorization code from the merchant copy of the receipt. If the transaction number is not blank and an integer then the validation process will continue, otherwise it will terminate. If the authorization code database 1-117 has been updated with the entered transaction number and if the authorization code in the database is not in active status, then the validation process will terminate otherwise it will terminate. If the authorization code is blank or an integer, then the validation process will continue, otherwise it will terminate. If the authorization code is blank and if the authorization code database 1-117 has been updated with the entered transaction number and an authorization code, then the validation process will continue otherwise it will terminate. If the authorization code is not blank and if the authorization code database 1-117 has been updated with the entered transaction number and an authorization code and if the entered authorization code does not match with the authorization code in the authorization code database 1-117, then the validation process will terminate otherwise it will continue. If the validation process does not terminate and the entered values of all the fields as shown in FIG. 1-21 are valid, then the service provider 1-8 would add pick-up ready information.

If the entered transaction number has already been added into the authorization code database 1-117 then the authorization code database 1-117 will be updated with the box number, otherwise the authorization code database 1-117 will be updated with transaction number, authorization code and the box number. Also the authorization code database 117 will be updated with the value ‘A’ for status and with the current data and time for Add DateTime. If the validation process terminates anytime during the validation process or during authorization code database 1-117 update process then, an error message will be displayed in the form 1-21 and the service provider 1-8 will wait to receive the data again from the seller 1-10.

The seller 1-10 then places the goods in the predetermined electronic goods pickup box. The type of electronic goods pickup box depends on the retail situation utilized. For example, in a restaurant or take out order location, a single door electronic goods pickup box 1-45 embodiment may be used. In this example, the seller 1-10 would place the goods into the hollow side of the single door electronic goods pickup box 1-45. Once the goods are placed the seller 1-10 would press ‘LOCK’ button 1-53. As per FIGS. 1-9, 1-10 and 1-24, pressing the “LOCK” button 1-53 will instruct the microcontroller 1-69 to send a request message consisting of a “lock” command related to the electronic door 1-47 and the dip switch 1-73 settings and/or serial number 1-74 of related to the electronic goods pickup box to the personal computer 1-85 through the network 1-84.

In the case of goods pick-up box 1-54 with double electronic door such as in an environment in which a two-sided delivery box is necessary (such as when multiple service clients are using an array or bay of electronic goods pickup boxes such as FIG. 1-23 or if a service client provides a pick up goods box with one door facing inside a store with the second door facing a drive through lane providing a buyer with two options to pick up), the seller 1-10 would place the goods through the door facing front side 1-56 or through the door facing back side 1-61 whichever is accessible and then lock both front and back doors. To lock the front door 1-56, the seller would press the ‘FRONT LOCK’ button 1-65. To lock the back door 1-61, the seller would press the ‘BACK LOCK’ button 1-66. The microcontroller 1-69 would format the request message which consists of a command which is ‘Front Lock’ and/or “Back Lock” the dip switch 1-73 settings and/or serial number 1-74 of related to the electronic goods pickup box to the personal computer 1-85 through the network 1-84.

In the situation where an enclosed electronic goods pickup box with a single door is preferred the seller 1-10 would open the electronic door and place the goods into the electronic goods pickup box 1-45. The door may always be unlocked unless a seller 1-10 properly activates the locking process. Once the goods are placed the seller 1-10 would press ‘LOCK’ button. As per FIGS. 1-9, 1-10 and 1-24, pressing the “LOCK” button will instruct the microcontroller 1-69 to send a request message consisting of a “lock” command related to the electronic door 1-47 and the dip switch 1-73 settings and/or serial number 1-74 of related to the electronic goods pickup box to the personal computer 1-85 through the network 1-84. Alternatively, in a home or office setting, the buyer may have a shared electronic goods pickup box. In the case of shared electronic goods pickup boxes, the available shared electronic goods pickup boxes may always be unlocked. For a seller or shipper to place the goods, they must obtain a one-time authorization code that permits the locking of the shared electronic goods pickup box. In this situation, the shipper places the goods, and then further locks the shared electronic goods pickup box with a one-time authorization code. For the buyer to retrieve the goods, the buyer must obtain a one-time authorization code that permits the unlocking of the shared electronic goods pickup box. The buyer may then use a one-time authorization code to open the shared electronic goods pickup box. Such method only allows a shipper or seller access to the shared electronic goods pickup box once an order is placed.

In each of the above situations, single door, double door, and fully enclosed with a single door, the personal computer 1-85, upon receiving the lock command and specific box identifiers, would add location specific information like merchant ID and location ID to the request message and forward the said request message to the service provider 1-8 through the authorization gateway 1-118 as shown in FIG. 1-24. The service provider 1-8, in order to verify the request message, would forward the request message to the request handler 1-108 to handle the request. The request handler 1-108 then verify the location information in the request message namely the merchant ID and the location ID. If the merchant ID and the location ID exists in the service client database 1-114 and if the current status is active then the request handler would forward the request message to authorizing agent 1-109, otherwise the verification process would terminate with response type ‘DENY’ and error message ‘Invalid Location’. The authorizing agent would verify the microcontroller information in the request message namely the dip switch settings 1-73 and/or serial number 1-74 using the box database 1-115. If the value for the field Identifier_Type in box database 115 as shown in FIG. 1-12 is ‘D’, then the authorizing agent would locate the box number and the side of the door using the dip switch settings, otherwise the authorizing agent would locate the box number and the side of the door using the serial number. If the authorizing agent could locate the box number and the side of the door then the authorizing agent would add the box number and the side of the door to the request message and forward the said request message to the validation tool, otherwise the verification process would terminate with response type ‘DENY’ and response message ‘Invalid box and/or side’. If the verification process has not been terminated, then the service provider 1-8 would update the box database 1-115 by setting the value for Front_Side_Position to ‘L’ or Back_Side_Position to ‘L’ depending on the side of the door in the request message and would terminate with the response type ‘APPROVE’ and with blank for response message. If the response type in the response received by the microcontroller 1-69 is ‘APPROVE’ then the microcontroller 1-69 would lock the door from which the request originated. This prevents an accidental pressing of a lock button on an electronic foods pickup box if the box is not presently designated to receive an order for a buyer to pickup.

Once the service provider 1-8 receives a valid request to lock the electronic goods pickup box, the service provider 1-8 sends a notification to the buyer 1-12 that the goods are ready to pickup, the identifying information related to the specific electronic goods pickup box such as location and unique identifier, and the authorization code. Service provider 1-8 utilizes the information obtained about the buyer during the request authorization code form 1-98 as seen in FIG. 1-19. The buyer's information may be a mobile number, Bluetooth address, email address or other form of communication with the buyer. The buyer's information may also have a preference for the type of authorization code which is matched along with the electronic goods pickup boxes capabilities (NFC, keypad, QR code, etc.).

In certain settings like restaurant or point of sale purchases, a display screen 1-101 as seen in FIG. 1-22 may be utilized. Once the service provider 1-8 receives a valid request to lock the electronic goods pickup box, the service provider 1-8 updates the screen 1-22 to include information related to a transaction number and may include a buyer's first name. In this example, the buyer's authorization code will be present on the receipt for the point of sale transaction. In furtherance of this example, the cashier acting as the service client and seller, request an authorization code by generating the order. Upon completion of the ordering process, the authorization code is requested and generated and printed upon a receipt 99 as seen in FIG. 1-20.

Once the buyer 1-12 receives notification of the order to be picked up, the buyer 1-12 physically goes to the location of the specific electronic goods pick-up box. The buyer 1-12, having received the notification and the authorization code, enters the one-time authorization code based on the specific format (manual key pad entry, QR scanner, NFC, etc.) and presses the ‘UNLOCK’ button. If a QR scanner, Bluetooth, or NFC is used, a buyer's 1-12 mobile device may be used to supply the authorization code and may be used to give a command to “UNLOCK” the electronic goods delivery box. A seller 1-10 or service client 1-9 may enter a master authorization code and press ‘UNLOCK’ button. The microcontroller 1-69 formats the request message which consists of a command which is ‘UNLOCK’, dip switch 1-73 settings and/or serial number 1-74 of the controller attached to the electronic door 1-47 or 1-56 or 1-61. The microcontroller 1-69 would forward the request message to the personal computer 1-85 through the network 1-84. Then the personal computer 1-85 would add location specific information like merchant ID and location ID to the request message and forward the said request message to the service provider 1-8 through the authorization gateway 1-118 as shown in FIG. 1-24.

Alternatively, if a key pad, QR scanner, Bluetooth, NFC, or RFID is not used, a buyer's 1-12 mobile device may be used to communicate directly with the service provider (and/or the service provider's servers) and supply the authorization code and then give a command to “UNLOCK” the electronic goods delivery box from the microprocessor.

The service provider 1-8, in order to verify the request message, would forward the request message to the request handler 1-108 to handle the request. The request handler 1-108 then verify the location information in the request message namely the merchant ID and the location ID. If the merchant ID and the location ID exists in the service client database 1-114 and if the current status is active then the request handler would forward the request message to authorizing agent 1-109, otherwise the verification process would terminate with response type ‘DENY’ and error message ‘Invalid Location’. The authorizing agent would verify the microcontroller information in the request message namely the dip switch settings 1-73 and/or serial number 1-74 using the box database 1-115. If the value for the field Identifier_Type in box database 115 as shown in FIG. 1-12 is ‘D’, then the authorizing agent would locate the box number and the side of the door using the dip switch settings, otherwise the authorizing agent would locate the box number and the side of the door using the serial number. If the authorizing agent could locate the box number and the side of the door then the authorizing agent would add the box number and the side of the door to the request message and forward the said request message to the validation tool, otherwise the verification process would terminate with response type ‘DENY’ and response message ‘Invalid box and/or side’.

The validation tool would use merchant ID, location ID, the one-time authorization code, the box number and the side of the door (if applicable) in the said request message that was passed on by the authorizing agent to verify the one-time passcode using the authorization code database 1-117. If the merchant ID, location ID, one-time authorization code, box number and the side of the door exist in the authorization code database 1-117 with the status ‘A’ then the verification process would be considered as successful.

If the verification process is not successful, then the service provider would communicate with wallet providers to authenticate the buyer. The process to authenticate the buyer with wallet providers would vary from each other. At a minimum the service provider would send merchant ID, location ID, one-time authorization code received in the request message along with each transaction number that are currently active in authorization code database 1-117 based on merchant ID, location ID, box number and the side of the door in the request message. When the buyer made the payment with a wallet provider, the seller would have sent the merchant ID, store ID and transaction number to the wallet provider. If an authentication is successful, then the verification process would be considered as successful.

If the verification is not successful, then the service provider would determine whether the request is from a seller 1-10. If the one-time authorization code in the request message is equal to master authorization code of any active seller 1-10, then verification process would be considered successful.

If the verification process is successful then the service provider 1-8 would update the authorization code database 1-117 using the merchant ID, location ID, box number and side of the door received in the request message by setting the values for Status to and for Open_DateTime to current date time. Also, if the verification process is successful then the service provider 1-8 would also update the most current row in goods pick-up box database 1-115 by setting the value of Front_Side_Position or Back_Side_Position to II based on merchant ID, location ID, the box number and side of the door received in the request message. If the verification process is successful, then the verification process would be complete and the service provider 1-8 would set the response type to ‘APPROVE’ and response message to ‘Unlocked’, otherwise the verification process would terminate with the response type ‘DENY’ and response message ‘Invalid Authorization Code’.

If the response type in the response received by the microcontroller 1-69 is ‘APPROVE’ then the microcontroller 1-69 would unlock the door from which the request originated and display the response message in the appropriate display monitor, otherwise the microcontroller i-69 would simply display the response message in the appropriate display monitor.

The service provider 1-8 uses several programmatically executable procedures loaded into the microcontroller 1-69, the personal computer 1-85 and the application server 1-107 which are executed based on buyers' 1-12 and sellers' 1-10 requests. Some programmatically executable procedures will be programmed to execute automatically at specified intervals without any user input or action, others will be executed only because of some user input or user action.

In certain embodiments a service client may authorize a shipping company to act as a seller. In this example, a buyer may have a dedicated electronic goods pickup box at a home or office location with specified unique identifiers. The shipper, acting as a seller, will indicate the buyer's dedicated electronic goods pickup box in the request for an authorization code. In this example the process will act the same except the electronic goods pickup box is specifically identified. In an alternative embodiment, the electronic goods pickup box may always be locked. For a seller or shipper to gain access to the electronic goods pickup box, they must obtain an authorization code that permits the unlocking of the electronic goods pickup box. In this situation, the shipper unlocks the electronic goods pickup box via an authorization code, then places the goods, and then further locks the electronic goods pickup box. The buyer may then use a master authorization code to open the electronic goods pickup box. Such method only allows a shipper or seller access to the electronic goods pickup box once an order is placed.

There are numerous applications for the embodiment disclosed in the electronic goods pick-up box system 1-1 including buyer/service client transactions through face to face orders, self-service kiosks, internet/telephone orders for takeout/pickup/delivery, or application based orders for takeout/pickup/delivery. The authorization code printed on sales receipts for all types of transactions will generally be referred as authorization code. This could be the authorization code received by Point of Sales systems from credit card processor or an authorization code generated by Point of Sales systems. Usually this is the code accepted by Point of Sales systems to process returned goods. For manual transactions, sellers can request for an authorization code from the service providers.

Application of the embodiment disclosed in the electronic goods pick-up box system 1-1 for a face to face transaction may result in the following. Buyer purchases or orders designated goods at a face to face interaction with a seller. Each sales receipt is assigned a unique transaction number and a unique authorization code printed or displayed on the receipt. Once the goods are prepared, the seller uses the service provider to identify a goods pick-up box, places the goods in the goods pickup box, and may lock one or more doors on the box depending on the embodiment of the goods pickup box. The service provider then may update a digital screen that displays the unique transaction number printed or displayed on the receipt and the external identifier assigned to the goods pick-up box where the goods are placed. If the name of the buyer is available (for example through credit/debit card or through the wallet payment) then the name of the buyer may be displayed on the digital screen. In addition to displaying the information on a digital screen, the service provider may provide the same information to the buyer through other communication means such as text messages. Upon such notification, the buyer enters the authorization code printed on the receipt on the key pad attached to the goods pick-up box to unlock the goods pick-up box. Alternatively, the buyer enters the authorization code using other electronic means such as QR Code, Bluetooth, NFC, or RFID if such applications are available. Further, buyer may also enter the authorization through a service provider's website or application which will in turn unlock the goods pickup box.

Application of the embodiment disclosed in the electronic goods pick-up box system 1-1 for a self-serve kiosk transaction may result in the following. Buyer purchases or orders goods at a self-serve kiosk. Each sales receipt is assigned a unique transaction number and a unique authorization code printed or displayed on the receipt. Once the goods are prepared, the seller uses the service provider to identify a goods pick-up box, places the goods in the goods pickup box, and may lock one or more doors on the box depending on the embodiment of the goods pickup box. The service provider then may update a digital screen that displays the unique transaction number printed or displayed on the receipt and the external identifier assigned to the goods pick-up box where the goods are placed. If the name of the buyer is available (for example through credit/debit card or through the wallet payment) then the name of the buyer may be displayed on the digital screen. In addition to displaying the information on a digital screen, the service provider may provide the same information to the buyer through other communication means such as text messages. Upon such notification, the buyer enters the authorization code printed on the receipt on the key pad attached to the goods pick-up box to unlock the goods pick-up box. Alternatively, the buyer enters the authorization code using other electronic means such as QR Code, Bluetooth, NFC, or RFID if such applications are available. Further, buyer may also enter the authorization through a service provider's website or application which will in turn unlock the goods pickup box.

Application of the embodiment disclosed in the electronic goods pick-up box system 1-1 for an internet/telephone/application-based transaction with the buyer picking up the goods may result in the following. Buyer purchases or orders goods verbally from the seller or through an internet based application/website. Buyer may designate a location in which the service provider has available goods pickup boxes. Each sales receipt is assigned a unique transaction number and a unique authorization code printed or displayed on the receipt. Once the goods are prepared, the seller uses the service provider to identify a goods pick-up box, places the goods in the goods pickup box, and may lock one or more doors on the box depending on the embodiment of the goods pickup box. The service provider then may update a digital screen, available in store or at a drive through lane, which displays the unique transaction number printed or displayed on the receipt and the external identifier assigned to the goods pick-up box where the goods are placed. If the name of the buyer is available (for example through credit/debit card or through the wallet payment) then the name of the buyer may be displayed on the digital screen. In addition to displaying the information on a digital screen, the service provider may provide the same information to the buyer through other communication means such as text messages. Upon such notification, the buyer may then access the goods pickup box in the store or a drive through lane. The buyer then enters the authorization code printed on the receipt on the key pad attached to the goods pick-up box to unlock the goods pick-up box. Alternatively, the buyer enters the authorization code using other electronic means such as QR Code, Bluetooth, NFC, or RFID if such applications are available. Further, buyer may also enter the authorization through a service provider's website or application which will in turn unlock the goods pickup box.

Application of the embodiment disclosed in the electronic goods pick-up box system 1-1 for an internet/telephone/application-based transaction with the seller delivering the goods may result in the following. Buyer purchases or orders goods verbally from the seller or through an internet based application/website. Buyer designates buyer's goods pickup box at its location or one in which it controls. Each sales receipt is assigned a unique transaction number and a unique authorization code printed or displayed on the receipt. Once the goods are prepared, the seller uses the authorization code for the goods pick-up box and places the goods in the goods pickup box, and may lock one or more doors on the box depending on the embodiment of the goods pickup box. Seller may enter the authorization code on the key pad attached to the goods pick-up box to unlock the goods pick-up box. Alternatively, the seller enters the authorization code using other electronic means such as QR Code, Bluetooth, NFC, or RFID if such applications are available. The service provider may provide notification to the buyer that the goods were delivered through communication means such as text messages. Upon such notification, the buyer may then access the goods pickup box using buyer's master authorization code.

In at least some implementations of the present embodiment the seller and the buyer need not face each other even for offline transactions.

In at least some implementations of the present embodiment the seller need not wait to hand over the goods to buyer before starting a new sales transaction.

In at least some implementations of the present embodiment the service client need not maintain a goods pick-up station with dedicated or part-time sellers handing over the goods.

In at least some implementations of the present embodiment the service client need not place goods in unsecured and unprotected area.

In at least some implementations of the present embodiment the service client need not deliver the goods to service client specified location within service client's location.

In at least some implementations of the present embodiment the service client need not manage check-out counters.

In at least some implementations of the present embodiment the service client need not store large items of the same product on the shopping floor.

While the foregoing description is exemplary of the present embodiment, those of ordinary skill in the relevant arts will recognize the many variations, alterations, modifications, substitutions and the likes are readily possible, especially in light of this description, the accompanying drawings and claims drawn thereto. For example, those of ordinary skill in the art will recognize that special programs for hotels or the like may be implemented where guests can pick-up room keys without getting them from a live receptionist over the counter. Likewise, those of ordinary skill in the art will recognize that special programs for shipping companies or the like may be implemented where recipients of goods can pick-up the goods, any day or time, without getting them from a live operator over the counter.

### Second Embodiment

This embodiment relates to a system for a self-serve security scanning station for goods to permit the secure passing of goods from an unsecured area to a secured area. This embodiment comprises at least one scanning chamber having at least two remotely controlled electronic doors accessible to interior of the scanning chamber wherein the scanning chamber may have at least one security x-ray scanners for scanning the interior.

Referring to FIG. 2-1, the self-serve security scanning station for goods 2-1 generally comprises a service provider 2-8, an operative combination of a plurality of service clients 2-9 with implemented use cases 2-2 and 2-3, a plurality of inspectors 2-10 with implemented use cases 2-4, 2-5 and 2-6, and at least one end user 2-12 with implemented use case 2-7. A service client is generally referred to as a security administrative provider such as the Transportation Security Administration (TSA) or private security for public gatherings. An inspector is generally referred to as an agent or employee of the service client. A service provider facilitates the services described herein by managing the hardware and software of the self-serve security scanning station for goods 2-1. A service provider may also be the service client.

The service provider 2-8 generally provides a means 2-13 for service clients 2-9 to access a form to add/update the scanning chamber. The service client 2-9 generally uses the means 2-14 to submit the request to add/update the scanning chamber. The service provider 2-8 generally uses means 2-15 to approve/deny the service client's request. The use case 2-2 for adding/updating the scanning chamber 2-38 is further detailed in a flow chart in FIG. 2-2.

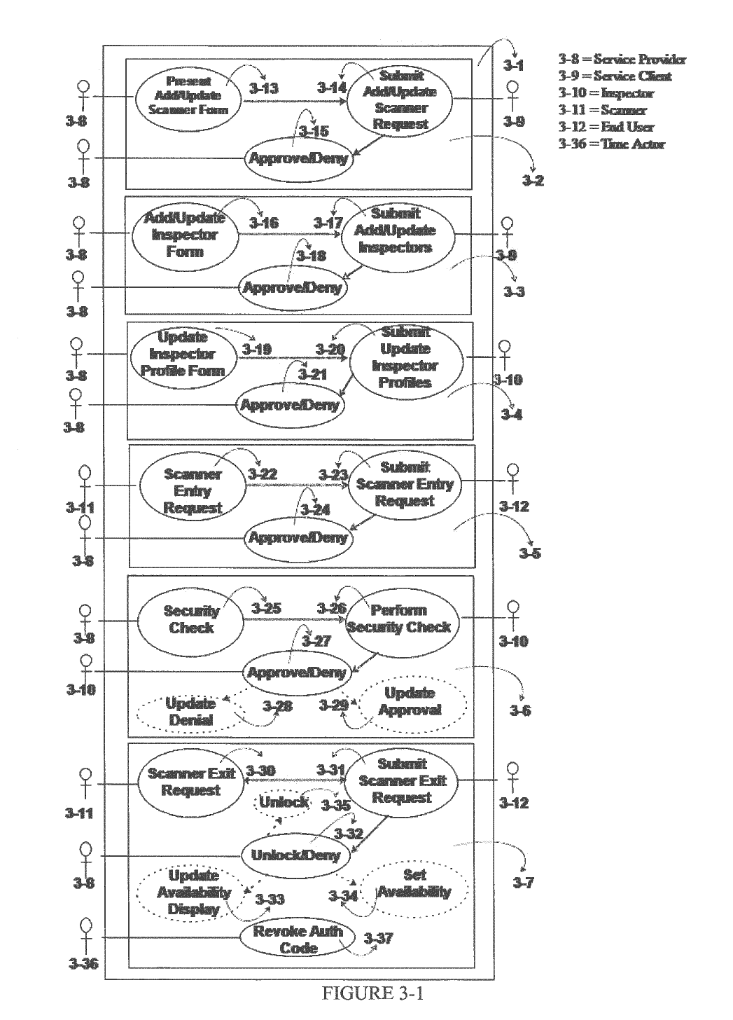

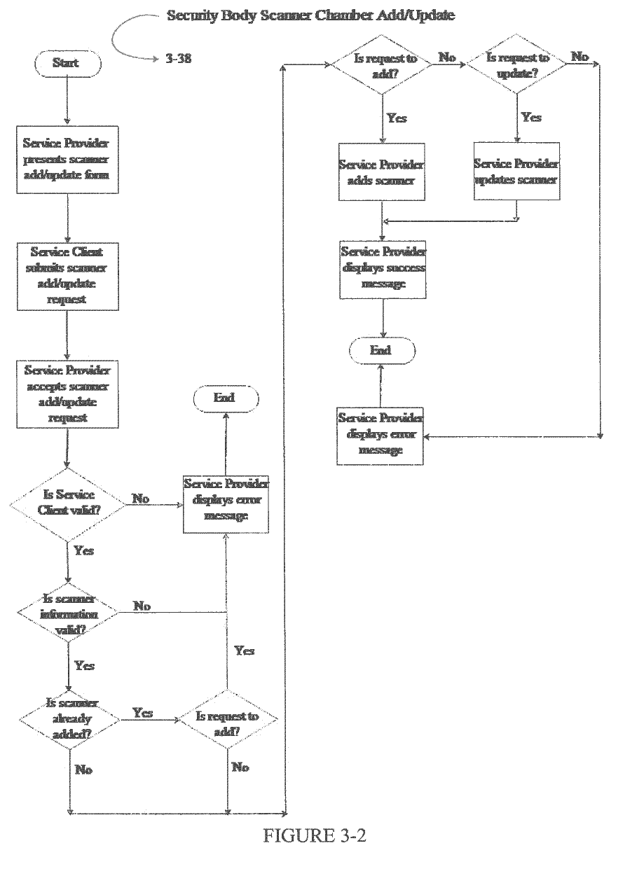

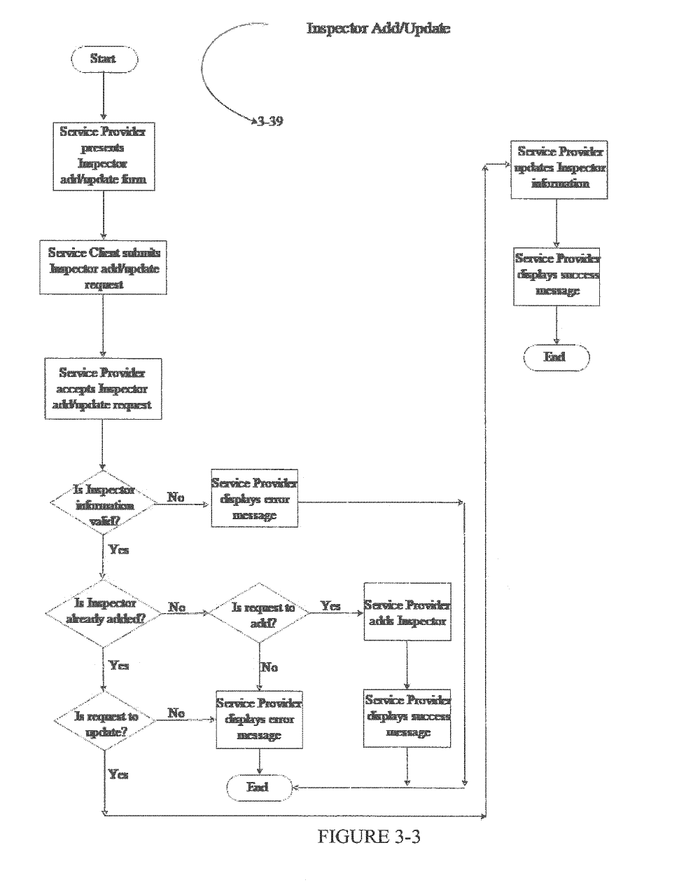

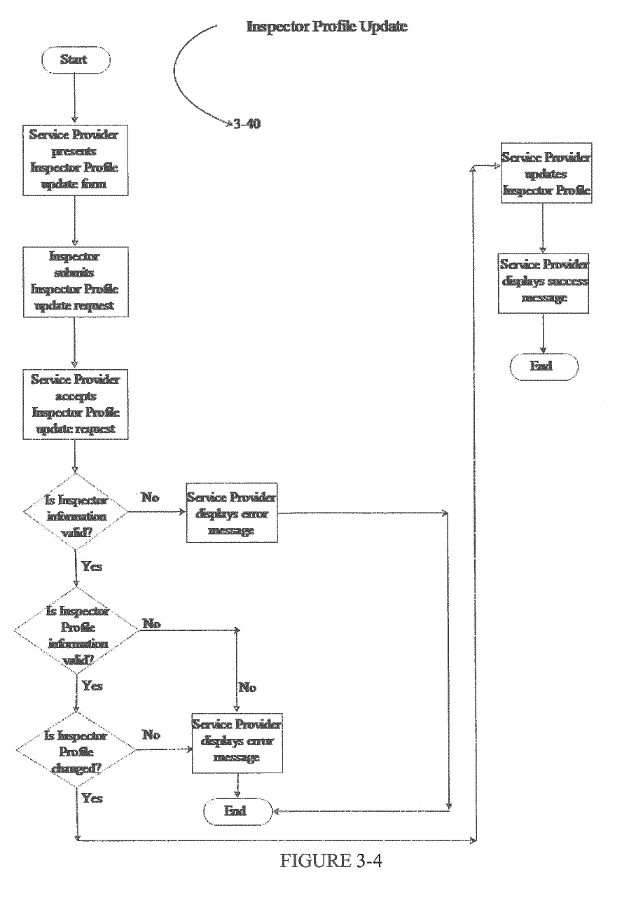

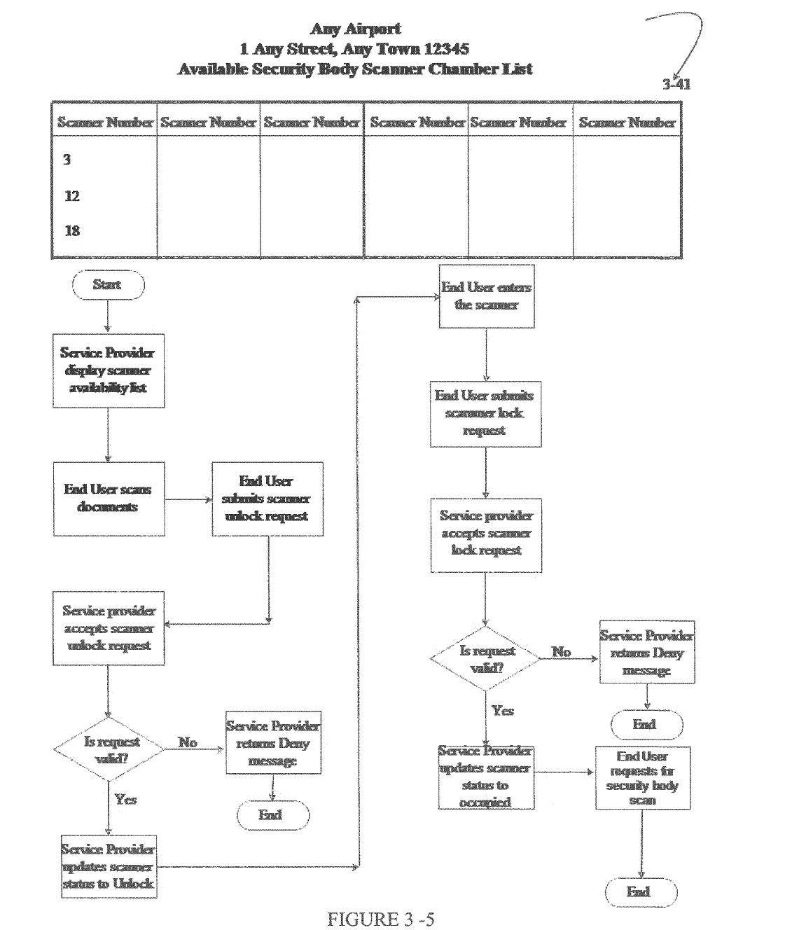

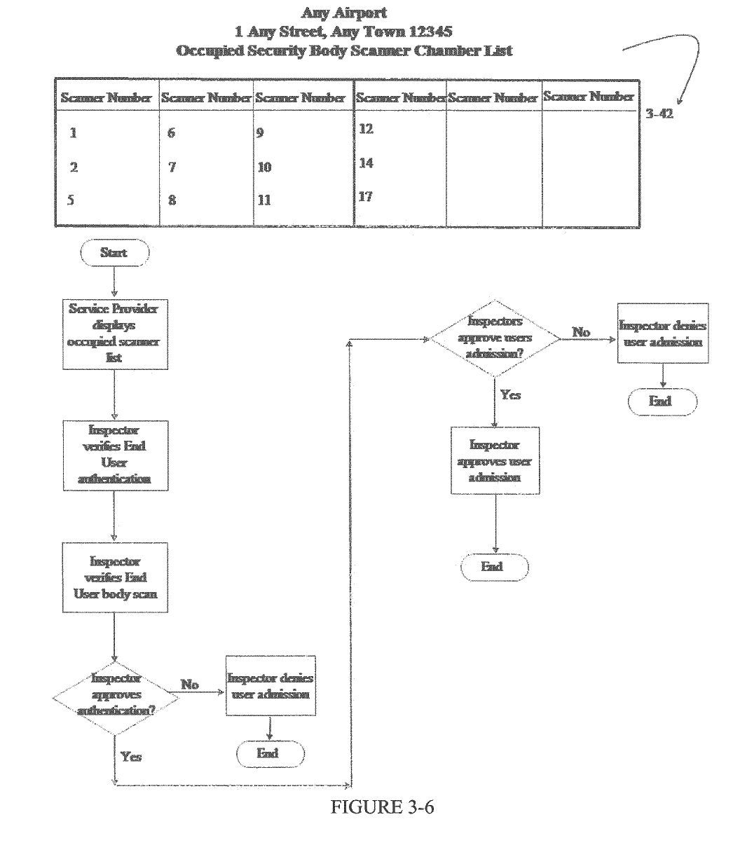

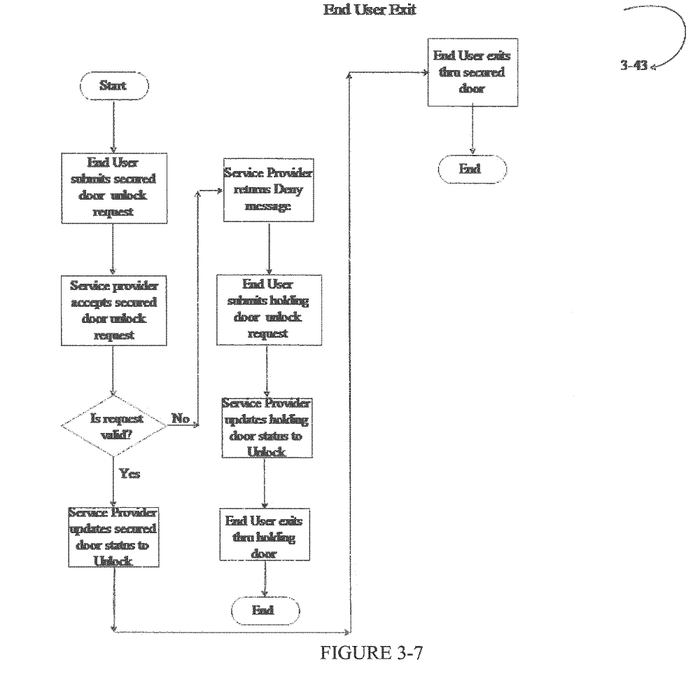

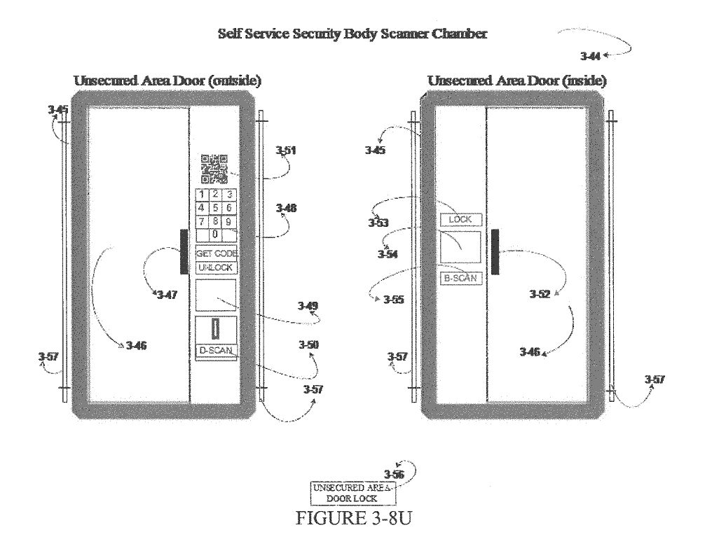

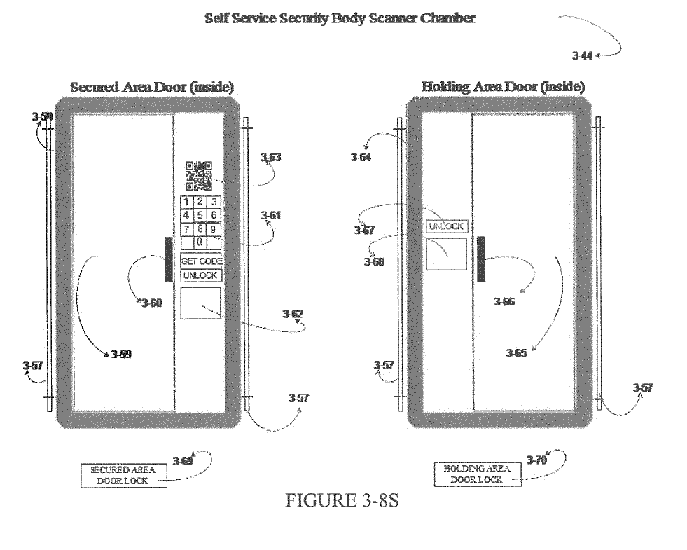

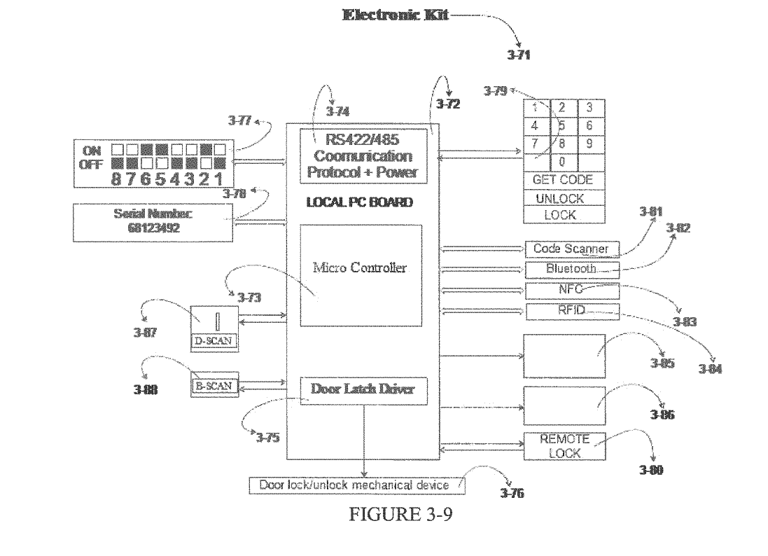

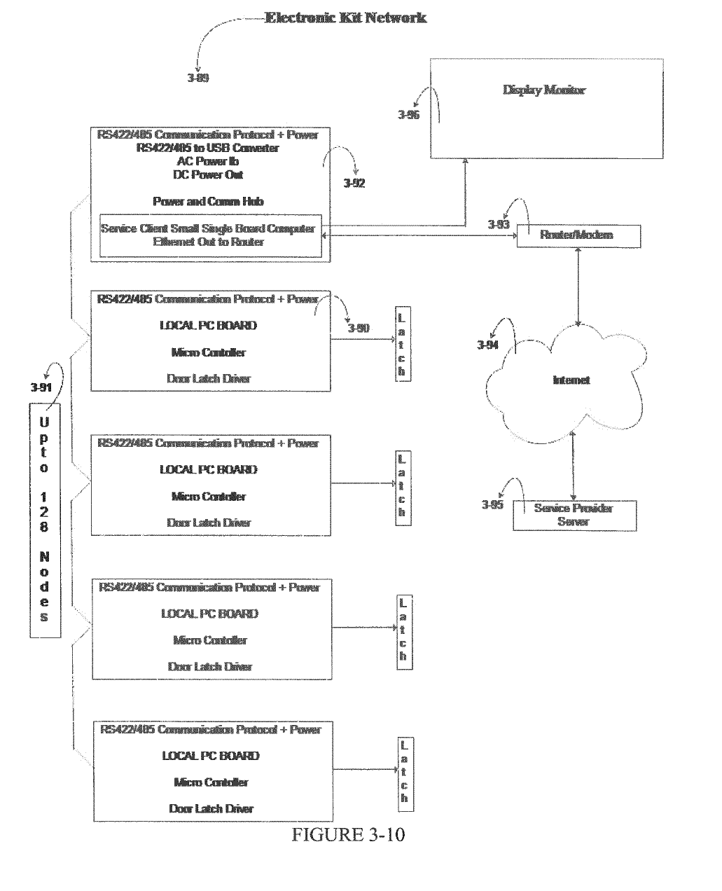

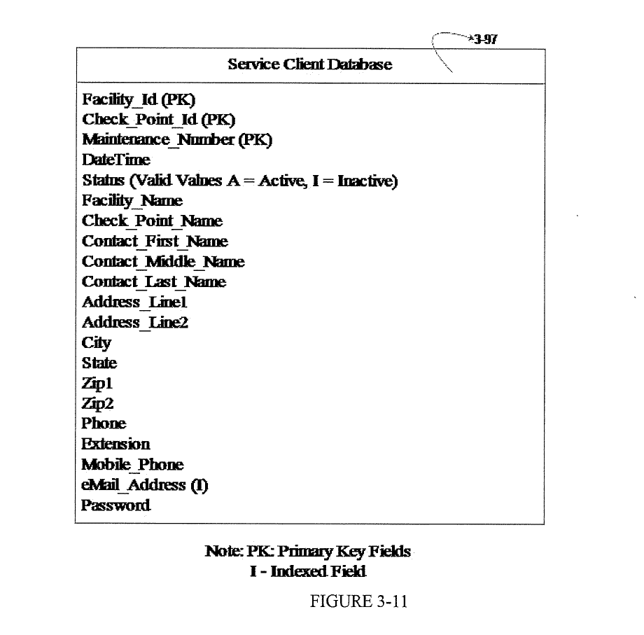

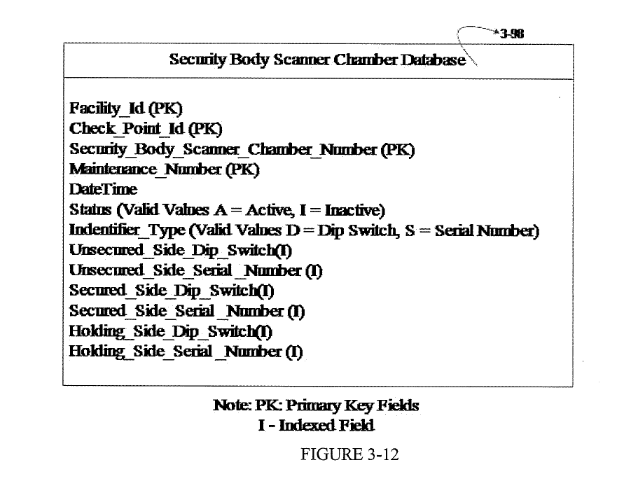

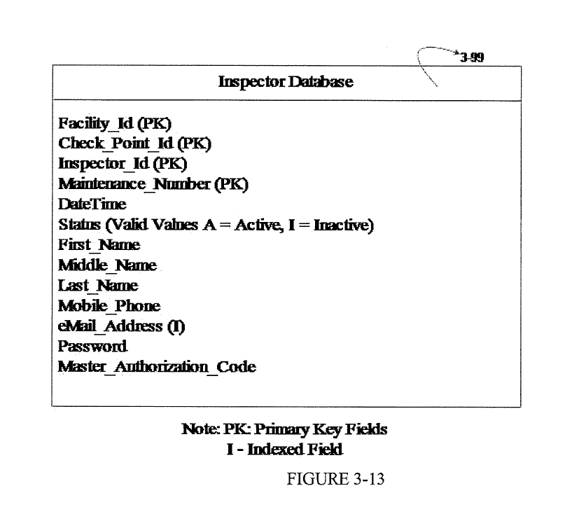

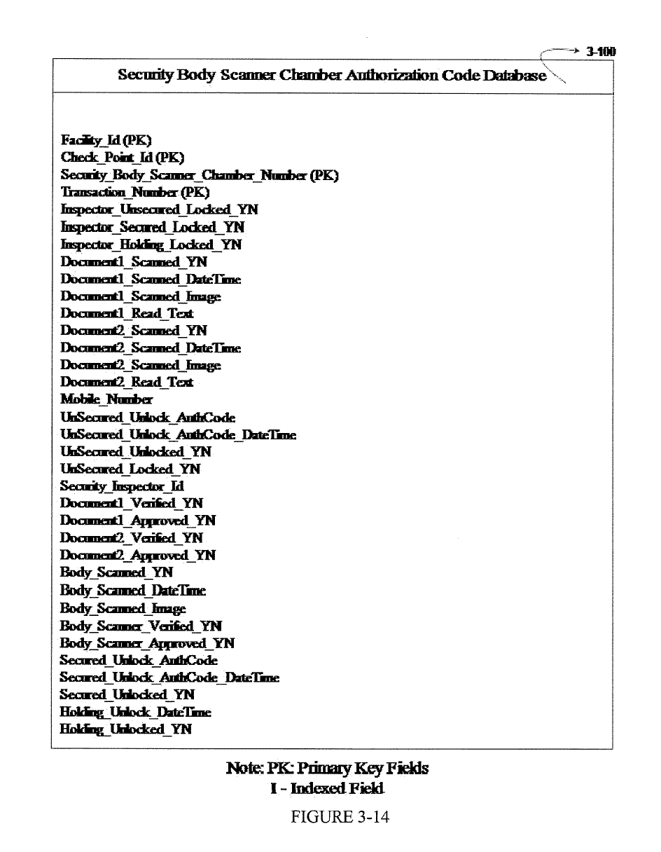

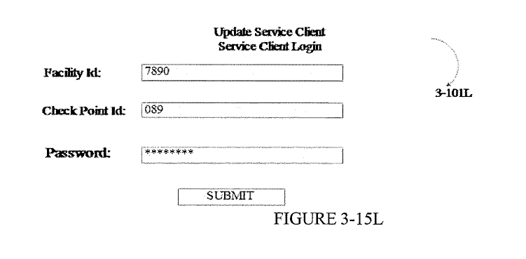

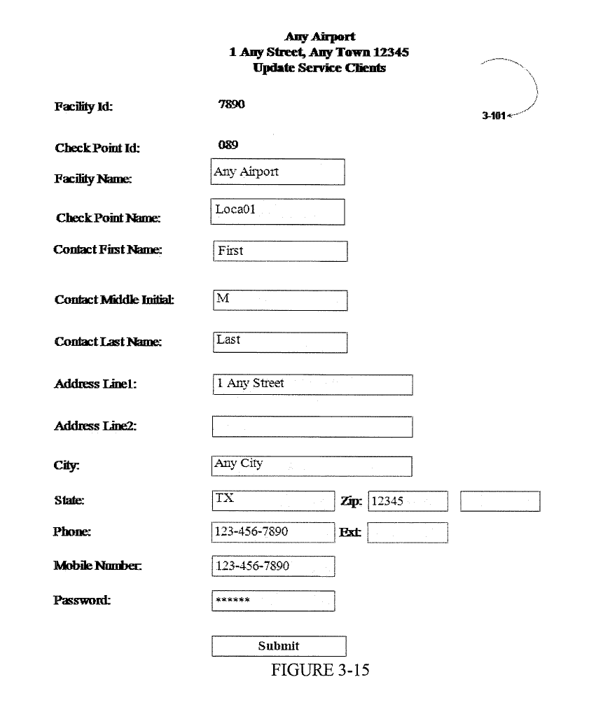

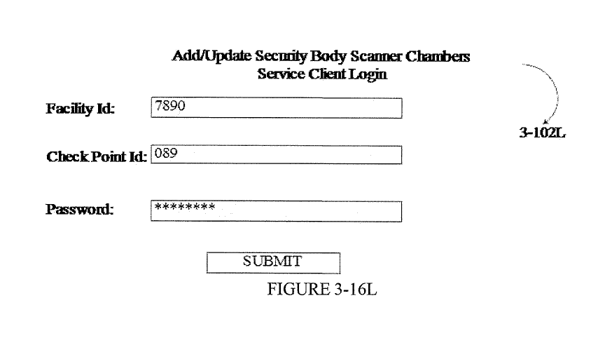

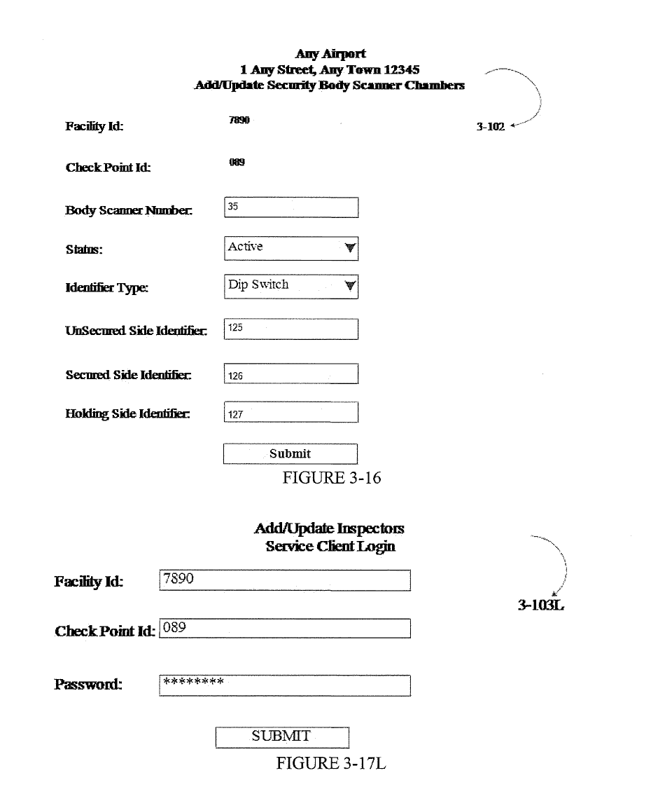

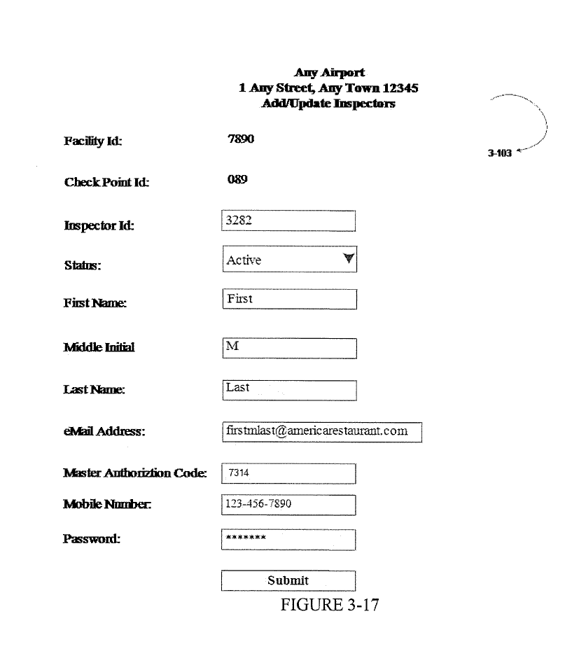

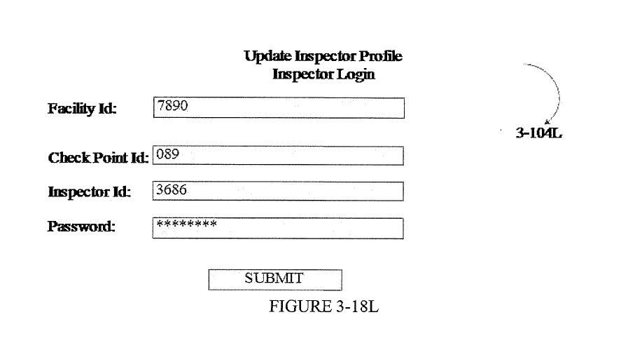

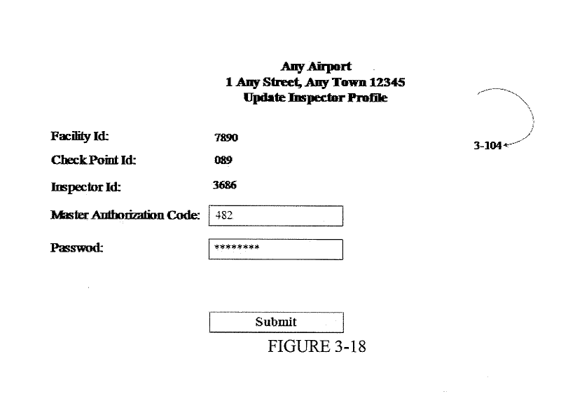

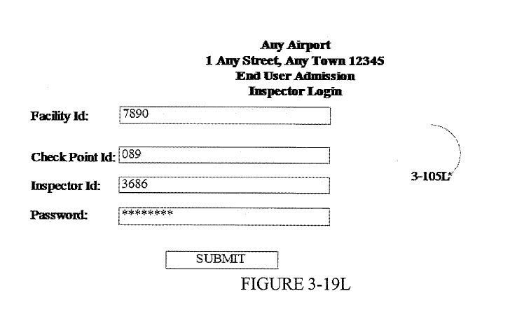

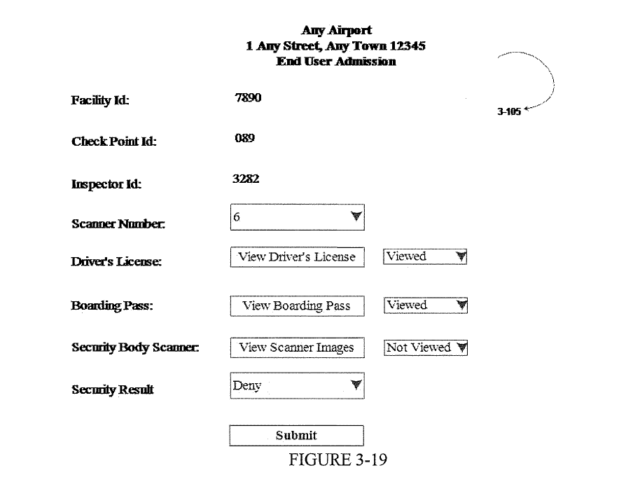

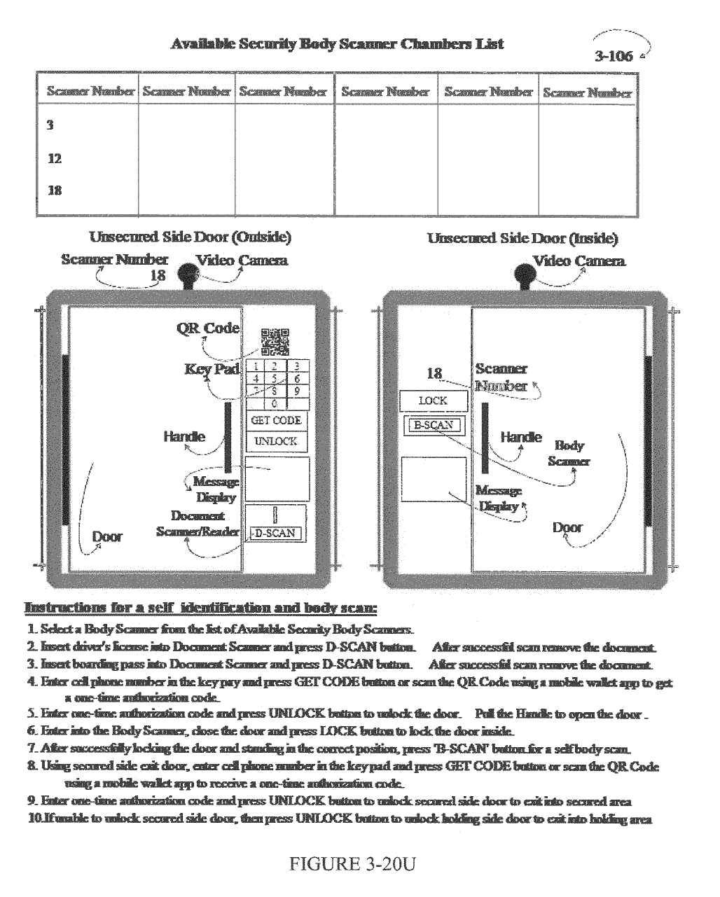

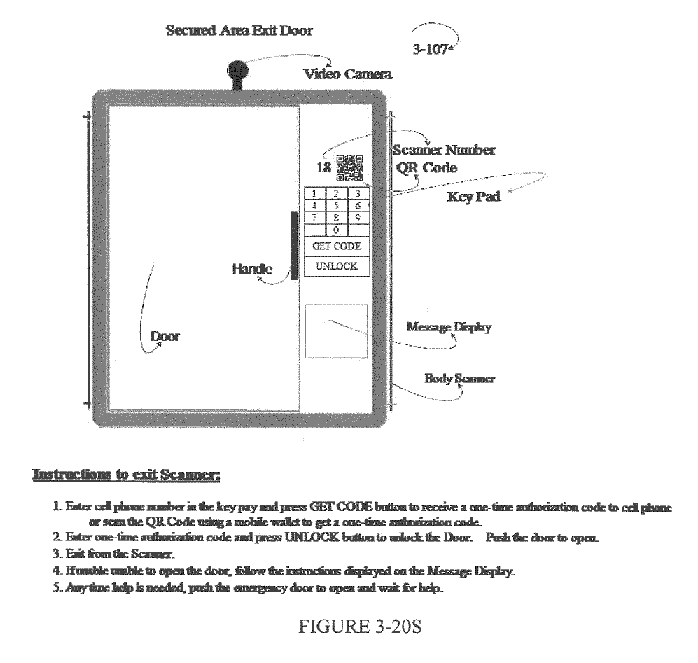

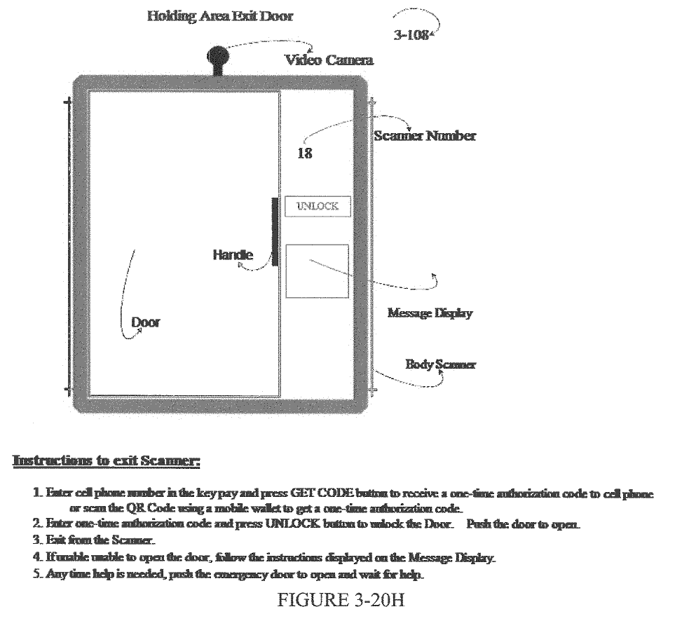

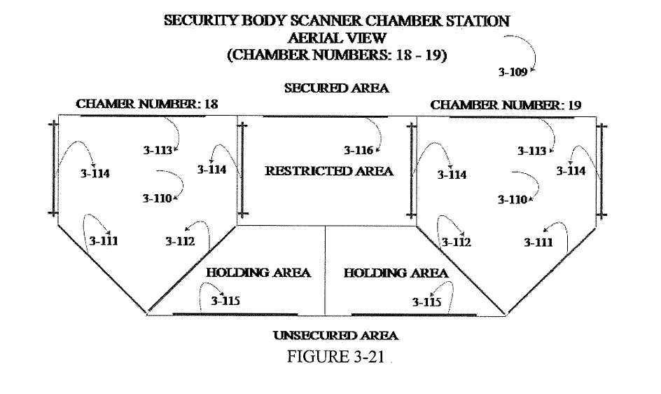

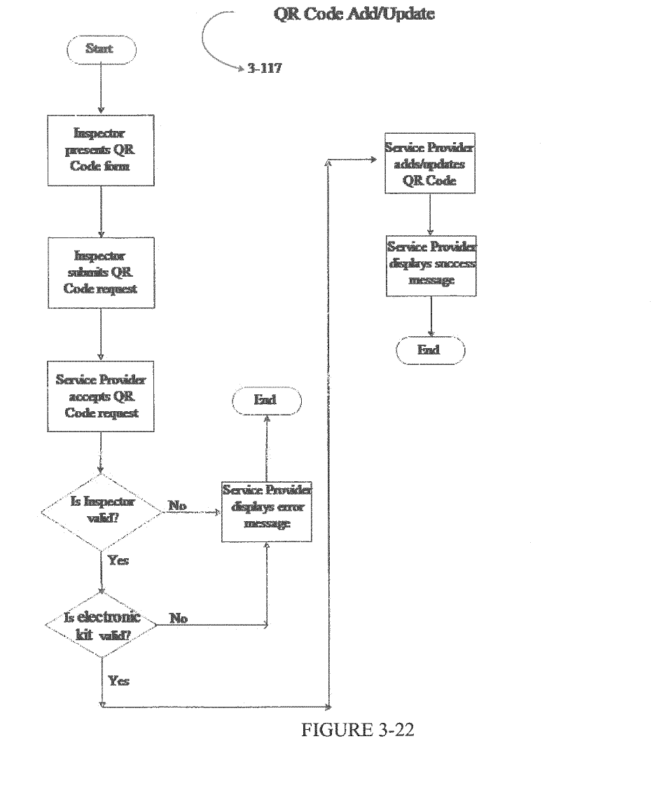

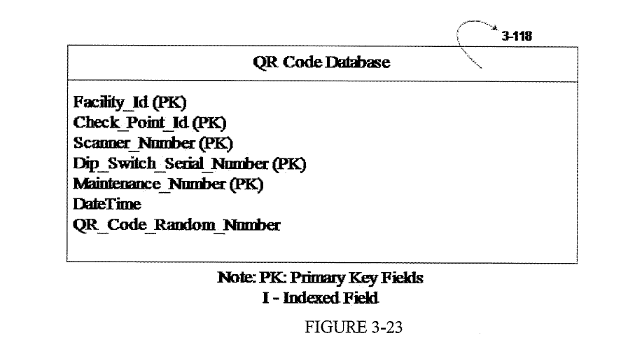

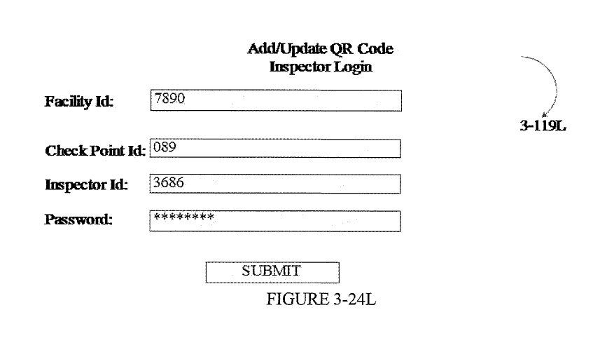

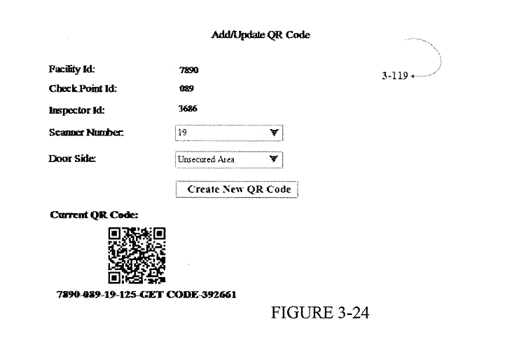

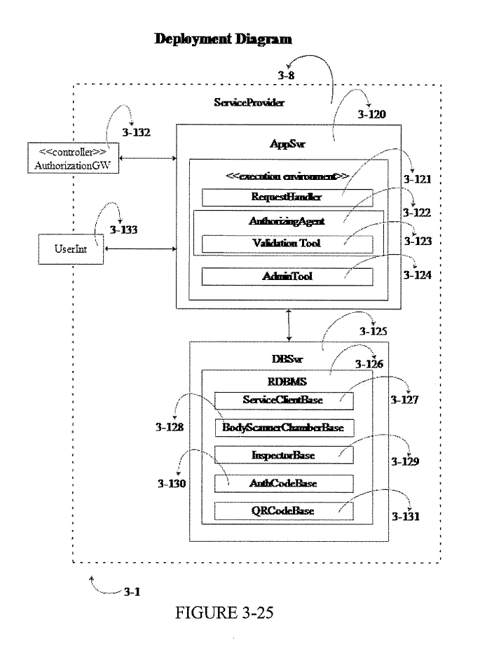

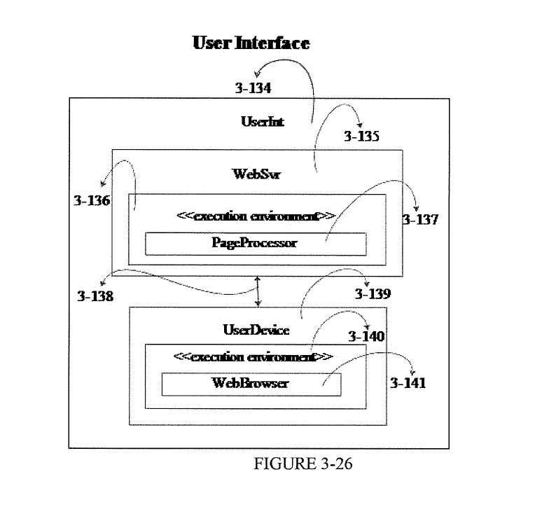

The service provider 2-8 generally provides a means 2-16 for service clients 2-9 to access a form to add/update inspector information. The service client 2-9 generally uses the means 2-17 to submit the request to add/update inspector information. The service provider 2-8 generally uses the means 2-18 to approve or deny the service client's request. The use case 2-3 for adding/updating inspectors 2-39 is further detailed in a flow chart in FIG. 2-3.

The service provider 2-8 generally provides a means 2-19 for inspectors 2-10 to access a form to update inspector profile information. The inspector 2-10 generally uses the means 2-20 to submit the request to update inspector profile information. The service provider 2-8 generally uses the means 2-21 to approve or deny the inspector's request. The use case 2-4 for updating inspector profile 2-40 is further detailed in a flow chart in FIG. 2-4.

The service provider 2-8 generally provides a means 2-22 for end users 2-12 to load goods into a scanning chamber from an unsecured area. The end users 2-12 generally use the means 2-23 to submit the request to unlock and lock a remotely controlled electronic door of a self-service security goods scanner chamber from unsecured area. The service provider 2-8 generally uses the means 2-24 to approve or deny. The use case 2-5 for end users 2-12 to load goods 2-41 is further detailed in a flow chart in FIG. 2-5.

The service provider 2-8 generally provides a means 2-25 for inspectors 2-10 to select a scanning chamber, loaded with end user's goods, to conduct a security check. The inspectors 2-10 generally use the means 2-26 to perform the security check. The inspectors 2-10 generally use the means 2-27 to approve or deny the end users' request to pass goods from unsecured area to secured area. If security check is completed, then service provider 2-8 generally uses the means 2-28 to send security check completed notification, if required. If security check is completed, then service provider 2-8 generally uses the means 2-29 to update security check completed information and if the security check is approved, the service provider 2-8 would update unload ready information. The use case 2-6 for inspectors 10 to authenticate end users 2-12 using documents and video images to securely check the goods 2-42 is further detailed in a flow chart in FIG. 2-6.

The service provider 2-8 generally provides a means 2-30 for the end users 2-12 to retrieve the same goods from the same scanning chamber 2-11 from a secured area. The end user 2-12 generally uses the means 2-31 to submit a request to unlock the scanning chamber 2-11. The service provider 2-8 generally uses the means 2-32 to approve or deny the request and if the request is approved then the scanning chamber 2-11 uses the means 2-35 to unlock the controlled door of the scanning chamber 2-11 in the secured area. If the scanning chamber 2-11 successfully unlocks the controlled door in the secured area, then the service provider 2-8 generally uses means 2-33 for the inspectors 2-10 to verify the scanning chamber 2-11 is empty. Once verified, the doors of the scanning chamber 2-11 are locked. The service provider uses the means 2-34 to indicate the scanning chamber 2-11 available for use. The use case 2-7 for end users 2-12 to retrieve goods 2-43 is further detailed in a flow chart in FIG. 2-7.

Time 2-36, as an actor, generally uses the means 2-37 to revoke the security check approval 2-27 if the goods are not retrieved by the end user 2-12 within a predetermined time.

FIG. 2-8 shows a preferred embodiment of a scanning chamber 2-44 (corresponds with 2-11 in FIG. 2-1) having a first side and a second side. The first side faces the unsecured security area and is generally referred to as the “unsecured” side whereas the second side faces the secured area and is generally referred to as the “secured” side. The unsecured side of the scanning chamber 2-44 comprises a first door 2-46, having a handle 2-47, which is attached to the door frame 2-45. A first key entry pad 2-48, a first screen 2-49, a document scanner reader 2-50, and an X-SCAN button 2-61 are positioned on or within the door frame 2-45 adjacent to the door 2-46. The secured side of the scanning chamber 2-44 comprises a second door 2-53, having a handle 2-54, which is attached to the door frame 2-52. A second key entry pad 2-55 and a second screen 2-56 are positioned on or within the door frame 2-52 adjacent to the door 2-53. An ‘UNSECURED LOCK’ button 2-58 and ‘SECURED LOCK’ button 2-59 are in communication with the scanning chamber 2-44 and accessible to inspectors 2-10. A security x-ray scanner 2-60 is attached to the scanning chamber 2-44. The X-SCAN button 2-61 is in communication with the security x-ray scanner 2-60.

Each door 2-46, 2-53 is capable of being locked by a door locking mechanism 2-67 (referenced in FIG. 2-9). The door locking mechanism 2-67 may be an electromagnet that holds the door in a locked position when the said electromagnet is magnetized. The door locking mechanism 2-67 may also be an electromagnet that moves a latch to hold the door in a locked position when the electromagnet is magnetized. The door locking mechanism 2-67 may also be a motor that physically moves the door to an open/closed position such as moving the door up/down or right/left. Any suitable mechanisms for locking or unlocking the door may be utilized so long as the control may be accomplished electronically and remotely.

As shown in FIGS. 2-22U and 2-22S, a security scanning station 2-98 may be comprised of a plurality of scanning chambers each having a unique external identifier 2-101 visible on the unsecured side and 2-111 visible on the secured side.

FIG. 2-9 shows the electronic kit 2-62 used by the service provider to lock/unlock the remotely controlled electronic doors 2-46, 2-53. The electronic kit 2-62 is comprised of various components to unlock/lock remotely controlled electronic doors including a local PC board 2-63, door locking mechanism 2-67, a bank of dip switches 2-68 and/or a serial number reader 2-69, external key pad 2-70, scanner reader 2-72, bluetooth reader 2-73, near field communication (NFC) reader 2-74, radio frequency identification (RFID) reader 2-75, external mini screen 2-76, external lock button 2-71, document scanner reader 2-77, and security x-ray scanner 2-60. The door locking mechanism 2-67 must be physically within the scanning chamber 2-44 to physically lock and unlock the doors. The other components of the electronic kit 2-62 may be located within the scanning chamber 2-44 or in communication therewith. The electronic kit 2-62 is configurable to connect to any number of scanning chambers 2-44 to control the door(s) connected to the scanning chamber 2-44.

The local PC board 2-63 comprises a microcontroller 2-64, communication protocol plus power component 2-65, and a door latch driver 2-66. The power part of the communication protocol plus power component 2-65 supplies DC, either from a battery source or from conversion of AC power, to power the local PC board 2-63. The microcontroller 2-64 communicates, via the communication protocol of the said communication protocol plus power component 2-65, with a small single board computer, a general purpose computer (“personal computer”) 2-82 (as shown in FIG. 2-10), or directly with service provider server 2-85 through the internet. An example of a communication protocol plus power component capable of use with this embodiment is RS422/485 but other interface cards may be used. The door latch driver 2-66, based on instructions from the microcontroller 2-64 controls the door locking mechanism 2-67 that ultimately controls the locked/unlocked status of each door. The local PC board 2-63 is in communication with a bank of dip switches 2-68 and/or a serial number reader 2-69. The microcontroller 2-64 communicates information from the bank of dip switches 2-68 and/or a serial number reader 2-69 when communicating with the personal computer 2-82 or service provider server 2-85 in order to identify the specific local PC board 2-63.

The microcontroller 2-64 may be in communication with at least one external key pad 2-70. The external key pad 2-70 consists of a numeric pad with buttons 0-9, a ‘GET CODE’ button, a ‘UNLOCK’ button and a ‘LOCK’ button. The external key pad 2-70 may be physically attached to the scanning chamber 2-44 such as key entry pads 2-48, 2-55 as shown in FIG. 2-8 but physical attachment is not a requirement. The external key pad 2-70 receives inputs from service clients, inspectors, and end users and communicates such inputs to the microcontroller 2-64.

The microcontroller 2-64 may be in communication with a scanner reader 2-72 that is capable of scanning and reading a QR code, bar code, or any machine readable code; bluetooth reader 2-73; near field communication (NFC) reader 2-74; and/or a radio frequency identification (RFID) reader 2-75. The scanner reader 2-72, bluetooth reader 2-73, near field communication (NFC) reader 2-74, and/or radio frequency identification (RFID) reader 2-75 may be physically attached to the scanning chamber 2-11 but physical attachment is not a requirement. The scanner reader 2-72, bluetooth reader 2-73, near field communication (NFC) reader 2-74, and/or radio frequency identification (RFID) reader 2-75 receive an input from service clients, inspectors, and end users, and communicates such inputs to the microcontroller 2-64. The scanner reader 2-72, bluetooth reader 2-73, near field communication (NFC) reader 2-74, and/or radio frequency identification (RFID) reader 2-75 may be used in lieu of or in conjunction with external key pad 2-70.

The microcontroller 2-64 may be in communication with an external button 2-71 located on the scanning chamber 2-44. The external button 2-71 may be accessible to the inspectors and service clients. The external button 2-71 may be a lock button such as an ‘UNSECURED LOCK’ button 2-58 and ‘SECURED LOCK’ button 2-59 disclosed in FIG. 2-8.

The microcontroller 2-64 may be in communication with an external screen 2-76 that is capable of displaying messages. The external screen 2-76 may be physically attached to the scanning chamber 2-44 such as the screens 2-49, 2-56 as shown in FIG. 2-8 but physical attachment is not a requirement. The external screen 2-76 may also be a touch screen and function as a display for messages as well as the external key pad 2-70 or as the external button 2-71.

The microcontroller 2-64 may be in communication with a document scanner reader 2-77 that is capable of scanning and saving documents such as a driver's license, badge, boarding pass, etc. The document scanner reader 2-77 may be physically attached to the scanning chamber 2-11 but physical attachment is not a requirement. The document scanner reader 2-77 may receive an input from service clients, inspectors, and end users, and communicates such inputs to the microcontroller 2-64. The document scanner reader 2-77 may be a document scanner 2-50 as disclosed in FIG. 2-8.

The microcontroller 2-64 may be in communication with a security x-ray scanner 2-60 and a switch 2-78 related to such operation. The switch 2-78 may receive an input from inspectors or end users, and communicates such inputs to the microcontroller 2-64 which in turn may operate the security x-ray scanner 2-60 disclosed in FIG. 2-8. The switch 2-78 may be an X-SCAN button 2-61 as disclosed in FIG. 2-8.

As shown in FIG. 2-10, the electronic kits 2-80, as shown in FIG. 2-9 as 2-62, may be arranged in a network 2-79. The electronic kits 2-80, through a network 2-81, are in communication with a personal computer 2-82. The personal computer 2-82 may be in communication with a router/modem 2-83 which is in communication to the internet or an intranet 2-84 which is in communication with the service provider server 2-85. The personal computer 2-82 may also be connected to an external display monitor 2-86.

FIG. 2-26 shows the various elements of an exemplary hardware and software based implementation of the self-serve security scanning station for goods 2-1. The implementation depicted in FIG. 2-26 is exemplary and not intended to be limiting as a variety of implementations are possible. While some elements in FIG. 2-26 are shown to comprise hardware and others software, virtually any element could be implemented in either hardware, software, or a combination thereof. Still further, it is noted that while for clarity of discussion various hardware elements are segregated between different machines and various software elements are segregated into various components, no such segregation should be deemed as required unless specifically stated herein and further or differing division into various particular components, modules, classes, objects or the like should be taken as within the scope of the present embodiment as limited only by the claims appended hereto. To the extent that any structural element (including software) is stated as being adapted to perform some function, such language is to be taken as a positive structural limitation imposed upon the referenced element whereby the element is required to be actually adapted, programed, configured or otherwise provided with the actual capability for performing the specified function. In no case shall such language be taken as merely a statement of intended use or the like, but to the contrary such language shall be in every case taken to read on all structures of the referenced element that are in any manner actually in the present tense configured to perform the specified function (as opposed to being merely capable of adaption for the conduct of the specified function). The deployment diagram of FIG. 2-26 may be locally hosted on a personal computer 2-82 as shown in FIG. 2-10 or may be remotely located and connected via an internet or intranet.

Turning then to FIG. 2-26, a service provider 2-8 is associated with one or more application servers 2-121 or database servers 2-126 upon which may be hosted software functionality necessary to operate within the framework of the embodiment. An application server 2-121 may accept inputs and deliver outputs through an authorization gateway 2-133 and user interface 2-134. The authorization inputs and outputs may be in any of a plurality of message formats such as, and not limited to, a comma or special character delimited message, an XML formatted message, a JASON formatted message, over any of a plurality of languages such as and not limited to, HTML (HTTP or HTTPS or SOAP), JavaScript, C programs, C++ programs, .NET and based on the Application Programming Interfaces (API) specification provided by the service provider 2-8. Preferably, the authorization gateway 2-133 is a unified authorization gateway. An application server 2-121 may host a request handler software component 2-122 adapted to handle authorization requests communicated through authorization gateway 2-133 and all other inputs through user interface 2-134 as well as to produce responses for authorization requests and for other inputs as may be necessary in the operation of the embodiment. Additionally, the application server 2-121 may host an authorizing agent 2-123 adapted to handle or otherwise control all aspects of the authorization process of the service provider 2-8, including receiving authorization requests, storing and/or retrieving data pertinent to the processing of such requests, and directing the validation of authorization codes submitted for authorization and respond based upon the results of such validations. In order to improve efficiency, the authorizing agent 2-123 may comprise one or more further specialized components such as, for example, a validation tool 2-124 adapted to conduct the specialized task of comparing received authorization code with known end user authorization code or end user wallet authentication code or inspector master scanner chamber authorization code. Still further, the application server 2-121 may also host an administration tool 2-125 through which various aspects of the setup, maintenance and operation of the hardware and software systems of the service provider 2-8 may be managed.

In order to efficiently manage and handle the large quantity of data that may typically be stored in connection with an implementation of the present embodiment, one or more dedicated database servers 2-126 hosting database management systems 2-127 are generally desired. As shown in FIG. 2-26, a typical database management system 2-127 may include a service client database 2-128 for storing a wide variety of generally service client centric data, a scanner chamber database 2-129 for storing a wide variety of generally scanner chamber centric data, an inspector database 2-130 for storing a wide variety of generally inspector centric data, an authorization code database 2-131 for storing a wide variety of generally authorization code centric data, and a QR code database 2-132 for storing a wide variety of generally QR code centric data. Although those of ordinary skill in the art will recognize that virtually unlimited alternatives are possible, FIG. 2-11 shows a high level generally representative schema 2-87 for a service client database 2-128, FIG. 2-12 shows a high level generally representative schema 2-88 for a scanner chamber database 2-129, FIG. 2-13 shows a high level generally representative schema 2-89 for an inspector database 2-130, FIG. 2-14 shows a high level generally representative schema 2-90 for an authorization code database 2-131, and FIG. 2-24 shows a high level generally representative schema 2-119 for QR code database 2-132, each of which will be described in greater detail further herein in connection with an exemplary description of the conduct of a typical transaction.

An exemplary user interface 2-134 may be implemented as a web interface 2-135 as shown in FIG. 2-27, comprising a page processor 2-138 hosted on an appropriate execution environment 2-137, installed on a dedicated web server 2-136, in communication 2-139 with a user device 2-140. The user device 2-140, such as a personal computer, smart phone, or tablet, has a hosted a web browser 2-142 running in a provided execution environment 2-141. As will be appreciated by those of ordinary skill in the art, the provision of a secured user interface 2-134 enables the various users, service clients 2-9, and inspectors 2-10, to maintain and/or otherwise manage the data stored in the service client database 2-128, scanner chamber database 2-129, inspector database 2-130, authorization code database 2-131, QR code database 2-132 as may be appropriate as well as to generally manage and maintain the implemented self-serve security scanning station for goods 2-1.

Several initial step setups must occur prior to use of the present embodiment. Each service client 2-9 should be registered with the service provider 2-8 to receive a unique facility ID and check point ID. The service provider may assign unlimited number of unique facility ids and unlimited number of unique check point ids within each facility ID so that service clients 2-9 can have unlimited number of check-points within a facility. Each service client 2-9 may populate the service client database 2-128, scanner chamber database 2-129, inspector database 2-130 using a web site or a standalone computer.

In reference to FIGS. 2-11, 2-15, 2-15L, and 2-26, each service client 2-9 may populate the service client database 2-128 using form 2-91. The service client 2-9 may use a password provided by the service provider 2-8 and maintained by the service client 2-9 to access its information in service client database 2-128. The service client 2-9 may enter facility ID, check point ID, and password into a log in form 2-91L as shown in FIG. 2-15L. If the submitted credentials are valid, then the service client 2-9 may access form 2-91, if not valid then the login process is terminated. The service client 2-9 may access this information using a user interface 2-135 in FIG. 2-27 as described supra. Using form 2-91 the service client 2-9 may enter information into appropriate fields and click on submit button or review previously inputted information. The service provider 2-8 may validate the submitted information and if the submitted information is valid then the service provider 2-8 would update the service client database 2-128, otherwise the service provider 2-8 may terminate the validation process, display an error message and wait to receive the data again. The validation process includes validation of values of each individual field namely facility name, security check-point name, contact first name, contact middle initial, contact last name, address line 1, city, state, zip, phone, extension, mobile number and password. If facility name or security check-point name or contact first name or contact last name or address line1 or city or state or zip code or phone number is blank then, the said validation process will terminate otherwise, the validation process will continue. If the state is not a valid state then, the validation process will terminate otherwise, the validation process will continue. If the city is not a valid city then, the validation process will terminate otherwise, the validation process will continue. If the zip code is not a valid zip code then, the validation process will terminate otherwise, the validation process will continue. If the phone number is not a valid phone number then, the validation process will terminate otherwise, the validation process will continue. If the extension is entered and is not valid then the validation process will terminate otherwise, the validation process will continue. If the mobile number is entered and is not valid then the validation process will terminate otherwise, the validation process will continue. If the password is entered and is not valid then the validation process will terminate otherwise, the validation process will continue. If the validation process terminates anytime during the validation process an error message will be displayed in the form 2-15 and the service provider 2-8 will wait to receive the data again. If the validation process does not terminate and the entered values of all the fields as shown in FIG. 2-15 are valid, then the service provider would update the service client database 2-128 as per the schema 2-87 shown in FIG. 2-11. If the password is blank, then the last previously set password will be taken forward.

As shown in FIG. 2-2, the service provider 2-8 may use the flow chart 2-38 as per the use case 2-2 of the present embodiment for the service client 2-9 to add/update scanning chambers. In reference to FIGS. 2-12, 2-16, 2-16L, and 2-24, each service client 2-9 may populate the scanner chamber database 2-129 using form 2-92. The service client 2-9 may use a password provided by the service provider 2-8 and maintained by the service client 2-9 to access the information in scanner chamber database 2-129. The service client 2-9 may enter facility ID, security check-point ID and password into a log in form 2-92L as shown in FIG. 2-16L. If the submitted credentials are valid then the service provider 2-8 would generally continue, populate the fields either with the values from the scanner chamber database 2-129 or populate the fields with blanks and present the form 2-92, otherwise it will terminate the process. To populate the fields in the form 2-92, the service provider 2-8 would accept a scanner chamber number from the service client 2-9 and get the most recent values for the said scanner chamber number from the scanner chamber database 2-129. If the said scanner chamber number does not exist in the said scanner chamber database 2-129 then the service provider 2-8 would populate the fields in the form with blanks.

On form 2-92, the service client 2-9 may enter the required information into appropriate fields and click on submit button. The service provider 2-8 would validate the submitted information and if the submitted information is valid then the service provider 2-8 would update the self-service security goods scanner chamber database 2-129, otherwise the service provider 2-8 would terminate the validation process, display an error message and wait to receive the data again. The said validation process includes validation of values of each individual field namely scanner chamber number, status, identifier type, unsecured side identifier and secured side identifier. The scanner chamber number is the self-service security goods scanner chamber unique external identifier provided by service client 2-9. The unsecured side identifier is the unique internal identifier of the remotely controlled electronic door attached to the unsecured side of the self-service security goods scanner chamber. The secured side identifier is the unique internal identifier of the remotely controlled electronic door attached to the secured side of the self-service security goods scanner chamber. The said unique internal identifier of any remotely controlled electronic door is the value of the dip switch settings or serial number of the microcontroller board controlling the said remotely controlled electronic door, depending on the identifier type. If the scanner chamber number is not blank and is an integer (number without decimals) then, the said validation process will continue otherwise, the validation process will terminate. If the status is Active or Inactive then, the said validation process will continue otherwise, the validation process will terminate. If the identifier type is Dip Switch or Serial Number then, the said validation process will continue otherwise, the validation process will terminate. If the unsecured side identifier is blank or an integer then, the said validation process will continue otherwise, the validation process will terminate. If the secured side identifier is blank or an integer then, the said validation process will continue otherwise, the validation process will terminate. If the status is Active then, if the unsecured side identifier is an integer and secured side identifier is an integer then, the said validation process will continue otherwise, the validation process will terminate.

If the same internal dip switch identifier is used by any other remotely controlled electronic door attached to any scanning chamber identified by facility ID and security check-point ID then, the validation process will terminate, otherwise it will continue. If the internal identifier type is serial number and if the same internal identifier is used by any other remotely controlled electronic door attached to any self-service security goods scanner chamber within any security check-point identified by any facility ID and by any security check-point ID then, the validation process will terminate, otherwise it will continue. If the validation process terminates anytime during the validation process an error message will be displayed in the form 2-92 and the service provider 2-8 will wait to receive the data again. If the validation process does not terminate and the entered values of all the fields as shown in FIG. 2-16 are valid, then the service provider 2-8 would insert a row in the scanner chamber database 2-129 as per the schema 2-88 shown in FIG. 2-12. If scanner chamber (self-service security goods scanner chamber) number does not exist in the scanner chamber database 2-129 then, the value for maintenance number would be set to 1, otherwise the value for the said maintenance number would be set to the last previously set value plus 1.

As shown in FIG. 2-3, the service provider 2-8 may use the flow chart 2-39 as per the use case 2-3 of the present embodiment for the service client 2-9 to add/update inspectors 2-10. In reference to FIGS. 2-13, 2-17, 2-17L, and 2-26, each service client 2-9 may populate the inspector database 2-130 using form 2-93. The service client 2-9 may use a password provided by the service provider 2-8 and maintained by the service client 2-9 to access the information in inspector database 2-130. The service client 2-9 may enter facility ID, check point ID, and password into a log in form 2-93L as shown in FIG. 2-17L. If the submitted credentials are valid, then the service client 2-9 may access form 2-93, if not valid then the login process is terminated. The service client 2-9 may access this information using a user interface 2-135 in FIG. 2-27 as described supra. To populate the fields in form 2-93, the service provider 2-8 may accept an inspector number from the service client 2-9 and obtain the most recent data for the inspector number from the inspector database 2-130. If the inspector number does not exist, then the service provider 2-8 would populate the fields in the form 2-93 with blanks.

On form 2-93, the service client 2-9 may enter information into appropriate fields and click on submit button. The service provider 2-8 may validate the submitted information and if the submitted information is valid then the service provider 2-8 would update the inspector database 2-130, otherwise the service provider 2-8 may terminate the validation process, display an error message and wait to receive the data again. The said validation process includes validation of values of each individual field namely inspector ID, status, first name, middle name, last name, email address, master authorization code, mobile number and password. The inspector ID is a unique number provided by service client 2-9 to each individual inspector. If the inspector ID is not blank and is an integer then, the said validation process will continue otherwise, the validation process will terminate. If the status is Active or Inactive then, the said validation process will continue otherwise, the validation process will terminate. If the contact first name or contact last name or email address or master authorization code is blank, then the validation process will terminate otherwise it will continue. If email address is a valid email address, then the process will continue otherwise it will terminate. If mobile number is blank or valid mobile number then the process will continue, otherwise it will terminate. If mobile number is not blank and the same mobile number is used for more than one inspector within a security check-point identified by facility ID and security check-point ID then the process will terminate, otherwise it will continue. If the validation process terminates anytime during the validation process an error message will be displayed in the form 2-17 and the service provider 2-8 will wait to receive the data again. If the validation process does not terminate and the entered values of all the fields as shown in FIG. 2-17 are valid, then the service provider 2-8 would update the inspector database 2-130 as per the schema 2-89 as shown in FIG. 2-13. If inspector ID does not exist in the inspector database 2-130 then, the inspector information will be added in the database 2-130 otherwise, the inspector information will be updated in the database 2-130. If the password is blank, then the last previously set password will be taken forward.

As shown in FIG. 2-4, the service provider 2-8 may use the flow chart 2-40 as per the use case 2-4 of the present embodiment for the inspectors 2-10 to update inspector's profile. In reference to FIGS. 2-18 and 2-18L each inspector 2-10 may update its profile using form 2-94. The inspector 2-10 may use a password provided by the service client 2-9. The inspector 2-10 may enter facility ID, check point ID, inspector ID, and password into a log in form 2-94L as shown in FIG. 2-18L. If the submitted credentials are valid, then the inspector 2-10 may access form 2-94, if not valid then the login process is terminated. The inspector 2-10 may access this information using a user interface 2-135 in FIG. 2-27 as described supra.

On form 2-94, the inspector 2-10 may enter information into appropriate fields and click on submit button. The service provider 2-8 may validate the submitted information and if the submitted information is valid then the service provider 2-8 would update the inspector database 2-130, otherwise the service provider 2-8 may terminate the validation process, display an error message and wait to receive the data again. The validation process includes validation of values of each individual field namely master authorization code and password. The inspector ID is a unique number provided by service client 2-9 to each individual inspector. If the master authorization code is not blank and an integer and the same master authorization code is not currently being used by any other inspector within the said facility ID and security check-point ID, then the validation process will continue, otherwise it will terminate. If the validation process terminates anytime during the validation process an error message will be displayed in the form 2-94 and the service provider 2-8 will wait to receive the data again. If the validation process does not terminate and the entered values of all the fields as shown in FIG. 2-18 are valid, then the service provider 2-8 would update the inspector database 2-130 as per the schema 2-89 as shown in FIG. 2-13. If the password is blank, then the last previously set password will be taken forward.

As shown in FIG. 2-23, the service provider 2-8 may use the flow chart 2-118 as per the use case 2-5 of the present embodiment to add/update QR Codes. In reference to FIGS. 2-25 and 2-25L each inspector 2-10 may request a QR code using form 2-120. The inspector 2-10 may use a password provided by the service client 2-9. The inspector 2-10 may enter facility ID, check point ID, inspector ID, and password into a log in form 2-120L as shown in FIG. 2-25L. If the submitted credentials are valid, then the inspector 2-10 may access form 2-120, if not valid then the login process is terminated. The inspector 2-10 may access this information using a user interface 2-135 in FIG. 2-27 as described supra.

Once the form 2-120 as shown in FIG. 2-25 is presented, the inspector 2-10 may enter the required information into appropriate fields and click on ‘Create QR Code’ button. The service provider 2-8 would validate the submitted information and if the submitted information is valid then the service provider 2-8 would update the QR Code database 2-132 with a new random number, otherwise the service provider 2-8 would terminate the validation process, display an error message and wait to receive the data again. The said validation process includes validation of values of each individual field namely scanner chamber number, and side of the door. The scanner chamber number is a unique external identifier number assigned by service client 2-9 to each self-service security goods scanner chamber and the side of the door is the side to which the door is attached to the self-service security goods scanner chamber. If the scanner chamber number and the side of the door are valid, then the validation process will continue, otherwise the validation process will terminate. If the validation process terminates anytime during the validation process an error message will be displayed in the form 2-120 and the service provider 2-8 will wait to receive the data again. If the validation process does not terminate and the entered values of all the fields as shown in FIG. 2-25 are valid, then the service provider 2-8 would create a new unique random number and update the QR Code database 2-132 as per the schema 2-119 as shown in FIG. 2-24. If no row exists in the qr code database 2-132 based on the entered values, then the value for Maintenance Number in the new row will be set to 1, otherwise the Maintenance Number will be incremented by 1 from the last inserted row. Once a new row with a new maintenance number is inserted any QR Code displayed for the said scanner chamber number and for the said side of the door will not be valid any more. The inspectors 2-10 then need to print new QR Code and post them on the selected door of the selected scanner chamber.

The service provider 2-8 uses several programmatically executable procedures loaded into the microcontroller 2-64, the personal computer 2-82 and the application server 2-121 which are executed based on end users' 2-12 and inspectors' 2-10 request.

Upon successful completion of initial set up by service provider 2-8, service client 2-9, and inspectors 2-10, the service client 2-9 may proceed using the scanning chamber in accordance with the present embodiment.

The method of a self-serve security scanning station for goods 2-1 is generally described in reference to FIGS. 2-1, 2-5, 2-6, 2-7, 2-8, 2-9, 2-19, 2-21, 2-22U and 2-22S in an exemplary embodiment for use.

Continuing then with the example generally described with respect to FIG. 2-26, further details of the implementation are now described by way of the following detailed description of a possible use of the implementation for passing goods from unsecured area to secured area through a security check-point, which, for purposes of the example, shall be taken being conducted at an airport security check-point.

End users 2-12 and inspectors 2-10 submit requests in the following order to pass goods from unsecured area to secured area through a security check-point:

(1) Inspectors 2-10 maintain available self-service security goods scanner chambers which are displayed on a display monitor as shown in FIG. 2-19. To add a self-service security goods scanner chamber, the inspectors 2-10 would verify that a self-service security goods scanner chamber is empty, press ‘UNSECURED LOCK’ button 2-58 and then press ‘SECURED LOCK’ button 2-59. Pressing ‘UNSECURED LOCK’ button 2-58 would execute the procedure ‘Unsecured Lock’. Pressing ‘SECURED LOCK’ button 2-59 would execute the procedure ‘Secured Lock’. End-Users 2-12 would follow the instructions 2-95 as shown in FIG. 2-19 to load the goods into the self-service security goods scanner chamber.

(2) End-Users 2-12 upload self-identification documents through ‘Document Scanner Reader’. This would execute the procedure ‘End-User Self Identification’. Response message received in the response would be displayed in the ‘Message Display’ screen.

(3) End-Users 2-12 get a one-time authorization code to unlock a door of a self-service security goods scanner chamber facing unsecured area by scanning ‘QR Code’ using a mobile wallet or by entering a mobile number in the ‘Key Pad’ and by pressing the ‘GET CODE’ button. This would execute the procedure ‘Get AuthCode with QR Code or Mobile Number’. If the request was submitted by scanning the ‘QR Code’ using a wallet app, then a one-time authorization code and/or a response message will be displayed in the said wallet app. If the request was submitted by entering a mobile number in the ‘Key Pad’ then a one-time authorization code will be sent to the said mobile device, and/or a response message received in the response would be displayed in the ‘Message Display’ screen.

(4) End-Users 2-12 unlock a door of self-service security goods scanner chamber facing unsecured area by entering a one-time authorization code in the ‘Key Pad’ and by pressing ‘UNLOCK’ button. This would execute the procedure ‘Unlock Door’. The ‘Door’ of the self-service security goods scanner chamber facing unsecured area would be unlocked and/or a response message received in the response would be displayed in the ‘Message Display’ screen.

(5) End-Users 2-12 get a one-time authorization code to lock a door of a self-service security goods scanner chamber facing unsecured area by scanning a ‘QR Code’ using a mobile wallet or by entering a mobile number in the ‘Key Pad’ and by pressing the ‘GET CODE’ button. This would execute the procedure ‘Get AuthCode with QR Code or Mobile Number’. If the request was submitted by scanning the ‘QR Code’ using a wallet app, then a one-time authorization code and/or a response message will be displayed in the said wallet app. If the request was submitted by entering a mobile number in the ‘Key Pad’ then a one-time authorization code will be sent to the said mobile device and/or a response message received in the response would be displayed in the ‘Message Display’ screen.

(6) End-Users 2-12 would lock a door of self-service security goods scanner chamber facing unsecured area by entering a one-time authorization code in the ‘Key Pad’ and by pressing ‘LOCK’ button. This would execute the procedure ‘Lock Door’. The ‘Door’ of the self-service security goods scanner chamber facing unsecured area would be locked and/or a response message received in the response would be displayed in the ‘Message Display’ screen.

(7) End-Users 2-12 can do a security x-ray scan by pressing ‘X-SCAN’ button, if ‘X-SCAN’ button is accessible to End-Users. Alternatively, Inspectors can also do a security x-ray scan by pressing ‘X-SCAN’ button remotely. This would execute the procedure ‘Security X-Ray Scan’. If the ‘X-SCAN’ button is pressed by end-users 2-12, then response message received in the response would be displayed in the ‘Display Message’ screen.

(8) Inspectors 2-10 verify identification documents, verify x-ray scanned images and authorize or deny passage of goods using the form provided by the security provider 2-8 as shown in FIG. 2-20. This form would execute the procedure ‘Approve/Deny Passage of Goods’.

(9) Upon successfully passing through check-point, the end users 2-12 would access the same self-service security goods scanner chamber on which their goods were loaded and would follow the instructions 2-97 as shown in FIG. 2-21 to unload the goods from the self-service security goods scanner chamber.

(10) End-Users 2-12 get a one-time authorization code to unlock a door of a self-service security goods scanner chamber facing secured area by scanning a ‘QR Code’ using a mobile wallet or by entering a mobile number in the ‘Key Pad’ and by pressing the ‘GET CODE’ button. This would execute the procedure ‘Get AuthCode with QR Code or Mobile Number’. If the request was submitted by scanning the QR Code using a wallet app, then a one-time authorization code and/or a response message will be displayed in the said wallet app. If the request was submitted by entering a mobile number in the ‘Key Pad’ then a one-time authorization code will be sent to the said mobile device and/or a response message received in the response would be displayed in the ‘Message Display’ screen.

(11) End-Users 2-12 could unlock a door of self-service security goods scanner chamber facing secured area by entering a one-time authorization code in the ‘Key Pad’ and by pressing ‘UNLOCK’ button. This would execute the procedure ‘Unlock Door’. The ‘Door’ of the self-service security goods scanner chamber facing secured area would be unlocked and/or a response message received in the response would be displayed in the ‘Message Display’ screen.

(12) Inspectors 2-10 unlock a door of self-service security goods scanner chamber facing secured area by entering their master authorization code in the ‘Key Pad’ and by pressing ‘UNLOCK’ button. This would execute the procedure ‘Unlock Door’. The ‘Door’ of the self-service security goods scanner chamber facing secured area would be unlocked and/or a response message received in the response would be displayed in the ‘Display Message’ screen.

Following are details of programmatically executable procedures used by service provider 2-8 and loaded into the microcontroller 2-64 and/or the personal computer 2-82 and/or the application server 2-121:

Unsecured Lock:

To enable the end user 2-12 to pass goods from unsecured area to secured area using a self-service security goods scanner chamber, the service provider would display a list of available self-service security goods scanner chambers on a monitor, which would be conspicuously visible to end users, as shown in FIG. 2-5. To add a self-service security goods scanner chamber to the list of available self-service security goods scanner chambers, the inspectors 2-10 would select self-service security goods scanner chambers that are empty with secured side doors unlocked and/or unsecured side doors unlocked. Then the said inspectors 2-10 would lock all the doors facing the unsecured area by pressing ‘UNSECURED LOCK’ button 2-58 and all the doors facing the secured area by pressing ‘SECURED LOCK’ button 2-59 as shown in FIG. 2-8. All self-service security goods scanner chambers where the latest row in Self-service security goods scanner chamber Authorization Code database have the value for the field Inspector_Unsecured_Locked_YN is ‘Y’, the value for the field Inspector_Secured_Locked_YN is ‘Y’ and the value for the field Document1_Scanned_YN is ‘N’ will be added into Available Self-service security goods scanner chambers list.

When the said inspectors 2-10 press the button ‘UNSECURED LOCK’ the microcontroller would format a request message which consists of command which is ‘UNSECURED LOCK’, dip switch 2-68 settings and/or serial number 2-69. Then the microcontroller 2-64 would forward the request message to the personal computer 2-82 through the network 2-81. Then the personal computer 2-82 would add check-point specific information like facility ID and security check-point ID to the request message and forward the said request message to the service provider 2-8 through the authorization gateway 2-133 as shown in FIG. 2-26. The service provider 2-8 would verify the request message and send a response back to the personal computer 2-82, which would send the response back to the microcontroller through the network 2-81.

The service provider 2-8, in order to process the request message, would forward the request message to the request handler 2-122 to handle the request. The request handler 2-122 then verify the location information in the request message namely the facility ID and the check-point ID. If the facility ID and the check-point ID exists in the service client database 2-128 and if the current status is active then the request handler would forward the request message to authorizing agent 2-123, otherwise the verification process would terminate with response type ‘DENY’ and response message ‘Invalid Location’. The authorizing agent would verify the microcontroller information in the request message namely the dip switch settings 2-68 and/or serial number 2-69 using the scanner chamber database 2-129. If the value for the field Identifier_Type in scanner chamber database 2-129 as shown in FIG. 2-12 is ‘D’, then the authorizing agent would locate the scanner chamber number and the side of the door using the dip switch settings, otherwise the authorizing agent would locate the scanner chamber number and the side of the door using the serial number. If the authorizing agent could locate the scanner chamber number and the side of the door then the authorizing agent would add the scanner chamber number and the side of the door to the request message and forward the said request message to the validation tool, otherwise the verification process would terminate with response type ‘DENY’ and response message ‘Invalid scanner chamber and/or door’. If the side of the door is not ‘Unsecured’ then the verification process would terminate with response type ‘DENY’ and response message ‘Invalid door’. If the verification is not terminated, a new row will be inserted into authorization code database 2-131. If no row exists in the authorization code database 2-131 then the value for Transaction Number in the new row will be set to 1, otherwise the Transaction Number will be incremented by 1 from the last inserted row. The values of facility ID, check-point ID and scanner chamber number will be used to populate the fields Facility_Id, Check_Point_Id, and Security_Goods_Scanner_Chamber_Number fields respectively. All the fields that have field names ending with ‘_YN’, except the fields Inspector_Unsecured_Locked_YN and XRary_Scanner_Approved_YN, would be populated with the value ‘N’. The field Inspector_Unsecured_Locked_YN will be populated with ‘Y’. The field XRary_Scanner_Approved_YN will be populated with a blank. All the other fields would be populated with blank values.

If the verification is not terminated, then the verification process would terminate, with response type ‘APPROVE’. The response will be sent back to the microcontroller 2-64. If the microcontroller 2-64 receives a response with response type ‘APPROVE’ then the microcontroller 2-64 would lock the door 2-103.

Secured Lock:

When inspectors 2-10 press the button ‘SECURED LOCK’ the microcontroller would format a request message which consists of command which is ‘SECURED LOCK’, dip switch 2-68 settings and/or serial number 2-69. Then the microcontroller 2-64 would forward the request message to the personal computer 2-82 through the network 2-81. Then the personal computer 2-82 would add check-point specific information like facility ID and security check-point ID to the request message and forward the said request message to the service provider 2-8 through the authorization gateway 2-133 as shown in FIG. 2-26. The service provider 2-8 would verify the request message and send a response back to the personal computer 2-82, which would send the response back to the microcontroller through the network 2-81.

The service provider 2-8, in order to process the request message, would forward the request message to the request handler 2-122 to handle the request. The request handler 2-122 then verify the location information in the request message namely the facility ID and the check-point ID. If the facility ID and the check-point ID exists in the service client database 2-128 and if the current status is active then the request handler would forward the request message to authorizing agent 2-123, otherwise the verification process would terminate with response type ‘DENY’ and response message ‘Invalid Location’. The authorizing agent would verify the microcontroller information in the request message namely the dip switch settings 2-68 and/or serial number 2-69 using the scanner chamber database 2-129. If the value for the field Identifier_Type in scanner chamber database 2-129 as shown in FIG. 2-12 is ‘D’, then the authorizing agent would locate the scanner chamber number and the side of the door using the dip switch settings, otherwise the authorizing agent would locate the scanner chamber number and the side of the door using the serial number. If the authorizing agent could locate the scanner chamber number and the side of the door then the authorizing agent would add the scanner chamber number and the side of the door to the request message and forward the said request message to the validation tool, otherwise the verification process would terminate with response type ‘DENY’ and response message ‘Invalid scanner chamber and/or door’. If the side of the door is not ‘Secured’ then the verification process would terminate with response type ‘DENY’ and response message ‘Invalid door’.

If the verification process is not terminated, the validation tool, using the facility ID, check-point ID and scanner chamber number from the request message, would get the latest row from the authorization code database 2-131. If the value of the field Inspector_Unsecured_Locked_YN is equal to ‘Y’ and Inspector_Secured_Locked_YN is equal to ‘N’ then the service provider 2-8 will update the field Inspector_Secured_Locked_YN to ‘Y’ and the verification process would terminate with the response type ‘APPROVE’, otherwise the verification process would terminate with response type ‘DENY’ and response message ‘Invalid door’.

The response will be sent back to the microcontroller 2-64. If the microcontroller 2-64 receives a response with response type ‘APPROVE’ then the microcontroller 2-64 would lock the door 2-113.

End-User Self-Identification:

Once the end user 2-10 selects a self-service security goods scanner chamber to pass goods from unsecured area to secured area from the list of available self-service security goods scanner chambers displayed on the display monitor, the end user 2-10 would access the selected self-service security goods scanner chamber in the unsecured area. The scanner chamber number 2-99 would be displayed on each self-service security goods scanner chamber so that the end users 2-12 could access the desired self-service security goods scanner chamber. Once accessed the desired self-service security goods scanner chamber, the end users 2-10 can load the goods into the said self-service security goods scanner chamber. To load the goods, the end user 2-10 need to identify themselves to the said self-service security goods scanner chamber, unlock the said self-service security goods scanner chamber, place the goods inside the said self-service security goods scanner chamber and lock the said self-service security goods scanner chamber.

To identify themselves the end users 2-12 would insert approved security documents like driver's license, airline boarding pass, badge and the like into the document scanner reader 2-105 and press the ‘D-SCAN’ button. If more than one approved security document is required to complete the identification process, then the end users 2-12 would use one document at a time. To start the goods loading process, the end user 2-12 would insert a valid document into the document scanner reader 2-105 and press the ‘D-SCAN’ button. When ‘D-SCAN’ button is pressed the microcontroller 2-64 would verify that a document has been inserted into the document scanner reader 2-105. If a document is inserted then the process will continue, otherwise it will terminate with a text ‘Insert Document’ displayed on the mini screen 2-107. If the process continues, the document scanner reader 2-105 would capture the image of the document and read any text encoded in the document. The scanner part of the document scanner reader 2-105 would capture the image of the document and the reader part of the document scanner reader 2-105 would read the encoded text (for example encoded in a magnetic stripe), if any, in the document. Then the microcontroller would format a request message which consists of document image, encoded text, command which is ‘D-SCAN’, dip switch 2-68 settings and/or serial number 2-69. Then the microcontroller 2-64 would forward the request message to the personal computer 2-82 through the network 2-81. Then the personal computer 2-82 would add check-point specific information like facility ID and security check-point ID to the request message and forward the said request message to the service provider 2-8 through the authorization gateway 2-133 as shown in FIG. 2-26. The service provider 2-8 would verify the request message and send a response back to the personal computer 2-82, which would send the response back to the microcontroller through the network 2-81.

The service provider 2-8, in order to process the request message, would forward the request message to the request handler 2-122 to handle the request. The request handler 2-122 then verify the location information in the request message namely the facility ID and the check-point ID. If the facility ID and the check-point ID exists in the service client database 2-128 and if the current status is active then the request handler would forward the request message to authorizing agent 2-123, otherwise the verification process would terminate with response type ‘DENY’ and response message ‘Invalid Location’. The authorizing agent would verify the microcontroller information in the request message namely the dip switch settings 2-68 and/or serial number 2-69 using the scanner chamber database 2-129. If the value for the field Identifier_Type in scanner chamber database 2-129 as shown in FIG. 2-12 is ‘D’, then the authorizing agent would locate the scanner chamber number and the side of the door using the dip switch settings, otherwise the authorizing agent would locate the scanner chamber number and the side of the door using the serial number. If the authorizing agent could locate the scanner chamber number and the side of the door then the authorizing agent would add the scanner chamber number and the side of the door to the request message and forward the said request message to the validation tool, otherwise the verification process would terminate with response type ‘DENY’ and response message ‘Invalid scanner chamber and/or door’. If the side of the door is not ‘Unsecured’ then the verification process would terminate with response type ‘DENY’ and response message ‘Invalid door’.

The validation tool, using the facility ID, check-point ID and scanner chamber number from the request message, would get the latest row from the authorization code database 2-131. If Inspector_Unsecured_Locked_YN equal to ‘Y’ and Inspector_Secured_Locked_YN equal to ‘Y’ the verification process will continue, otherwise it would terminate with response type ‘DENY’ and with response message ‘Invalid door’. If verification process continues then, if Document1_Scanned_YN not equal to ‘Y’ then, the service provider 2-8 would update the latest row by setting the value for the fields Document1_Scanned_YN to ‘Y’, Dorument1_Scanner_DateTime to current date and time, Document1_Scanned_Image to the document image in the request message and Document1_Read_Text to the document text in the request message, otherwise, if Document2_Scanned_YN not equal to ‘Y’ then, the service provider 2-8 would update the latest row by setting the value for the fields Document2_Scanned_YN to ‘Y’, Dorument2_Scanner_DateTime to current date and time, Document2_Scanned_Image to the document image in the request message and Document2_Read_Text to the document text in the request message, otherwise, verification process would terminate with response type ‘DENY’ and with response message ‘Cannot scan more than 2 documents’. If the verification process is not terminated, then the service provider 2-8 would terminate with response type ‘APPROVE’ and with response message ‘D-Scanned’.

Get AuthCode with QR Code or Mobile Number:

To unlock/lock any door of the self-service security goods scanner chamber, the end users 2-12 would need a one-time security authorization code. The end users 2-12 can either scan the QR Code 2-100 or 2-110 using a mobile wallet or enter their mobile number in the key pad 2-106 or 2-115 and press the ‘GET CODE’ button to get a one-time authorization code.

If the end users 2-12 scanned the QR Code 2-100 or 2-110 using a mobile wallet, then the mobile wallet would read the content of the QR Code to start a mobile wallet process and provide a one-time authorization code or issue an error message. The content of the QR Code would be facility ID, check-point ID, scanner chamber number, dip switch 2-68 settings and/or serial number 2-69, the text ‘GET CODE’ and a service provider 2-8 provided random number generated each time the QR Code is replaced. Inspectors 2-10 can replace the QR Code as often as required. The mobile wallet would restrict the end users 2-12 only to scan the QR Code and not be manually entered using keyboard. The mobile wallet process would determine whether the QR Code was scanned or the content of the QR Code was manually entered. If the QR Code was not scanned then, the mobile wallet process will terminate with appropriate error message. If the mobile wallet process is not terminated, then the mobile wallet process would compare the GPS location information from the mobile device and the GPS location based on the facility ID and the check-point ID. If they are not equal, then the mobile wallet process will terminate with an appropriate error message. If the mobile wallet process is not terminated, then the mobile wallet would verify the random number included in the QR Code with the service provider 2-10 using an Application Programming Interface provided by the service provider 2-10. If the verification fails, then the mobile wallet process will terminate with an appropriate error message. If the mobile wallet process is not terminated, then the mobile wallet process would authenticate the mobile wallet user including biometric authentication. If the authentication fails, then the mobile wallet process will terminate with an appropriate error message. If the mobile wallet process is not terminated, then the mobile wallet process would format a request message which consists of mobile number, request type which is ‘GET CODE’, input type which is ‘QR Code’, facility ID, check-point ID and dip switch 2-68 settings and/or serial number 2-69. The mobile wallet process would send the request message to the service provider 2-8 through the authorization gateway 2-133 as shown in FIGS. 2-26 and receive a response with response type and response message. The mobile wallet would display the response in the mobile device. If the request is processed successfully then the response message would include the one-time authorization code.

On the other hand, if the end users 2-12 entered their mobile number in the key pad 2-106 or 2-115 and pressed the ‘GET CODE’ button, then the microcontroller 2-64 would format a request message which consists of mobile number, command which is ‘GET CODE’, dip switch 2-68 settings and/or serial number 2-69. Then the microcontroller 2-64 would forward the request message to the personal computer 2-82 through the network 2-81. Then the personal computer 2-82 would add check-point specific information like facility ID and security check-point ID to the request message and forward the said request message to the service provider 2-8 through the authorization gateway 2-133 as shown in FIGS. 2-26 and receive a response with response type and response message. The personal computer 2-82, would send the response back to the microcontroller through the network 2-81.

The service provider 2-8, in order to process the request message, would forward the request message to the request handler 2-122 to handle the request. The request handler 2-122 then verify the location information in the request message namely the facility ID and the check-point ID. If the facility ID and the check-point ID exists in the service client database 2-128 and if the current status is active then the request handler would forward the request message to authorizing agent 2-123, otherwise the verification process would terminate with response type ‘DENY’ and response message ‘Invalid Location’. The authorizing agent would verify the microcontroller information in the request message namely the dip switch settings 2-68 and/or serial number 2-69 using the scanner chamber database 2-129. If the value for the field Identifier_Type in scanner chamber database 2-129 as shown in FIG. 2-12 is ‘D’, then the authorizing agent would locate the scanner chamber number and the side of the door using the dip switch settings, otherwise the authorizing agent would locate the scanner chamber number and the side of the door using the serial number. If the authorizing agent could locate the scanner chamber number and the side of the door then the authorizing agent would add the scanner chamber number and the side of the door to the request message and forward the said request message to the validation tool 2-124, otherwise the verification process would terminate with response type ‘DENY’ and response message ‘Invalid scanner chamber and/or door’.

The validation tool 2-124, using the facility ID, check-point ID and scanner chamber number from the request message, would get the latest row from the authorization code database 2-131. If Document1_Scanned_YN is equal to ‘Y’ then, verification process would continue, otherwise verification process would terminate with response type ‘DENY’ and with response message ‘Document Scanning is required’.

If the format of the mobile number in the request message is valid then the verification process will continue, otherwise the verification process will terminate with response type ‘DENY’ and response message ‘Invalid mobile number’. If Mobile Number is blank or equal to the mobile number in the request message, then the verification process would continue, otherwise the verification process would terminate with response type ‘DENY’ and response message ‘Invalid mobile number’.

If the side of the door in the request message is ‘unsecured’ and if UnSecured_Unlocked_YN equal to ‘Y’ and UnSecured_Locked_YN equal to ‘Y’, then the verification process would terminate, with response type ‘DENY’ and response message ‘Invalid side’. If the side of the door in the request message is ‘secured’ and if UnSecured_Unlocked_YN equal to ‘N’ or UnSecured_Locked_YN equal to ‘N’, then the verification process would terminate, with response type ‘DENY’ and response message ‘Invalid side’. If the side of the door in the request message is ‘secured’ and if XRay_Scanner_Approved_YN equal to ‘N’ then the verification process would terminate, with response type ‘DENY’ and response message ‘Waiting for Approval’.

If the verification process is not terminated, then the service provider 2-8 would create a random number, may be, between 6 and 8 digits and is not same any inspector's master authorization code. If the verification process is not terminated, then the service provider 2-8 would update the latest row in authorization code database 2-131 based on the facility ID, check-point ID and scanner chamber number from the request message and by populating field Mobile Number with mobile number in the request message.

If the verification process is not terminated and if Unsecured_Unlocked_YN equal to ‘N’, then the service provider 2-8 would update the latest row in authorization code database 2-131 based on the facility ID, check-point ID and scanner chamber number from the request message and by populating field UnSecured_Unlock_Authcode with said random number and by populating UnSecured_Unlock_Authcode_DateTime with current date and time.

If the verification process is not terminated and if Unsecured_Unlocked_YN equal to ‘Y’ and Unsecured_Locked_YN equal to ‘N’, then the service provider 2-8 would update the latest row in authorization code database 2-131 based on the facility ID, check-point ID and scanner chamber number from the request message and by populating field UnSecured_Lock_Authcode with said random number and by populating UnSecured_Lock_Authcode_DateTime with current date and time.

If the verification process is not terminated and if Unsecured_Unlocked_YN equal to ‘Y’ and Unsecured_Locked_YN equal to ‘Y’ and Secured_Unlocked_YN equal to ‘N’, then the service provider 2-8 would update the latest row in authorization code database 2-131 based on the facility ID, check-point ID and scanner chamber number from the request message and by populating field Secured_Unlock_Authcode with said random number and by populating Secured_Unlock_Authcode_DateTime with current date and time.

If input type exists in the request message and is ‘QR CODE’ and if the verification process is not terminated the service provider 2-8 would terminate the verification process with response type ‘APPROVE’ and response message populated with the said random number, otherwise if the verification process is not terminated the service provider 2-8 would send the said random number to the mobile number received in the request message and would terminate the verification process with response type ‘APPROVE’ and with response message ‘Code Sent’.

If input type exists in the request message and is ‘QR CODE’ then, the response will be sent back to the mobile wallet process otherwise, the response will be sent back to the microcontroller 2-80 and the microcontroller 2-80 would display the response message received in the response, in the mini screen 2-107 or 2-116.

Unlock Door:

To unlock any door facing unsecured area or facing secured area, the end users 2-12 need to enter a one-time authorization code in the key pad 2-106 or 2-115 and press the ‘UNLOCK’ button. When ‘UNLOCK’ button is pressed, the microcontroller 2-64 would format a request message which consists of one-time authorization code, command which is ‘UNLOCK’, dip switch 2-68 settings and/or serial number 2-69. Then the microcontroller 2-64 would forward the request message to the personal computer 2-82 through the network 2-81. Then the personal computer 2-82 would add check-point specific information like facility ID and security check-point ID to the request message and forward the said request message to the service provider 2-8 through the authorization gateway 2-133 as shown in FIGS. 2-26 and receive a response with response type and response message. The personal computer 2-82, would send the response back to the microcontroller through the network 2-81.

The service provider 2-8, in order to process the request message, would forward the request message to the request handler 2-122 to handle the request. The request handler 2-122 then verify the location information in the request message namely the facility ID and the check-point ID. If the facility ID and the check-point ID exists in the service client database 2-128 and if the current status is active then the request handler would forward the request message to authorizing agent 2-123, otherwise the verification process would terminate with response type ‘DENY’ and response message ‘Invalid Location’. The authorizing agent would verify the microcontroller information in the request message namely the dip switch settings 2-68 and/or serial number 2-69 using the scanner chamber database 2-129. If the value for the field Identifier_Type in scanner chamber database 2-129 as shown in FIG. 2-12 is ‘D’, then the authorizing agent would locate the scanner chamber number and the side of the door using the dip switch settings, otherwise the authorizing agent would locate the scanner chamber number and the side of the door using the serial number. If the authorizing agent could locate the scanner chamber number and the side of the door then the authorizing agent would add the scanner chamber number and the side of the door to the request message and forward the said request message to the validation tool, otherwise the verification process would terminate with response type ‘DENY’ and response message ‘Invalid scanner chamber and/or door’.

The validation tool, using the facility ID, check-point ID and scanner chamber number from the request message, would get the latest row from the authorization code database 2-131.

If Document1_Scanned_YN_is equal to ‘Y’ then, verification process would continue, otherwise verification process would terminate with response type ‘DENY’ and with response message ‘Self Verification is required’.

If the side of the door in the request message is ‘unsecured’ and if UnSecured_Unlocked_YN equal to ‘Y’, then the verification process would terminate, with response type ‘DENY’ and response message ‘Invalid request’.

If the side of the door in the request message is ‘secured’ and if UnSecured_Unlocked_YN equal to ‘Y’ and UnSecured_Locked_YN equal to ‘Y’, then the verification process would continue, otherwise the verification process would terminate with response type ‘DENY’ and response message ‘Invalid request’.

If the side of the door in the request message is ‘secured’ and if UnSecured_Unlocked_YN equal to ‘Y’, UnSecured_Locked_YN equal to ‘Y’ and XRay_Scanned_YN not equal to ‘Y’, the verification process would terminate with response type ‘DENY’ and response message ‘Goods have to be scanned’.

If the verification process continues and the side of the door in the request message is ‘unsecured’ and any inspector's master authorization code is equal to authorization code in the request message, then the verification process would terminate, with response type ‘APPROVE’ and response message ‘Unlocked’.

If the verification process continues and the side of the door in the request message is ‘secured’ and any inspector's master authorization code is equal to authorization code in the request message, then the verification process would terminate, with response type ‘APPROVE’ and response message ‘Unlocked’.

If the side of the door in the request message is ‘secured’ and if UnSecured_Unlocked_YN equal to ‘Y’, UnSecured_Locked_YN equal to ‘Y’, XRay_Scanned_YN equal to ‘Y’, and XRay_Scanner_Verified_YN not equal to ‘Y’, the verification process would terminate with response type ‘DENY’ and response message ‘Waiting for approval’.

If the side of the door in the request message is ‘secured’ and if UnSecured_Unlocked_YN equal to ‘Y’, UnSecured_Locked_YN equal to ‘Y’, XRay_Scanned_YN equal to ‘Y’, XRay_Scanner_Verified_YN equal to ‘Y’ and XRay_Scanner_Approved_YN not equal to ‘Y’, the verification process would terminate with response type ‘DENY’ and response message ‘Contact Inspector’.

If the verification process continues and the side of the door in the request message is ‘unsecured’ and current date and time minus Unsecured_Unlock_AuthCode_DateTime is more than a preset expiration level, then the verification process would terminate, with response type ‘DENY’ and response message ‘Time Expired’.

If the verification process continues and the side of the door in the request message is ‘secured’ and current date and time minus Secured_Unlock_AuthCode_DateTime is more than a preset expiration level, then the verification process would terminate, with response type ‘DENY’ and response message ‘Time Expired’.

If the verification process continues and the side of the door in the request message is ‘unsecured’ and Unsecured_Unlock_AuthCode is equal to authorization code in the request message, then the verification process would terminate, with response type ‘APPROVE’ and response message ‘Unlocked’. If the verification process continues and the side of the door in the request message is ‘secured’ and Secured_Unlock_AuthCode is equal to authorization code in the request message, then the verification process would terminate, with response type ‘APPROVE’ and response message ‘Unlocked’.

If the response type is equal to ‘APPROVE’ and the side of the door in the request message is ‘unsecured’, then the service provider 2-8 would update the latest row in the authorization code database 2-131 by setting the value for the field UnSecured_Unlocked_YN to ‘Y’. If the response type is equal to ‘APPROVE’ and the side of the door in the request message is ‘secured’, then the service provider 2-8 would update the latest row in the authorization code database 2-131 by setting the value for the field Secured_Unlocked_YN to ‘Y’.

The response will be sent back to the microcontroller 2-64. If the microcontroller 2-64 receives a response with response type ‘APPROVE’ then the microcontroller 2-64 would unlock the door 2-103 or 2-113. The microcontroller 2-64 would display the response message received in the response, in the mini screen 2-107 or 2-116.

Lock Door:

To lock any door facing unsecured area, the end users 2-12 need to enter a one-time authorization code in the key pad 2-106 and press the ‘LOCK’ button. When ‘LOCK’ button is pressed, the microcontroller 2-64 would format a request message which consists of one-time authorization code, command which is ‘LOCK’, dip switch 2-68 settings and/or serial number 2-69. Then the microcontroller 2-64 would forward the request message to the personal computer 2-82 through the network 2-81. Then the personal computer 2-82 would add check-point specific information like facility ID and security check-point ID to the request message and forward the said request message to the service provider 2-8 through the authorization gateway 2-133 as shown in FIGS. 2-26 and receive a response with response type and response message. The personal computer 2-82, would send the response back to the microcontroller through the network 2-81.

The service provider 2-8, in order to process the request message, would forward the request message to the request handler 2-122 to handle the request. The request handler 2-122 then verify the location information in the request message namely the facility ID and the check-point ID. If the facility ID and the check-point ID exists in the service client database 2-128 and if the current status is active then the request handler would forward the request message to authorizing agent 2-123, otherwise the verification process would terminate with response type ‘DENY’ and response message ‘Invalid Location’. The authorizing agent would verify the microcontroller information in the request message namely the dip switch settings 2-68 and/or serial number 2-69 using the scanner chamber database 2-129. If the value for the field Identifier_Type in scanner chamber database 2-129 as shown in FIG. 2-12 is ‘D’, then the authorizing agent would locate the scanner chamber number and the side of the door using the dip switch settings, otherwise the authorizing agent would locate the scanner chamber number and the side of the door using the serial number. If the authorizing agent could locate the scanner chamber number and the side of the door then the authorizing agent would add the scanner chamber number and the side of the door to the request message and forward the said request message to the validation tool, otherwise the verification process would terminate with response type ‘DENY’ and response message ‘Invalid scanner chamber and/or door’.

The validation tool, using the facility ID, check-point ID and scanner chamber number from the request message, would get the latest row from the authorization code database 2-131.

If the side of the door in the request message is ‘secured’, then the verification process would terminate, with response type ‘DENY’ and response message ‘Invalid request’.

If Document1_Scanned_YN_is equal to ‘Y’ then, verification process would continue, otherwise verification process would terminate with response type ‘DENY’ and with response message ‘Self Verification is required’.

If the side of the door in the request message is ‘unsecured’ and if UnSecured_Locked_YN equal to ‘Y’, then the verification process would terminate, with response type ‘DENY’ and response message ‘Invalid request’.

If the side of the door in the request message is ‘unsecured’ and if UnSecured_Unlocked_YN not equal to ‘Y’, then the verification process would terminate with response type ‘DENY’ and response message ‘Invalid request’.

If the verification process continues and the side of the door in the request message is ‘unsecured’ and any inspector's master authorization code is equal to authorization code in the request message, then the verification process would terminate with response type ‘APPROVE’ and response message ‘Locked’.

If the verification process continues and if the side of the door in the request message is ‘unsecured’ and current date and time minus Unsecured_Lock_AuthCode_DateTime is more than a preset expiration level, then the verification process would terminate, with response type ‘DENY’ and response message ‘Time Expired’.

If the verification process continues and the side of the door in the request message is ‘unsecured’ and Unsecured_Lock_AuthCode is equal to authorization code in the request message, then the verification process would terminate, with response type ‘APPROVE’ and response message ‘Locked’.

If the response type is equal to ‘APPROVE’ and the side of the door in the request message is ‘unsecured’, then the service provider 2-8 would update the latest row in the authorization code database 2-131 by setting the value for the fields UnSecured_Locked_YN to ‘Y’.

The response will be sent back to the microcontroller 2-64. If the microcontroller 2-64 receives a response with response type ‘APPROVE’ then the microcontroller 2-64 would lock the door 2-103. The microcontroller 2-83 would display the response message received in the response, in the mini screen 2-107.

Security X-Ray Scan:

Once the end user 2-12 has placed the goods inside the self-service security goods scanner chamber and locked the door facing unsecured area then the said goods are ready to be scanned by security x-ray scanners for security clearance. Scanning of said goods by security x-ray scanners can be done just by pressing ‘X-SCAN’ button 2-61 by the end user 2-12, if ‘X-SCAN’ button 2-61 is accessible to end user 2-10. Alternatively, scanning of said goods by security x-ray scanners can always be done just by pressing ‘X-SCAN’ button 2-61 by the inspectors 2-10. When ‘X-SCAN’ button is pressed the microcontroller 2-64 would request the security x-ray scanner 2-60 to scan the goods and get scanned images. Once the microcontroller 2-64 receives the scanned images from security x-ray scanner, the microcontroller 2-64 would format a request message which consists of scanned images, command which is ‘X-SCAN’, dip switch 2-68 settings and/or serial number 2-69. Then the microcontroller 2-64 would forward the request message to the personal computer 2-82 through the network 2-81. Then the personal computer 2-82 would add check-point specific information like facility ID and security check-point ID to the request message and forward the said request message to the service provider 2-8 through the authorization gateway 2-133 as shown in FIG. 2-26. The service provider 2-8 would verify the request message and send a response back to the personal computer 2-82, which would send the response back to the microcontroller through the network 2-81.

The service provider 2-8, in order to process the request message, would forward the request message to the request handler 2-122 to handle the request. The request handler 2-122 then verify the location information in the request message namely the facility ID and the check-point ID. If the facility ID and the check-point ID exists in the service client database 2-128 and if the current status is active then the request handler would forward the request message to authorizing agent 2-123, otherwise the verification process would terminate with response type ‘DENY’ and response message ‘Invalid Location’. The authorizing agent would verify the microcontroller information in the request message namely the dip switch settings 2-68 and/or serial number 2-69 using the scanner chamber database 2-129. If the value for the field Identifier_Type in scanner chamber database 2-129 as shown in FIG. 2-12 is ‘D’, then the authorizing agent would locate the scanner chamber number and the side of the door using the dip switch settings, otherwise the authorizing agent would locate the scanner chamber number and the side of the door using the serial number. If the authorizing agent could locate the scanner chamber number and the side of the door then the authorizing agent would add the scanner chamber number and the side of the door to the request message and forward the said request message to the validation tool, otherwise the verification process would terminate with response type ‘DENY’ and response message ‘Invalid scanner chamber and/or door’. If the side of the door is not ‘Unsecured’ then the verification process would terminate with response type ‘DENY’ and response message ‘Invalid door’.

The validation tool, using the facility ID, check-point ID and scanner chamber number from the request message, would get the latest row from the authorization code database 2-131. If UnSecured_Locked_YN is equal to ‘Y’ then, verification process would continue, otherwise verification process would terminate with response type ‘DENY’ and with response message ‘Scanner chamber has to be locked’. If XRay_Scanned_YN is equal to ‘Y’ then, verification process would terminate with response type ‘DENY’ and with response message ‘Cannot Scan Again’. If verification process has not been terminated then, the service provider

2-8 would update the latest row by setting the value for the fields XRay_Scanned_YN to ‘Y’, XRay_Scanned_DateTime to current date and time, XRay_Scanned_Image to the scanned images in the request message. If the verification process is not terminated, then the service provider 2-8 would terminate with response type ‘APPROVE’ and with response message ‘X-Scanned’.

The response will be sent back to the microcontroller 2-64. The microcontroller 2-64 would display the response message received in the response, in the mini screen 2-107.

Approve/Deny Passage of Goods:

The inspectors 2-10 would access the form 2-96 as shown in FIG. 2-20. The inspectors 2-10 would enter facility ID, security check-point ID, inspector ID and password into a log in form 2-96L as shown in FIG. 2-20L. If the submitted credentials are valid then the service provider 2-8 would generally continue and present the form 2-20, otherwise it will terminate the process. Every time when the form 2-20 is opened, the service provider 2-8 would build the dropdown scanner chamber number list by accessing all latest rows based on facility ID, self-service security goods scanner chamber number and transaction number from authorization code database 2-131 where the value of the field Unsecured_Locked_YN is equal to ‘Y’ and the value of the field XRary_Scanner_Approved_YN is blank. If dropdown scanner chamber number list count is greater than 0 then the inspectors would be able to select a scanner chamber number, otherwise a message will be displayed and inspectors 2-10 will not be able to select any scanner chamber number. When the inspectors 2-10 select a scanner chamber number from the dropdown list then the service provider 2-8 would update the form by accessing the latest row from authorization code database 2-131 based on facility ID, check-point ID, scanner chamber number and transaction number. If XRay_Scanned_YN equal ‘N’ for any row in the list, then the inspector can perform a security x-ray scan of the goods placed in the self-service security goods scanner chamber and refresh the list.

If Document1_Scanned_YN_is equal to ‘Y’ then Driver's License field will be populated with the text ‘View Driver's License’, otherwise the said field will be populated with blank. If Document1_Verified_YN is equal to ‘Y’ then Driver's License Viewed filed will be populated with the text ‘Viewed’, otherwise the said field will be populated with blank. If Document2_Scanned_YN is equal to ‘Y’ then Boarding Pass field will be populated with the text ‘View Boarding Pass’, otherwise the said field will be populated with blank. If Document2_Verified_YN is equal to ‘Y’ then Boarding Pass Viewed filed will be populated with the text ‘Viewed’, otherwise the said field will be populated with blank. If XRay_Scanned_YN is equal to ‘Y’ then Security XRay Scanner field will be populated with the text ‘View Security Images’, otherwise the said field will be populated with blank. If XRay_Verified_YN is equal to ‘Y’ then Security XRay Scanner Viewed filed will be populated with the text ‘Viewed’, otherwise the said field will be populated with blank. If XRay_Scanner_Approved_YN is equal to ‘Y’ then Security Result field will be populated with the text ‘Approved’, otherwise if XRay_Scanner_Approved_YN is equal to ‘N’ then Security Result field will be populated with the text ‘Denied’, otherwise the Security Result field will be populated with blank.

If Document1_Scanned_YN_is equal to ‘Y’ and if the inspectors 2-10 clicked on Driver's License field, then the service provider 2-8 would display the Document1_Scanned_Image and Document1_Read_Text on a pop-up window with options ‘DENY’ and ‘APPROVE’. If the inspectors 2-10 clicked on ‘DENY’ option in the pop-up window, then the service provider 2-8 would update the latest row in the authorization code database 2-131 based on facility ID, check-point ID, scanner chamber number and transaction number by setting the value for Document1_Verified_YN to ‘Y’ and setting the value for Document1_Approved_YN to ‘N’ and update the form 2-96 accordingly. If the inspectors 2-10 clicked on ‘APPROVE’ option in the pop-up window, then the service provider 2-8 would update the latest row in the authorization code database 2-131 based on facility ID, check-point ID, scanner chamber number and transaction number by setting the value for Document1_Verified_YN to ‘Y’ and setting the value for Document1_Approved_YN to ‘Y’ and update the form 2-96 accordingly.

If Document2_Scanned_YN is equal to ‘Y’ and if the inspectors 2-10 clicked on Boarding Pass field, then the service provider 2-8 would display the Document2_Scanned_Image and Document2_Read_Text on a pop-up window with options ‘DENY’ and ‘APPROVE’. If the inspectors 2-10 clicked on ‘DENY’ option in the pop-up window, then the service provider 2-8 would update the latest row in the authorization code database 2-131 based on facility ID, check-point ID, scanner chamber number and transaction number by setting the value for Document2_Verified_YN to ‘Y’ and setting the value for Document2_Approved_YN to ‘N’ and update the form 2-96 accordingly. If the inspectors 2-10 clicked on ‘APPROVE’ option in the pop-up window, then the service provider 2-8 would update the latest row in the authorization code database 2-131 based on facility ID, check-point ID, scanner chamber number and transaction number by setting the value for Document2_Verified_YN to ‘Y’ and setting the value for Document2_Approved_YN to ‘Y’ and update the form 2-96 accordingly.

If XRay_Scanned_YN is equal to ‘Y’ and if the inspectors 2-10 clicked on Security goods scanner field, then the service provider 2-8 would display the XRay_Scanned_Image on a pop-up window with options ‘DENY’ and ‘APPROVE’. If the inspectors 2-10 clicked on ‘DENY’ option in the pop-up window, then the service provider 2-8 would update the latest row in the authorization code database 2-131 based on facility ID, check-point ID, scanner chamber number and transaction number by setting the value for XRay_Scanner_Verified_YN to ‘Y’ and setting the value for XRay_Scanner_Approved_YN to ‘N’ and setting the value for Security_Inspector_Id to inspector ID and update the form 2-96 accordingly. If the inspectors 2-10 clicked on ‘APPROVE’ option in the pop-up window, then the service provider 2-8 would update the latest row in the authorization code database 2-131 based on facility ID, check-point ID, scanner chamber number and transaction number by setting the value for XRay_Scanner_Verified_YN to ‘Y’ and setting the value for XRay_Scanner_Approved_YN to ‘Y’ and setting the value for Security_Inspector_Id to inspector ID and update the form 2-96 accordingly.

While the foregoing description is exemplary of the present embodiment, those of ordinary skill in the relevant arts will recognize the many variations, alterations, modifications, substitutions and the likes are readily possible, especially in light of this description, the accompanying drawings and claims drawn thereto. For example, those of ordinary skill in the art will recognize that special programs for hotels, malls or the like may be implemented where guests can securely pass goods from outside (unsecured area) of the buildings to inside (secured area) of the building.

### Third Embodiment

This embodiment relates to a system for a self-serve security body scanning to permit the secure passage of a person from an unsecured area to a secured area. This embodiment comprises at least one scanning chamber having at least three remotely controlled electronic doors accessible to interior of the scanning chamber wherein the scanning chamber may have at least one security body scanners for scanning the interior.

Referring to FIG. 3-1, the self-serve security body scanning station 3-1 generally comprises a service provider 3-8, an operative combination of a plurality of service clients 3-9 with implemented use cases 3-2 and 3-3, a plurality of inspectors 3-10 with implemented use cases 3-4, 3-5 and 3-6, and at least one end user 3-12 with implemented use case 3-7. A service client is generally referred to as a security administrative provider such as the Transportation Security Administration (TSA) or private security for public gatherings. An inspector is generally referred to as an agent or employee of the service client. A service provider facilitates the services described herein by managing the hardware and software of the self-serve security body scanning station for persons 3-1. A service provider may also be the service client.

The service provider 3-8 generally provides a means 3-13 for service clients 3-9 to access a form to add/update the scanning chamber. The service client 3-9 generally uses the means 3-14 to submit the request to add/update the scanning chamber. The service provider 3-8 generally uses means 3-15 to approve/deny the service client's request. The use case 3-2 for adding/updating the scanning chamber 3-38 is further detailed in a flow chart in FIG. 3-2.

The service provider 3-8 generally provides a means 3-16 for service clients 3-9 to access a form to add/update inspector information. The service client 3-9 generally uses the means 3-17 to submit the request to add/update inspector information. The service provider 3-8 generally uses the means 3-18 to approve or deny the service client's request. The use case 3-3 for adding/updating inspectors 3-39 is further detailed in a flow chart in FIG. 3-3.

The service provider 3-8 generally provides a means 3-19 for inspectors 3-10 to access a form to update inspector profile information. The inspector 3-10 generally uses the means 3-20 to submit the request to update inspector profile information. The service provider 3-8 generally uses the means 3-21 to approve or deny the inspector's request. The use case 3-4 for updating inspector profile 3-40 is further detailed in a flow chart in FIG. 3-4.

The service provider 3-8 generally provides a means 3-22 for end users 3-12 to enter into a scanning chamber from an unsecured area. The end users 3-12 generally use the means 3-23 to submit the request to unlock and lock a remotely controlled electronic door of a self-service security body scanning station for persons from unsecured area. The service provider 3-8 generally uses the means 3-24 to approve or deny. The use case 3-5 for end users 3-12 to enter the scanning chamber from an unsecured area 3-41 is further detailed in a flow chart in FIG. 3-5.

The service provider 3-8 generally provides a means 3-25 for inspectors 3-10 to select a scanning chamber to conduct a security check on a person entering into a secured area from an unsecured area. The inspectors 3-10 generally use the means 3-26 to perform the security check. The inspectors 3-10 generally use the means 3-27 to approve or deny the end users' request to enter from an unsecured area to a secured area. If security check is completed, then service provider 3-8 generally uses the means 3-28 to send security check completed notification, if required. If security check is completed, then service provider 3-8 generally uses the means 3-29 to update security check completed information and if the security check is approved, the service provider 3-8 would update unload ready information. The use case 3-6 for inspectors 10 to authenticate end users 3-12 using documents and video images to securely verify the persons passing through the scanning chamber 3-42 is further detailed in a flow chart 3-42 in FIG. 3-6.

The service provider 3-8 generally provides a means 3-30 for the end users 3-12 to enter into a secured area from the scanning chamber 3-11. The end user 3-12 generally uses the means 3-31 to submit a request to unlock the scanning chamber 3-11. The service provider 3-8 generally uses the means 3-32 to approve or deny the request and if the request is approved then the scanning chamber 3-11 uses the means 3-35 to unlock the controlled door of the scanning chamber 3-11 in the secured area. If the scanning chamber 3-11 successfully unlocks the controlled door in the secured area, then the service provider 3-8 generally uses means 3-33 for the inspectors 3-10 to verify the scanning chamber 3-11 is empty. Once verified, the doors of the scanning chamber 3-11 are locked. The service provider uses the means 3-34 to indicate the scanning chamber 3-11 available for use. The use case 3-7 for end users 3-12 to exit from security body scanner chamber into secured area or into holding area 3-43 is further detailed in a flow chart in FIG. 3-7.

Time 3-36, as an actor, generally uses the means 3-37 to revoke the security check approval 3-27 if the end user 3-12 does not enter and/or exit from the scanning chamber 3-11 in a predetermined time.

FIGS. 3-8U and 3-8S shows a preferred embodiment of a scanning chamber 3-44 (corresponds with 3-11 in FIG. 3-1) having three doors with one facing an unsecured side 3-46, a secured side 3-59, and a holding side 3-65. The unsecured side faces the unsecured security area and is generally referred to as the “unsecured” side. The exterior face of the unsecured side of the scanning chamber 3-44 comprises a first door 3-46, having a handle 3-47, which is attached to the door frame 3-45. A first key entry pad 3-48, a first screen 3-49, a document scanner reader 3-50, a QR code 3-51, and an X-SCAN button 3-61 are positioned on or within the door frame 3-45 adjacent to the door 3-46. The interior face comprises a handle 3-52 on the first door 3-46, a lock button 3-53, a secondary screen 3-54, and a B-SCAN button 3-55. An ‘UNSECURED LOCK’ button 3-56 is in communication with the scanning chamber 3-44 and accessible to inspectors 3-10.

The secured side faces the secured security area and is generally referred to as the “secured” side. The interior face of the secured side of the scanning chamber 3-44 comprises a second door 3-59, having a handle 3-69, which is attached to the door frame 3-58. A second key entry pad 3-61, a first screen 3-62, a QR code 3-63, a GET CODE button, and an UNLOCK button are positioned on or within the door frame 3-58 adjacent to the door 3-59. A ‘SECURED AREA DOOR LOCK’ button 3-69 is in communication with the scanning chamber 3-44 and accessible to inspectors 3-10.

The holding side faces the holding area and is generally referred to as the “holding” side. The interior face of the holding side of the scanning chamber 3-44 comprises a third door 3-65, having a handle 3-66, which is attached to the door frame 3-64. A screen 3-67 and an “UNLOCK” button 3-67 are positioned on or within the door frame 3-64 adjacent to the door 3-65. A ‘HOLDING AREA DOOR LOCK’ button 3-70 is in communication with the scanning chamber 3-44 and accessible to inspectors 3-10.

The security body scanner 3-57 is wrapped around the frames 3-45, 3-58 and 3-64. The B-SCAN button 3-55 is in communication with the security body scanner 3-57. Live video cameras are attached to the frames 3-45, 3-58 and 3-64 to capture live video of unsecured, secured, and holding areas.

Each door 3-46, 3-59, 3-65 is capable of being locked by a door locking mechanism 3-76 (referenced in FIG. 3-9). The door locking mechanism 3-76 may be an electromagnet that holds the door in a locked position when the said electromagnet is magnetized. The door locking mechanism 3-76 may also be an electromagnet that moves a latch to hold the door in a locked position when the electromagnet is magnetized. The door locking mechanism 3-76 may also be a motor that physically moves the door to an open/closed position such as moving the door up/down or right/left. Any suitable mechanisms for locking or unlocking the door may be utilized so long as the control may be accomplished electronically and remotely.

As shown in FIG. 3-21, a security scanning station 3-109 may be comprised of a plurality of scanning chambers each having a unique external identifier which is visible on the unsecured side, secured side and holding area side.

FIG. 3-9 shows the electronic kit 3-71 used by the service provider to lock/unlock the remotely controlled electronic doors 3-46, 3-59, 3-65. The electronic kit 3-71 is comprised of various components to unlock/lock remotely controlled electronic doors including a local PC board 3-72, door locking mechanism 3-76, a bank of dip switches 3-77 and/or a serial number reader 3-78, external key pad 3-79, scanner reader 3-81, bluetooth reader 3-82, near field communication (NFC) reader 3-83, radio frequency identification (RFID) reader 3-84, primary mini screen 3-85, secondary mini screen 3-86, a remote lock button 3-80, document scanner reader 3-87, and a security body scanner 3-88. The door locking mechanism 3-76 must be physically within the scanning chamber 3-44 to physically lock and unlock the doors. The other components of the electronic kit 3-71 may be located within the scanning chamber 3-44 or in communication therewith. The electronic kit 3-71 is configurable to connect to any number of scanning chambers 3-44 to control the door(s) connected to the scanning chamber 3-44.

The local PC board 3-72 comprises a microcontroller 3-73, communication protocol plus power component 3-74, and a door latch driver 3-75. The power part of the communication protocol plus power component 3-74 supplies DC, either from a battery source or from conversion of AC power, to power the local PC board 3-72. The microcontroller 3-73 communicates, via the communication protocol of the said communication protocol plus power component 3-74, with a small single board computer, a general purpose computer (“personal computer”) 3-92 (as shown in FIG. 3-10), or directly with service provider server 3-95 through the internet. An example of a communication protocol plus power component capable of use with this embodiment is RS422/485 but other interface cards may be used. The door latch driver 3-75, based on instructions from the microcontroller 3-73 controls the door locking mechanism 3-76 that ultimately controls the locked/unlocked status of each door. The local PC board 3-72 is in communication with a bank of dip switches 3-77 and/or a serial number reader 3-78. The microcontroller 3-73 communicates information from the bank of dip switches 3-77 and/or a serial number reader 3-78 when communicating with the personal computer 3-92 or service provider server 3-95 in order to identify the specific local PC board 3-72.

The microcontroller 3-73 may be in communication with at least one external key pad 3-79. The external key pad 3-79 consists of a numeric pad with buttons 0-9, a ‘GET CODE’ button, a ‘UNLOCK’ button and a ‘LOCK’ button. The external key pad 3-79 may be physically attached to the scanning chamber 3-44 such as key entry pads 3-48, 3-61 as shown in FIGS. 3-8U and 3-8S but physical attachment is not a requirement. The external key pad 3-79 receives inputs from service clients, inspectors, and end users and communicates such inputs to the microcontroller 3-73.

The microcontroller 3-73 may be in communication with a scanner reader 3-81 that is capable of scanning and reading a QR code, bar code, or any machine readable code; bluetooth reader 3-82; near field communication (NFC) reader 3-83; and/or a radio frequency identification (RFID) reader 3-84. The scanner reader 3-81, bluetooth reader 3-82, near field communication (NFC) reader 3-83, and/or radio frequency identification (RFID) reader 3-84 may be physically attached to the scanning chamber 3-44 but physical attachment is not a requirement. The scanner reader 3-81, bluetooth reader 3-82, near field communication (NFC) reader 3-83, and/or radio frequency identification (RFID) reader 3-84 receive an input from service clients, inspectors, and end users, and communicates such inputs to the microcontroller 3-73. The scanner reader 3-81, bluetooth reader 3-82, near field communication (NFC) reader 3-83, and/or radio frequency identification (RFID) reader 3-84 may be used in lieu of or in conjunction with external key pad 3-79.

The microcontroller 3-73 may be in communication with an external remote lock button 3-80 located on the scanning chamber 3-44. The external remote lock button 3-80 may be accessible to the inspectors and service clients. The external remote lock button 3-80 may be a lock button such as ‘UNSECURED AREA DOOR LOCK’ button 3-56, ‘SECURED AREA DOOR LOCK’ button 3-69, and ‘HOLDING AREA DOOR LOCK’ button 3-70 as shown in FIGS. 3-8U, 3-8S.

The microcontroller 3-73 may be in communication with a primary mini screen 3-85 and secondary mini screen 3-86 that are capable of displaying messages. The primary mini screen 3-85 and secondary mini screen 3-86 may be physically attached to the scanning chamber 3-44 such as the screens 3-49, 3-54, 3-62, 3-68 as shown in FIGS. 3-8U and 3-8S but physical attachment is not a requirement. The primary mini screen 3-85 and secondary mini screen 3-86 may also be a touch screen and function as a display for messages as well as the external key pad 3-79 or as the external remote lock button 3-80.

The microcontroller 3-73 may be in communication with a document scanner reader 3-87 that is capable of scanning and saving documents such as a driver's license, badge, boarding pass, etc. The document scanner reader 3-87 may be physically attached to the scanning chamber 3-11 but physical attachment is not a requirement. The document scanner reader 3-87 may receive an input from service clients, inspectors, and end users, and communicates such inputs to the microcontroller 3-73. The document scanner reader 3-87 may be a document scanner 3-50 as disclosed in FIG. 3-8U.

The microcontroller 3-73 may be in communication with a security body scanner 3-88 and a switch related to such operation. The switch may receive an input from inspectors or end users, and communicates such inputs to the microcontroller 3-73 which in turn may operate the security body scanner 3-88 disclosed in FIGS. 3-8U and 3-8S. The switch may be a B-SCAN button 3-55 as disclosed in FIG. 3-8U.

As shown in FIG. 3-10, the electronic kits 3-90, as shown in FIG. 3-9 as 3-71, may be arranged in a network 3-89. The electronic kits 3-90, through a network 3-91, are in communication with a personal computer 3-92. The personal computer 3-92 may be in communication with a router/modem 3-93 which is in communication to the internet or an intranet 3-94 which is in communication with the service provider server 3-95. The personal computer 3-92 may also be connected to an external display monitor 3-96.

FIG. 3-25 shows the various elements of an exemplary hardware and software based implementation of the self-serve security body scanning station for persons 3-1. The implementation depicted in FIG. 3-25 is exemplary and not intended to be limiting as a variety of implementations are possible. While some elements in FIG. 3-25 are shown to comprise hardware and others software, virtually any element could be implemented in either hardware, software, or a combination thereof. Still further, it is noted that while for clarity of discussion various hardware elements are segregated between different machines and various software elements are segregated into various components, no such segregation should be deemed as required unless specifically stated herein and further or differing division into various particular components, modules, classes, objects or the like should be taken as within the scope of the present embodiment as limited only by the claims appended hereto. To the extent that any structural element (including software) is stated as being adapted to perform some function, such language is to be taken as a positive structural limitation imposed upon the referenced element whereby the element is required to be actually adapted, programed, configured or otherwise provided with the actual capability for performing the specified function. In no case shall such language be taken as merely a statement of intended use or the like, but to the contrary such language shall be in every case taken to read on all structures of the referenced element that are in any manner actually in the present tense configured to perform the specified function (as opposed to being merely capable of adaption for the conduct of the specified function). The deployment diagram of FIG. 3-25 may be locally hosted on a personal computer 3-92 as shown in FIG. 3-10 or may be remotely located and connected via an internet or intranet.

Turning then to FIG. 3-25, a service provider 3-8 is associated with one or more application servers 3-120 or database servers 3-125 upon which may be hosted software functionality necessary to operate within the framework of the embodiment. An application server 3-120 may accept inputs and deliver outputs through an authorization gateway 3-132 and user interface 3-133. The authorization inputs and outputs may be in any of a plurality of message formats such as, and not limited to, a comma or special character delimited message, an XML formatted message, a JASON formatted message, over any of a plurality of languages such as and not limited to, HTML (HTTP or HTTPS or SOAP), JavaScript, C programs, C++ programs, .NET and based on the Application Programming Interfaces (API) specification provided by the service provider 3-8. Preferably, the authorization gateway 3-132 is a unified authorization gateway. An application server 3-120 may host a request handler software component 3-121 adapted to handle authorization requests communicated through authorization gateway 3-132 and all other inputs through user interface 3-133 as well as to produce responses for authorization requests and for other inputs as may be necessary in the operation of the embodiment. Additionally, the application server 3-120 may host an authorizing agent 3-122 adapted to handle or otherwise control all aspects of the authorization process of the service provider 3-8, including receiving authorization requests, storing and/or retrieving data pertinent to the processing of such requests, and directing the validation of authorization codes submitted for authorization and respond based upon the results of such validations. In order to improve efficiency, the authorizing agent 3-122 may comprise one or more further specialized components such as, for example, a validation tool 3-123 adapted to conduct the specialized task of comparing received authorization code with known end user authorization code or end user wallet authentication code or inspector master scanner chamber authorization code. Still further, the application server 3-120 may also host an administration tool 3-124 through which various aspects of the setup, maintenance and operation of the hardware and software systems of the service provider 3-8 may be managed.

In order to efficiently manage and handle the large quantity of data that may typically be stored in connection with an implementation of the present embodiment, one or more dedicated database servers 3-125 hosting database management systems 3-126 are generally desired. As shown in FIG. 3-25, a typical database management system 3-126 may include a service client database 3-127 for storing a wide variety of generally service client centric data, a scanner chamber database 3-128 for storing a wide variety of generally scanner chamber centric data, an inspector database 3-129 for storing a wide variety of generally inspector centric data, an authorization code database 3-130 for storing a wide variety of generally authorization code centric data, and a QR code database 3-131 for storing a wide variety of generally QR code centric data. Although those of ordinary skill in the art will recognize that virtually unlimited alternatives are possible, FIG. 3-11 shows a high level generally representative schema 3-97 for a service client database 3-127, FIG. 3-12 shows a high level generally representative schema 3-98 for a scanner chamber database 3-128, FIG. 3-13 shows a high level generally representative schema 3-99 for an inspector database 3-129, FIG. 3-14 shows a high level generally representative schema 3-100 for an authorization code database 3-130, and FIG. 3-23 shows a high level generally representative schema 3-118 for QR code database 3-131, each of which will be described in greater detail further herein in connection with an exemplary description of the conduct of a typical transaction.

An exemplary user interface 3-133 may be implemented as a web interface 3-134 as shown in FIG. 3-26, comprising a page processor 3-137 hosted on an appropriate execution environment 3-136, installed on a dedicated web server 3-135, in communication 3-138 with a user device 3-139. The user device 3-139, such as a personal computer, smart phone, or tablet, has a hosted a web browser 3-141 running in a provided execution environment 3-140. As will be appreciated by those of ordinary skill in the art, the provision of a secured user interface 3-133 enables the various users, service clients 3-9, and inspectors 3-10, to maintain and/or otherwise manage the data stored in the service client database 3-127, scanner chamber database 3-128, inspector database 3-129, authorization code database 3-130, QR code database 3-131 as may be appropriate as well as to generally manage and maintain the implemented elf-serve security body scanning station for persons 3-1.

Several initial step setups must occur prior to use of the present embodiment. Each service client 3-9 should be registered with the service provider 3-8 to receive a unique facility ID and check point ID. The service provider may assign unlimited number of unique facility ids and unlimited number of unique check point ids within each facility ID so that service clients 3-9 can have unlimited number of check-points within a facility. Each service client 3-9 may populate the service client database 3-127, scanner chamber database 3-128, inspector database 3-129 using a web site or a standalone computer.

In reference to FIGS. 3-11, 3-15, 3-15L, and 3-25, each service client 3-9 may populate the service client database 3-127 using form 3-101. The service client 3-9 may use a password provided by the service provider 3-8 and maintained by the service client 3-9 to access its information in service client database 3-127. The service client 3-9 may enter facility ID, check point ID, and password into a log in form 3-101L as shown in FIG. 3-15L. If the submitted credentials are valid, then the service client 3-9 may access form 3-101, if not valid then the login process is terminated. The service client 3-9 may access this information using a user interface 3-134 in FIG. 3-26 as described supra. Using form 3-101 the service client 3-9 may enter information into appropriate fields and click on submit button or review previously inputted information. The service provider 3-8 may validate the submitted information and if the submitted information is valid then the service provider 3-8 would update the service client database 3-127, otherwise the service provider 3-8 may terminate the validation process, display an error message and wait to receive the data again. The validation process includes validation of values of each individual field namely facility name, security check-point name, contact first name, contact middle initial, contact last name, address line 1, city, state, zip, phone, extension, mobile number and password. If facility name or security check-point name or contact first name or contact last name or address line1 or city or state or zip code or phone number is blank then, the said validation process will terminate otherwise, the validation process will continue. If the state is not a valid state then, the validation process will terminate otherwise, the validation process will continue. If the city is not a valid city then, the validation process will terminate otherwise, the validation process will continue. If the zip code is not a valid zip code then, the validation process will terminate otherwise, the validation process will continue. If the phone number is not a valid phone number then, the validation process will terminate otherwise, the validation process will continue. If the extension is entered and is not valid then the validation process will terminate otherwise, the validation process will continue. If the mobile number is entered and is not valid then the validation process will terminate otherwise, the validation process will continue. If the password is entered and is not valid then the validation process will terminate otherwise, the validation process will continue. If the validation process terminates anytime during the validation process an error message will be displayed in the form 3-101 and the service provider 3-8 will wait to receive the data again. If the validation process does not terminate and the entered values of all the fields as shown in FIG. 3-15 are valid, then the service provider would update the service client database 3-127 as per the schema 3-97 shown in FIG. 3-11. If the password is blank, then the last previously set password will be taken forward.

As shown in FIG. 3-2, the service provider 3-8 may use the flow chart 3-38 as per the use case 3-2 of the present embodiment for the service client 3-9 to add/update scanning chambers. In reference to FIGS. 3-12, 3-16, 3-16L, and 3-25, each service client 3-9 may populate the scanner chamber database 3-128 using form 3-102. The service client 3-9 may use a password provided by the service provider 3-8 and maintained by the service client 3-9 to access the information in scanner chamber database 3-128. The service client 3-9 may enter facility ID, security check-point ID and password into a log in form 3-102L as shown in FIG. 3-16L. If the submitted credentials are valid then the service provider 3-8 would generally continue, populate the fields either with the values from the scanner chamber database 3-128 or populate the fields with blanks and present the form 3-102, otherwise it will terminate the process. To populate the fields in the form 3-102, the service provider 3-8 would accept a scanner chamber number from the service client 3-9 and get the most recent values for the said scanner chamber number from the scanner chamber database 3-128. If the said scanner chamber number does not exist in the said scanner chamber database 3-128 then the service provider 3-8 would populate the fields in the form with blanks.

On form 3-102, the service client 3-9 may enter the required information into appropriate fields and click on submit button. The service provider 3-8 would validate the submitted information and if the submitted information is valid then the service provider 3-8 would update the self-service security body scanner chamber database 3-128, otherwise the service provider 3-8 would terminate the validation process, display an error message and wait to receive the data again. The said validation process includes validation of values of each individual field namely scanner chamber number, status, identifier type, unsecured side identifier, secured side identifier and holding side identifier. The scanner chamber number is the self-service security body scanner chamber unique external identifier provided by service client 3-9. The unsecured side identifier is the unique internal identifier of the remotely controlled electronic door attached to the unsecured side of the self-service security body scanner chamber. The secured side identifier is the unique internal identifier of the remotely controlled electronic door attached to the secured side of the self-service security body scanner chamber. The holding side identifier is the unique internal identifier of the remotely controlled electronic door attached to the holding side of the self-service security body scanner chamber. The said unique internal identifier of any remotely controlled electronic door is the value of the dip switch settings or serial number of the microcontroller board controlling the said remotely controlled electronic door, depending on the identifier type. If the scanner chamber number is not blank and is an integer (number without decimals) then, the said validation process will continue otherwise, the validation process will terminate. If the status is Active or Inactive then, the said validation process will continue otherwise, the validation process will terminate. If the identifier type is Dip Switch or Serial Number then, the said validation process will continue otherwise, the validation process will terminate. If the unsecured side identifier is blank or an integer then, the said validation process will continue otherwise, the validation process will terminate. If the secured side identifier is blank or an integer then, the said validation process will continue otherwise, the validation process will terminate. If the holding side identifier is blank or an integer then, the said validation process will continue otherwise, the validation process will terminate. If the status is Active then, if the unsecured side identifier is an integer, secured side identifier is an integer and holding side identifier is an integer then, the said validation process will continue otherwise, the validation process will terminate.

If the same internal dip switch identifier is used by any other remotely controlled electronic door attached to any scanning chamber identified by facility ID and security check-point ID then, the validation process will terminate, otherwise it will continue. If the internal identifier type is serial number and if the same internal identifier is used by any other remotely controlled electronic door attached to any self-service security body scanner chamber within any security check-point identified by any facility ID and by any security check-point ID then, the validation process will terminate, otherwise it will continue. If the validation process terminates anytime during the validation process an error message will be displayed in the form 3-102 and the service provider 3-8 will wait to receive the data again. If the validation process does not terminate and the entered values of all the fields as shown in FIG. 3-16 are valid, then the service provider 3-8 would insert a row in the scanner chamber database 3-128 as per the schema 3-98 shown in FIG. 3-12. If scanner chamber number does not exist in the scanner chamber database 3-128 then, the value for maintenance number would be set to 1, otherwise the value for the said maintenance number would be set to the last previously set value plus 1.

As shown in FIG. 3-3, the service provider 3-8 may use the flow chart 3-39 as per the use case 3-3 of the present embodiment for the service client 3-9 to add/update inspectors 3-10. In reference to FIGS. 3-13, 3-17, 3-17L, and 3-25, each service client 3-9 may populate the inspector database 3-129 using form 3-103. The service client 3-9 may use a password provided by the service provider 3-8 and maintained by the service client 3-9 to access the information in inspector database 3-129. The service client 3-9 may enter facility ID, check point ID, and password into a log in form 3-103L as shown in FIG. 3-17L. If the submitted credentials are valid, then the service client 3-9 may access form 3-103, if not valid then the login process is terminated. The service client 3-9 may access this information using a user interface 3-134 in FIG. 3-26 as described supra. To populate the fields in form 3-103, the service provider 3-8 may accept an inspector number from the service client 3-9 and obtain the most recent data for the inspector number from the inspector database 3-129. If the inspector number does not exist, then the service provider 3-8 would populate the fields in the form 3-103 with blanks.

On form 3-103, the service client 3-9 may enter information into appropriate fields and click on submit button. The service provider 3-8 may validate the submitted information and if the submitted information is valid then the service provider 3-8 would update the inspector database 3-129, otherwise the service provider 3-8 may terminate the validation process, display an error message and wait to receive the data again. The said validation process includes validation of values of each individual field namely inspector ID, status, first name, middle name, last name, email address, master authorization code, mobile number and password. The inspector ID is a unique number provided by service client 3-9 to each individual inspector. If the inspector ID is not blank and is an integer then, the said validation process will continue otherwise, the validation process will terminate. If the status is Active or Inactive then, the said validation process will continue otherwise, the validation process will terminate. If the contact first name or contact last name or email address or master authorization code is blank, then the validation process will terminate otherwise it will continue. If email address is a valid email address, then the process will continue otherwise it will terminate. If mobile number is blank or valid mobile number then the process will continue, otherwise it will terminate. If mobile number is not blank and the same mobile number is used for more than one inspector within a security check-point identified by facility ID and security check-point ID then the process will terminate, otherwise it will continue. If the validation process terminates anytime during the validation process an error message will be displayed in the form 3-103 and the service provider 3-8 will wait to receive the data again. If the validation process does not terminate and the entered values of all the fields as shown in FIG. 3-17 are valid, then the service provider 3-8 would update the inspector database 3-129 as per the schema 3-99 as shown in FIG. 3-13. If inspector ID does not exist in the inspector database 3-129 then, the inspector information will be added in the database 3-130 otherwise, the inspector information will be updated in the inspector database 3-129. If the password is blank, then the last previously set password will be taken forward.

As shown in FIG. 3-4, the service provider 3-8 may use the flow chart 3-40 as per the use case 3-4 of the present embodiment for the inspectors 3-10 to update inspector's profile. In reference to FIGS. 3-18 and 3-18L each inspector 3-10 may update its profile using form 3-104. The inspector 3-10 may use a password provided by the service client 3-9. The inspector 3-10 may enter facility ID, check point ID, inspector ID, and password into a log in form 3-104L as shown in FIG. 3-18L. If the submitted credentials are valid, then the inspector 3-10 may access form 3-104, if not valid then the login process is terminated. The inspector 3-10 may access this information using a user interface 3-134 in FIG. 3-26 as described supra.

On form 3-104, the inspector 3-10 may enter information into appropriate fields and click on submit button. The service provider 3-8 may validate the submitted information and if the submitted information is valid then the service provider 3-8 would update the inspector database 3-129, otherwise the service provider 3-8 may terminate the validation process, display an error message and wait to receive the data again. The validation process includes validation of values of each individual field namely master authorization code and password. The inspector ID is a unique number provided by service client 3-9 to each individual inspector. If the master authorization code is not blank and an integer and the same master authorization code is not currently being used by any other inspector within the said facility ID and security check-point ID, then the validation process will continue, otherwise it will terminate. If the validation process terminates anytime during the validation process an error message will be displayed in the form 3-104 and the service provider 3-8 will wait to receive the data again. If the validation process does not terminate and the entered values of all the fields as shown in FIG. 3-18 are valid, then the service provider 3-8 would update the inspector database 3-129 as per the schema 3-99 as shown in FIG. 3-13. If the password is blank, then the last previously set password will be taken forward.

As shown in FIG. 3-22, the service provider 3-8 may use the flow chart 3-117 as per the use case 3-5 of the present embodiment to add/update QR Codes. In reference to FIGS. 3-24 and 3-24L each inspector 3-10 may request a QR code using form 3-119. The inspector 3-10 may use a password provided by the service client 3-9. The inspector 3-10 may enter facility ID, check point ID, inspector ID, and password into a log in form 3-119L as shown in FIG. 3-24L. If the submitted credentials are valid, then the inspector 3-10 may access form 3-119, if not valid then the login process is terminated. The inspector 3-10 may access this information using a user interface 3-134 in FIG. 3-26 as described supra.

Once the form 3-119 is presented, the inspector 3-10 may enter the required information into appropriate fields and click on ‘Create QR Code’ button. The service provider 3-8 would validate the submitted information and if the submitted information is valid then the service provider 3-8 would update the QR Code database 3-131 with a new random number, otherwise the service provider 3-8 would terminate the validation process, display an error message and wait to receive the data again. The said validation process includes validation of values of each individual field namely scanner chamber number, and side of the door. The scanner chamber number is a unique external identifier number assigned by service client 3-9 to each security body scanner chamber and the side of the door is the side to which the door is attached to the security body scanner chamber. If the scanner chamber number and the side of the door are valid, then the validation process will continue, otherwise the validation process will terminate. If the validation process terminates anytime during the validation process an error message will be displayed in the form 3-119 and the service provider 3-8 will wait to receive the data again. If the validation process does not terminate and the entered values of all the fields as shown in FIG. 3-24 are valid, then the service provider 3-8 would create a new unique random number and update the QR Code database 3-131 as per the schema 3-118 as shown in FIG. 3-23. If no row exists in the qr code database 3-131 based on the entered values, then the value for Maintenance Number in the new row will be set to 1, otherwise the Maintenance Number will be incremented by 1 from the last inserted row. Once a new row with a new maintenance number is inserted any QR Code displayed for the said scanner chamber number and for the said side of the door will not be valid any more. The inspectors 3-10 then need to print new QR Code and post them on the selected door of the selected scanner chamber.

The service provider 3-8 uses several programmatically executable procedures loaded into the microcontroller 3-73, the personal computer 3-92 and the application server 3-120 which are executed based on end users' 3-12 and inspectors' 3-10 request.

Upon successful completion of initial set up by service provider 3-8, service client 3-9, and inspectors 3-10, the service client 3-9 may proceed using the scanning chamber in accordance with the present embodiment.

The method of a self-serve security body scanning station 3-1 is generally described in reference to FIGS. 3-1, 3-5, 3-6, 3-7, 3-8U, 3-8S, 3-9, 3-19L, 3-19, 3-20U, 3-20S, 3-20H, 3-21, 3-22, 3-23, and 3-24 in an exemplary embodiment for use.

Continuing then with the example generally described with respect to FIG. 3-25, further details of the implementation are now described by way of the following detailed description of a possible use of the implementation for admitting end users from unsecured area to secured area through a security check-point, which, for purposes of the example, shall be taken being conducted at an airport security check-point.

End users 3-12 and inspectors 3-10 submit requests in the following order to enter into secured area from unsecured area through a security check-point:

(1) Inspectors 3-10 maintain available self-service security body scanner chambers which are displayed on a display monitor as shown in FIG. 3-20U. To add a self-service security body scanner chamber, the inspectors 3-10 would verify that a self-service security body scanner chamber is empty, press ‘UNSECURED AREA DOOR LOCK’ button 3-56, press ‘SECURED AREA DOOR LOCK’ button 3-69 and then finally press ‘HOLDING AREA DOOR LOCK’ button 3-70. Pressing ‘UNSECURED AREA DOOR LOCK’ button 3-56 would execute the procedure ‘Unsecured Lock’. Pressing ‘SECURED AREA DOOR LOCK’ button 3-69 would execute the procedure ‘Secured Lock’. Pressing ‘HOLDING AREA DOOR LOCK’ button 3-70 would execute the procedure ‘Holding Lock’. End-Users 3-12 would follow the instructions 3-106 as shown in FIG. 3-20U to pass through the body scanner chamber from unsecured area to secured area.

(2) End-Users 3-12 would access the door of one of the available security body scanner chamber from unsecured area and upload self-identification documents through ‘Document Scanner Reader’. This would execute the procedure ‘End-Users Self Identification’. Response message received in the response would be displayed in the ‘Message Display’ screen.

(3) End-Users 3-12 get a one-time authorization code to unlock the said door by scanning ‘QR Code’ using a mobile wallet or by entering a mobile number in the ‘Key Pad’ and by pressing the ‘GET CODE’ button. This would execute the procedure ‘Get Code with QR Code or Mobile Number’. If the request was submitted by scanning the ‘QR Code’ using a mobile wallet, then a one-time authorization code and/or a response message will be displayed in the said wallet app. If the request was submitted by entering a mobile number in the ‘Key Pad’ then a one-time authorization code will be sent to the said mobile device, and/or a response message received in the response would be displayed in the ‘Message Display’ screen.

(4) End-Users 3-12 unlock the said door by entering a one-time authorization code in the ‘Key Pad’ and by pressing ‘UNLOCK’ button. This would execute the procedure ‘Unlock Door’. The said door namely, ‘Door’ of the body scanner chamber facing unsecured area would be unlocked and/or a response message received in the response would be displayed in the ‘Message Display’ screen.

(5) End-Users 3-12, upon successfully opening the said door, would enter into the said security body scanner chamber, close the said door and lock the door by pressing ‘LOCK’ button from inside of the said security body scanner chamber. This would execute the procedure ‘Lock Door’. The said door namely, ‘Door’ of the body scanner chamber facing unsecured area would be locked and/or a response message received in the response would be displayed in the ‘Message Display’ screen displayed in the inside of the said security body scanner chamber.

(6) End-Users 3-12 can do a self-service security body scan by pressing ‘B-SCAN’ button displayed in the inside wall of the unsecured area door of the said security body chamber, if ‘B-SCAN’ button is accessible to End-Users. Alternatively, Inspectors 3-10 can also do a security body scan by pressing ‘B-SCAN’ button remotely. This would execute the procedure ‘Security Body Scan’. Response message received in the response would be displayed in the ‘Display Message’ screen displayed in the inside wall of the unsecured area door of the said security body scanner chamber or in a ‘Display Message’ screen visible to Inspectors 3-10.

(7) Inspectors 3-10 verify identification documents, verify body scanned images and authorize or deny entry of end users 3-12 into secured area by using the form provided by the security provider 3-8 as shown in FIG. 3-19. This form would execute the procedure ‘Approve/Deny Secured Area Entry’.

(8) To enter into secured area from security body scanner chamber, end users 3-12 would follow the instructions given on inside wall of the secured area door as shown in FIG. 3-20S. End-Users 3-12 get a one-time authorization code to unlock a door of the said security body scanner chamber facing secured area by scanning a ‘QR Code’ using a mobile wallet or by entering a mobile number in the ‘Key Pad’ and by pressing the ‘GET CODE’ button. This would execute the procedure ‘Get Code with QR Code or Mobile Number’. If the request was submitted by scanning the QR Code using a mobile wallet, then a one-time authorization code and/or a response message will be displayed in the said wallet app. If the request was submitted by entering a mobile number in the ‘Key Pad’ then a one-time authorization code will be sent to the said mobile device and/or a response message received in the response would be displayed in the ‘Message Display’ screen displayed in the inside wall of the secured area door of the said security body scanner chamber.

(9) End-Users 3-12 could unlock the said door of the said security body scanner chamber facing secured area by entering a one-time authorization code in the ‘Key Pad’ and by pressing ‘UNLOCK’ button. This would execute the procedure ‘Unlock Door’. The said door, secured side door of the body scanner chamber would be unlocked and/or a response message received in the response would be displayed in the ‘Message Display’ screen displayed in the inside wall of secured side door of the said security body scanner chamber. If the said door is unlocked, then the end user 3-12 could exit the said security body scanner chamber and enter into secured area.

(10) If the said door, namely secured side door of the body scanner chamber cannot be unlocked by the end user 3-12 then, the end user 3-12 can unlock the holding area door of the said security body scanner chamber by following the instructions given on inside wall of the holding area door as shown in FIG. 3-20H. Pressing ‘UNLOCK’ button displayed in the inside wall of the holding area door of the said security body scanner chamber would execute the procedure ‘Unlock Door’. he said door, namely holding area door of the said security body scanner chamber would be unlocked and/or a response message received in the response would be displayed in the ‘Message Display’ screen displayed in the inside wall of the holding area of the said security body scanner chamber. If the said door is unlocked, then the end user 3-12 could exit the said security body scanner chamber and enter into holding area.

Following are details of programmatically executable procedures used by service provider 3-8 and loaded into the microcontroller 3-73, the personal computer 3-92 and the application server 3-120:

Unsecured Lock:

To enable the end user 3-12 to enter into secured area from unsecured area using a security body scanner chamber, the service provider would display a list of available security body scanner chambers on a monitor, which would be conspicuously visible to end users, as shown in FIG. 3-5. To add a security body scanner chamber to the list of available security body scanner chambers, the inspectors 3-10 would select security body scanner chambers that are empty with secured side doors unlocked and/or unsecured side doors unlocked and/or holding side doors unlocked. Then the said inspectors 3-10 would lock all the doors facing the unsecured area by pressing ‘UNSECURED AREA DOOR LOCK’ button 3-56 as shown in FIGS. 3-8U and 3-8SU, all the doors facing the secured area by pressing ‘SECURED AREA DOOR LOCK’ button 3-69 as shown in FIGS. 3-8U and 3-8SS and all the doors facing the holding area by pressing ‘HOLDING AREA DOOR LOCK’ button 3-70 as shown in FIGS. 3-8U and 3-8SS. All security body scanner chambers where the latest row in Security Body Scanner Chamber Authorization Code database have the value for the field Inspector_Unsecured_Locked_YN is ‘Y’, the value for the field Inspector_Secured_Locked_YN is ‘Y’, the value for the field Inspector_Holding_Locked_YN is ‘Y’, and the value for the field Document1_Scanned_YN_is ‘N’ will be added into Available Security Body Scanner Chambers list.

When the said inspectors 3-10 press the button ‘UNSECURED AREA DOOR LOCK’ the microcontroller would format a request message which consists of command which is ‘UNSECURED AREA DOOR LOCK’, dip switch 3-77 settings and/or serial number 3-78. Then the microcontroller 3-73 would forward the request message to the personal computer 3-92 through the network 3-91. Then the personal computer 3-92 would add check-point specific information like facility ID and security check-point ID to the request message and forward the said request message to the service provider 3-8 through the authorization gateway 3-132 as shown in FIG. 3-25. The service provider 3-8 would verify the request message and send a response back to the personal computer 3-92, which would send the response back to the microcontroller through the network 3-91.

The service provider 3-8, in order to process the request message, would forward the request message to the request handler 3-121 to handle the request. The request handler 3-121 then verify the location information in the request message namely the facility ID and the check-point ID. If the facility ID and the check-point ID exists in the service client database 3-127 and if the current status is active then the request handler would forward the request message to authorizing agent 3-122, otherwise the verification process would terminate with response type ‘DENY’ and response message ‘Invalid Location’. The authorizing agent would verify the microcontroller information in the request message namely the dip switch settings 3-77 and/or serial number 3-78 using the scanner chamber database 3-128. If the value for the field Identifier_Type in scanner chamber database 3-128 as shown in FIG. 3-12 is ‘D’, then the authorizing agent would locate the scanner chamber number and the side of the door using the dip switch settings, otherwise the authorizing agent would locate the scanner chamber number and the side of the door using the serial number. If the authorizing agent could locate the scanner chamber number and the side of the door then the authorizing agent would add the scanner chamber number and the side of the door to the request message and forward the said request message to the validation tool, otherwise the verification process would terminate with response type ‘DENY’ and response message ‘Invalid box and/or door’. If the side of the door is not ‘Unsecured’ then the verification process would terminate with response type ‘DENY’ and response message ‘Invalid door’. If the verification is not terminated, a new row will be inserted into authorization code database 3-130. If no row exists in the authorization code database 3-130 then the value for Transaction Number in the new row will be set to 1, otherwise the Transaction Number will be incremented by 1 from the last inserted row. The values of facility ID, check-point ID and scanner chamber number will be used to populate the fields Facility_Id, Check_Point_Id, and Security_Body_Scanner_Chamber_Number fields respectively. All the fields that have field names ending with ‘_YN’, except the fields Inspector_Unsecured_Locked_YN and XRary_Scanner_Approved_YN, would be populated with the value ‘N’. The field Inspector_Unsecured_Locked_YN will be populated with ‘Y’. The field XRary_Scanner_Approved_YN will be populated with a blank. All the other fields would be populated with blank values.

If the verification is not terminated, then the verification process would terminate, with response type ‘APPROVE’. The response will be sent back to the microcontroller 3-73. If the microcontroller 3-73 receives a response with response type ‘APPROVE’ then the microcontroller 3-73 would lock the door 3-111 as shown in FIG. 3-21.

Secured Lock:

When inspectors 3-10 press the button ‘SECURED AREA DOOR LOCK’ the microcontroller would format a request message which consists of command which is ‘SECURED AREA DOOR LOCK’, dip switch 3-77 settings and/or serial number 3-78. Then the microcontroller 3-73 would forward the request message to the personal computer 3-92 through the network 3-91. Then the personal computer 3-92 would add check-point specific information like facility ID and security check-point ID to the request message and forward the said request message to the service provider 3-8 through the authorization gateway 3-132 as shown in FIG. 3-25. The service provider 3-8 would verify the request message and send a response back to the personal computer 3-92, which would send the response back to the microcontroller through the network 3-91.

The service provider 3-8, in order to process the request message, would forward the request message to the request handler 3-121 to handle the request. The request handler 3-121 then verify the location information in the request message namely the facility ID and the check-point ID. If the facility ID and the check-point ID exists in the service client database 3-127 and if the current status is active then the request handler would forward the request message to authorizing agent 3-122, otherwise the verification process would terminate with response type ‘DENY’ and response message ‘Invalid Location’. The authorizing agent would verify the microcontroller information in the request message namely the dip switch settings 3-77 and/or serial number 3-78 using the scanner chamber database 3-128. If the value for the field Identifier_Type in scanner chamber database 3-128 as shown in FIG. 3-12 is ‘D’, then the authorizing agent would locate the scanner chamber number and the side of the door using the dip switch settings, otherwise the authorizing agent would locate the box number and the side of the door using the serial number. If the authorizing agent could locate the scanner chamber number and the side of the door then the authorizing agent would add the scanner chamber number and the side of the door to the request message and forward the said request message to the validation tool, otherwise the verification process would terminate with response type ‘DENY’ and response message ‘Invalid box and/or door’. If the side of the door is not ‘Secured’ then the verification process would terminate with response type ‘DENY’ and response message ‘Invalid door’.

If the verification process is not terminated, the validation tool, using the facility ID, check-point ID and scanner chamber number from the request message, would get the latest row from the authorization code database 3-130. If the value of the field Inspector_Unsecured_Locked_YN is equal to ‘Y’ and Inspector_Secured_Locked_YN is equal to ‘N’ then the service provider 3-8 will update the field Inspector_Secured_Locked_YN to ‘Y’ and the verification process would terminate with the response type ‘APPROVE’, otherwise the verification process would terminate with response type ‘DENY’ and response message ‘Invalid door’.

The response will be sent back to the microcontroller 3-73. If the microcontroller 3-73 receives a response with response type ‘APPROVE’ then the microcontroller 3-73 would lock the door 3-113.

Holding Lock:

When inspectors 3-10 press the button ‘HOLDING AREA DOOR LOCK’ the microcontroller would format a request message which consists of command which is ‘HOLDING AREA DOOR LOCK’, dip switch 3-77 settings and/or serial number 3-78. Then the microcontroller 3-73 would forward the request message to the personal computer 3-92 through the network 3-91. Then the personal computer 3-92 would add check-point specific information like facility ID and security check-point ID to the request message and forward the said request message to the service provider 3-8 through the authorization gateway 3-132 as shown in FIG. 3-25. The service provider 3-8 would verify the request message and send a response back to the personal computer 3-92, which would send the response back to the microcontroller through the network 3-91.

The service provider 3-8, in order to process the request message, would forward the request message to the request handler 3-121 to handle the request. The request handler 3-121 then verify the location information in the request message namely the facility ID and the check-point ID. If the facility ID and the check-point ID exists in the service client database 3-127 and if the current status is active then the request handler would forward the request message to authorizing agent 3-122, otherwise the verification process would terminate with response type ‘DENY’ and response message ‘Invalid Location’. The authorizing agent would verify the microcontroller information in the request message namely the dip switch settings 3-77 and/or serial number 3-78 using the scanner chamber database 3-128. If the value for the field Identifier_Type in scanner chamber database 3-128 as shown in FIG. 3-12 is ‘D’, then the authorizing agent would locate the scanner chamber number and the side of the door using the dip switch settings, otherwise the authorizing agent would locate the box number and the side of the door using the serial number. If the authorizing agent could locate the scanner chamber number and the side of the door then the authorizing agent would add the scanner chamber number and the side of the door to the request message and forward the said request message to the validation tool, otherwise the verification process would terminate with response type ‘DENY’ and response message ‘Invalid box and/or door’. If the side of the door is not ‘Holding’ then the verification process would terminate with response type ‘DENY’ and response message ‘Invalid door’.

If the verification process is not terminated, the validation tool, using the facility ID, check-point ID and scanner chamber number from the request message, would get the latest row from the authorization code database 3-130. If the value of the field Inspector_Unsecured_Locked_YN is equal to ‘Y’ and Inspector_Secured_Locked_YN is equal to ‘Y’ and Inspector_Holding_Locked_YN is equal to ‘N’ then the service provider 3-8 will update the field Inspector_Holding_Locked_YN to ‘Y’ and the verification process would terminate with the response type ‘APPROVE’, otherwise the verification process would terminate with response type ‘DENY’ and response message ‘Invalid door’.

The response will be sent back to the microcontroller 3-73. If the microcontroller 3-73 receives a response with response type ‘APPROVE’ then the microcontroller 3-73 would lock the door 3-112.

End-User Self-Identification:

Once the end user 3-12 selects a security body scanner chamber, from the list of available self-service security body scanner chambers displayed on the display monitor, to pass through security check-point from unsecured area to secured area, the end user 3-12 would access the selected security body scanner chamber in the unsecured area. The scanner number would be displayed on each security body scanner chamber as shown in FIG. 3-20U so that the end users 3-12 could access the desired security body scanner chamber. Once accessed the desired security body scanner chamber in unsecured area, the end users 3-12 can pass through the said security body scanner chamber into secured area by following the instructions posted as shown in FIG. 3-20U. To enter into the said security body scanner chamber, the end users 3-12 need to identify themselves to the said security body scanner chamber and unlock the said security body scanner chamber.

To identify themselves the end users 3-12 would insert approved security documents like driver's license, airline boarding pass, badge and the like into the document scanner reader 3-50 and press the ‘D-SCAN’ button. If more than one approved security document is required to complete the identification process, then the end users 3-12 would scan one document at a time. When ‘D-SCAN’ button is pressed the microcontroller 3-73 would verify that a document has been inserted into the document scanner reader 3-50. If a document is inserted then the process will continue, otherwise it will terminate with a text ‘Insert Document’ displayed on the mini screen 3-49. If the process continues, the document scanner reader 3-50 would capture the image of the document and any text encoded in the document. The scanner part of the document scanner reader 3-50 would capture the image of the document and the reader part of the document scanner reader 3-50 would read the encoded text (for example encoded in a magnetic stripe), if any, in the document. Then the microcontroller would format a request message which consists of document image, encoded text, command which is ‘B-SCAN’, dip switch 3-77 settings and/or serial number 3-78. Then the microcontroller 3-73 would forward the request message to the personal computer 3-92 through the network 3-91. Then the personal computer 3-92 would add security check-point specific information like facility ID and security check-point ID to the request message and forward the said request message to the service provider 3-8 through the authorization gateway 3-132 as shown in FIG. 3-25. The service provider 3-8 would verify the request message and send a response back to the personal computer 3-92, which would send the response back to the microcontroller through the network 3-91.

The service provider 3-8, in order to process the request message, would forward the request message to the request handler 3-121 to handle the request. The request handler 3-121 then verify the location information in the request message namely the facility ID and the check-point ID. If the facility ID and the check-point ID exists in the service client database 3-127 and if the current status is active then the request handler would forward the request message to authorizing agent 3-122, otherwise the verification process would terminate with response type ‘DENY’ and response message ‘Invalid Location’. The authorizing agent would verify the microcontroller information in the request message namely the dip switch settings 3-77 and/or serial number 3-78 using the body scanner chamber database 3-128. If the value for the field Identifier_Type in scanner chamber database 3-128 as shown in FIG. 3-12 is ‘D’, then the authorizing agent would locate the body scanner chamber number and the side of the door using the dip switch settings, otherwise the authorizing agent would locate the body scanner chamber number and the side of the door using the serial number. If the authorizing agent could locate the body scanner chamber number and the side of the door then the authorizing agent would add the body scanner chamber number and the side of the door to the request message and forward the said request message to the validation tool 3-123, otherwise the verification process would terminate with response type ‘DENY’ and response message ‘Invalid body scanner chamber and/or door’. If the side of the door is not ‘Unsecured’ then the verification process would terminate with response type ‘DENY’ and response message ‘Invalid door’. The validation tool, using the facility ID, check-point ID and body scanner chamber number from the request message, would get the latest row from the authorization code database 3-130. If Inspector_Unsecured_Locked_YN equal to ‘Y’, Inspector_Secured_Locked_YN equal to ‘Y’ and Inspector_Holding_Locked_YN equal to ‘Y’ then validation process will continue, otherwise it will terminate with response type ‘DENY’ and response message ‘Invalid door’. If Document1_Scanned_YN not equal to ‘Y’ then, the service provider 3-8 would update the latest row by setting the value for the fields Document1_Scanned_YN to ‘Y’, Dorument1_Scanner_DateTime to current date and time, Document1_Scanned_Image to the document image in the request message and Document1_Read_Text to the document text in the request message, otherwise, if Document2_Scanned_YN not equal to ‘Y’ then, the service provider 3-8 would update the latest row by setting the value for the fields Document2_Scanned_YN to ‘Y’, Dorument2_Scanner_DateTime to current date and time, Document2_Scanned_Image to the document image in the request message and Document2_Read_Text to the document text in the request message, otherwise, verification process would terminate with response type ‘DENY’ and with response message ‘Cannot scan more than twice’. If the verification process is not terminated, then the service provider 3-8 would terminate with response type ‘APPROVE’ and with response message ‘D-Scanned’.

Get Code with QR Code or Mobile Number:

To unlock unsecured side door or secured side door of the body scanner chamber, the end users 3-12 would need a one-time security authorization code. The end users 3-12 can either scan the QR Code 3-51 or 3-63 using a mobile wallet or enter their mobile number in the key pad 3-48 or 3-61 and press the ‘GET CODE’ button to get a one-time authorization code.

If the end users 3-12 scanned the QR Code 3-51 or 3-63 using a mobile wallet, then the mobile wallet would read the content of the QR Code to start the mobile wallet process and provide a one-time authorization code or issue an error message. The content of the QR Code would be facility ID, check-point ID, body scanner chamber number, dip switch 3-77 settings and/or serial number 3-68, the text ‘GET CODE’ and a service provider 3-8 provided random number generated each time the QR Code is replaced. Inspectors 3-10 can replace the QR Code as often as required. The mobile wallet would restrict the end users 3-12 only to scan the QR Code and not be manually entered using key board. The mobile wallet process would determine whether the QR Code was scanned or the content of the QR Code was manually entered. If the QR Code was not scanned then, the mobile wallet process will terminate with appropriate error message. If the mobile wallet process is not terminated, then the mobile wallet process would compare the GPS location information from the mobile device and the GPS location based on the facility ID and the check-point ID. If they are not equal, then the mobile wallet process will terminate with an appropriate error message. If the mobile wallet process is not terminated, then the mobile wallet would verify the random number included in the QR Code with the service provider 3-8 using an Application Programming Interface provided by the service provider 3-8. If the verification fails, then the mobile wallet process will terminate with an appropriate error message. If the mobile wallet process is not terminated, then the mobile wallet process would authenticate the mobile wallet user including biometric authentication. If the authentication fails, then the mobile wallet process will terminate with an appropriate error message. If the mobile wallet process is not terminated, then the mobile wallet process would format a request message which consists of mobile number, request type which is ‘GET CODE’, input type which is ‘QR Code’, facility ID, check-point ID and dip switch 3-77 settings and/or serial number 3-78. The mobile wallet process would send the request message to the service provider 3-8 through the authorization gateway 3-132 as shown in FIGS. 3-25 and receive a response with response type and response message. The mobile wallet would display the response in the mobile device. If the request is processed successfully then the response message would include the one-time authorization code.

On the other hand, if the end users 3-12 entered their mobile number in the key pad 3-48 or 3-61 and pressed the ‘GET CODE’ button, then the microcontroller 3-73 would format a request message which consists of mobile number, command which is ‘GET CODE’, dip switch 3-77 settings and/or serial number 3-78. Then the microcontroller 3-73 would forward the request message to the personal computer 3-92 through the network 3-91. Then the personal computer 3-92 would add check-point specific information like facility ID and security check-point ID to the request message and forward the said request message to the service provider 3-8 through the authorization gateway 3-132 as shown in FIGS. 3-25 and receive a response with response type and response message. The personal computer 3-92, would send the response back to the microcontroller 3-73 through the network 3-91.

The service provider 3-8, in order to process the request message, would forward the request message to the request handler 3-121 to handle the request. The request handler 3-121 then verify the location information in the request message namely the facility ID and the check-point ID. If the facility ID and the check-point ID exists in the service client database 3-127 and if the current status is active then the request handler would forward the request to authorizing agent 3-122, otherwise the verification process would terminate with response type ‘DENY’ and response message ‘Invalid Location’. The authorizing agent would verify the microcontroller information in the request message namely the dip switch settings 3-77 and/or serial number 3-78 using the body scanner chamber database 3-128. If the value for the field Identifier_Type in body scanner chamber database 3-128 as shown in FIG. 3-12 is ‘D’, then the authorizing agent would locate the body scanner chamber number and the side of the door using the dip switch settings 3-77, otherwise the authorizing agent would locate the scanner chamber number and the side of the door using the serial number 3-78. If the authorizing agent could locate the body scanner chamber number and the side of the door then the authorizing agent would add the body scanner chamber number and the side of the door to the request message and forward the said request message to the validation tool 3-123, otherwise the verification process would terminate with response type ‘DENY’ and response message ‘Invalid body scanner chamber and/or door’.

The validation tool, using the facility ID, check-point ID and body scanner chamber number from the request message, would get the latest row from the authorization code database 3-130. If Document1_Scanned_YN_is equal to ‘Y’ then, verification process would continue, otherwise verification process would terminate with response type ‘DENY’ and with response message ‘Document Scanning is required’.

If the format of the mobile number in the request message is valid then the verification process will continue, otherwise the verification process will terminate with response type ‘DENY’ and response message ‘Invalid mobile number’. If Mobile Number is blank or equal to the mobile number in the request message, then the verification process would continue, otherwise the verification process would terminate with response type ‘DENY’ and response message ‘Invalid mobile number’.

If the side of the door in the request message is ‘unsecured’ or if the side of the door in the request message is ‘secured’ then the verification process would continue, otherwise it would terminate, with response type ‘DENY’ and response message ‘Invalid side’. If the side of the door in the request message is ‘unsecured’ and if UnSecured_Unlocked_YN equal to ‘Y’ then the verification process would terminate, with response type ‘DENY’ and response message ‘Invalid side’. If the side of the door in the request message is ‘secured’ and if Secured_Unlocked_YN equal to ‘Y’ then the verification process would terminate, with response type ‘DENY’ and response message ‘Invalid side’. If the side of the door in the request message is ‘secured’ and if Body_Scanner_Verified_YN equal to ‘N’ then the verification process would terminate, with response type ‘DENY’ and response message ‘Waiting for Approval’. If the side of the door in the request message is ‘secured’ and if Body_Scanner_Approved_YN equal to ‘N’ then the verification process would terminate, with response type ‘DENY’ and response message ‘Exit through Holding Area’.

If the verification process is not terminated, then the service provider 3-8 would create a random number, may be, between 6 and 8 digits and is not same as any inspector's master authorization code. If the verification process is not terminated, then the service provider 3-8 would update the latest row in authorization code database 3-130 based on the facility ID, check-point ID and body scanner chamber number from the request message and by populating field Mobile Number with mobile number in the request message.

If the verification process is not terminated and if Unsecured_Unlocked_YN equal to ‘N’, then the service provider 3-8 would update the latest row in authorization code database 3-131 based on the facility ID, check-point ID and body scanner chamber number from the request message and by populating field UnSecured_Unlock_Authcode with said random number and by populating UnSecured_Unlock_Authcode_DateTime with current date and time.

If the verification process is not terminated and if Unsecured_Unlocked_YN equal to ‘Y’ and Unsecured_Locked_YN equal to ‘Y’ and Secured_Unlocked_YN equal to ‘N’, then the service provider 3-8 would update the latest row in authorization code database 3-130 based on the facility ID, check-point ID and scanner chamber number from the request message and by populating field Secured_Unlock_Authcode with said random number and by populating Secured_Unlock_Authcode_DateTime with current date and time.

If input type exists in the request message and is ‘QR CODE’ and if the verification process is not terminated the service provider 3-8 would terminate the verification process with response type ‘APPROVE’ and response message populated with the said random number, otherwise if the verification process is not terminated the service provider 3-8 would send the said random number to the mobile number received in the request message and would terminate the verification process with response type ‘APPROVE’ and with response message ‘Code Sent’.

If input type exists in the request message and is ‘QR CODE’ then, the response will be sent back to the mobile wallet process otherwise, the response will be sent back to the microcontroller 3-73 and the microcontroller 3-73 would display the response message received in the response, in the mini screen 3-49 or 3-62.

Unlock Door:

To unlock any door facing unsecured area, the end users 3-12 need to enter a one-time authorization code in the key pad 3-48 and press the ‘UNLOCK’ button. To unlock any door facing secured area, the end users 3-12 need to enter a one-time authorization code in the key pad 3-61 and press the ‘UNLOCK’ button. To unlock any door facing holding area, the end users 3-12 need to press ‘UNLOCK’ button 3-67.

When ‘UNLOCK’ button is pressed, the microcontroller 3-73 would format a request message which consists of one-time authorization code, command which is ‘UNLOCK’, dip switch 3-77 settings and/or serial number 3-78. If ‘UNLOCK’ button 3-67 (from holding area door) is pressed, then the one-time authorization code could be blank. Then the microcontroller 3-73 would forward the request message to the personal computer 3-92 through the network 3-91. Then the personal computer 3-92 would add check-point specific information like facility ID and security check-point ID to the request message and forward the said request message to the service provider 3-8 through the authorization gateway 3-132 as shown in FIGS. 3-25 and receive a response with response type and response message. The personal computer 3-92, would send the response back to the microcontroller 3-73 through the network 3-91.

The service provider 3-8, in order to process the request message, would forward the request message to the request handler 3-121 to handle the request. The request handler 3-121 then verify the location information in the request message namely the facility ID and the check-point ID. If the facility ID and the check-point ID exists in the service client database 3-127 and if the current status is active then the request handler would forward the request message to authorizing agent 3-122, otherwise the verification process would terminate with response type ‘DENY’ and response message ‘Invalid Location’. The authorizing agent would verify the microcontroller information in the request message namely the dip switch settings 3-77 and/or serial number 3-78 using the body scanner chamber database 3-128. If the value for the field Identifier_Type in body scanner chamber database 3-128 as shown in FIG. 3-12 is ‘D’, then the authorizing agent would locate the body scanner chamber number and the side of the door using the dip switch settings, otherwise the authorizing agent would locate the body scanner chamber number and the side of the door using the serial number. If the authorizing agent could locate the body scanner chamber number and the side of the door then the authorizing agent would add the body scanner chamber number and the side of the door (secured or unsecured or holding) to the request message and forward the said request message to the validation tool 3-123, otherwise the verification process would terminate with response type ‘DENY’ and response message ‘Invalid scanner chamber and/or door’.

The validation tool, using the facility ID, check-point ID and scanner chamber number from the request message, would get the latest row from the authorization code database 3-130.

If Document1_Scanned_YN_is equal to ‘Y’ then, verification process would continue, otherwise verification process would terminate with response type ‘DENY’ and with response message ‘Document Scanning is required’.

If the side of the door in the request message is ‘unsecured’ and if UnSecured_Unlocked_YN equal to ‘Y’, then the verification process would terminate, with response type ‘DENY’ and response message ‘Invalid request’.

If the side of the door in the request message is ‘secured’ or ‘holding’ and if UnSecured_Unlocked_YN equal to ‘Y’ and UnSecured_Locked_YN equal to ‘Y’, then the verification process would continue, otherwise the verification process would terminate with response type ‘DENY’ and response message ‘Invalid request’.

If the side of the door in the request message is ‘secured’ or ‘holding’ and if UnSecured_Unlocked_YN equal to ‘Y’, UnSecured_Locked_YN equal to ‘Y’ and Body_Scanner_Verified_YN not equal to ‘Y’, the verification process would terminate with response type ‘DENY’ and response message ‘Waiting for Approval’.

If the verification process continues and the side of the door in the request message is ‘unsecured’ and any inspector's master authorization code is equal to authorization code in the request message, then the verification process would terminate, with response type ‘APPROVE’ and response message ‘Unlocked’.

If the verification process continues and the side of the door in the request message is ‘secured’ and any inspector's master authorization code is equal to authorization code in the request message, then the verification process would terminate, with response type ‘APPROVE’ and response message ‘Unlocked’.

If the side of the door in the request message is ‘holding’ and if UnSecured_Unlocked_YN equal to ‘Y’, UnSecured_Locked_YN equal to ‘Y’, Body_Scanner_Verified_YN equal to ‘Y’ and Body_Scanner_Approved_YN not equal to ‘Y’, the verification process would terminate with response type ‘APPROVE’ and response message ‘Unlocked’.

If the side of the door in the request message is ‘holding’, the verification process would terminate with response type ‘DENY’ and response message ‘Invalid Door’.

If the side of the door in the request message is ‘secured’ and if UnSecured_Unlocked_YN equal to ‘Y’, UnSecured_Locked_YN equal to ‘Y’, Body_Scanner_Verified_YN equal to ‘Y’ and Body_Scanner_Approved_YN not equal to ‘Y’, the verification process would terminate with response type ‘DENY’ and response message ‘Exit through Holding Area’.

If the verification process is terminated, if the side of the door is ‘holding’ and if the response type is ‘DENY’ then the response type will be modified to ‘DENY-S’. If the verification process is terminated, if the side of the door is ‘holding’ and if the response type is ‘APPROVE’ then the response type will be modified to ‘APPROVE-S’.

If the verification process continues and the side of the door in the request message is ‘unsecured’ and current date and time minus Unsecured_Unlock_AuthCode_DateTime is more than a preset expiration level, then the verification process would terminate, with response type ‘DENY’ and response message ‘Time Expired’.

If the verification process continues and the side of the door in the request message is ‘secured’ and current date and time minus Secured_Unlock_AuthCode_DateTime is more than a preset expiration level, then the verification process would terminate, with response type ‘DENY’ and response message ‘Time Expired’.

If the verification process continues and the side of the door in the request message is ‘unsecured’ and Unsecured_Unlock_AuthCode is equal to authorization code in the request message, then the verification process would terminate, with response type ‘APPROVE’ and response message ‘Unlocked’. If the verification process continues and the side of the door in the request message is ‘secured’ and Secured_Unlock_AuthCode is equal to authorization code in the request message, then the verification process would terminate, with response type ‘APPROVE’ and response message ‘Unlocked’.

If the response type is equal to ‘APPROVE’ and the side of the door in the request message is ‘unsecured’, then the service provider 3-8 would update the latest row in the authorization code database 3-130 by setting the value for the field UnSecured_Unlocked_YN to ‘Y’. If the response type is equal to ‘APPROVE’ and the side of the door in the request message is ‘secured’, then the service provider 3-8 would update the latest row in the authorization code database 3-130 by setting the value for the field Secured_Unlocked_YN to ‘Y’. If the response type is equal to ‘APPROVE-S’ and the side of the door in the request message is ‘holding’, then the service provider 3-8 would update the latest row in the authorization code database 3-130 by setting the value for the field Holding_Unlocked_YN to ‘Y’ and the value for the field Holding_Unlocked_Datetime to the current date and time.

The response will be sent back to the microcontroller 3-73. If the microcontroller 3-73 receives a response with response type ‘APPROVE’ and if the side of the door is ‘unsecured’, then the microcontroller 3-73 would unlock the door 3-46. If the microcontroller 3-73 receives a response with response type ‘APPROVE’ and if the side of the door is ‘secured’, then the microcontroller 3-73 would unlock the door 3-59. If the microcontroller 3-73 receives a response with response type ‘APPROVE-S’ and if the side of the door is ‘holding’, then the microcontroller 3-73 would unlock the door 3-65. If the side of the door is ‘unsecured’, then the microcontroller 3-73 would display the response message received in the response in the display screen 3-49. If the side of the door is ‘secured’, then the microcontroller 3-73 would display the response message received in the response in the display screen 3-62. If the side of the door is ‘holding’, then the microcontroller 3-73 would display the response message received in the response in the display screen 3-68.

Lock Door:

To lock any door facing unsecured area, the end users 3-12 need to press the ‘LOCK’ button 3-53 from inside of the door. When ‘LOCK’ button is pressed, the microcontroller 3-73 would format a request message which consists of the command ‘LOCK’, dip switch 3-77 settings and/or serial number 3-78. Then the microcontroller 3-73 would forward the request message to the personal computer 3-92 through the network 3-91. Then the personal computer 3-92 would add check-point specific information like facility ID and security check-point ID to the request message and forward the said request message to the service provider 3-8 through the authorization gateway 3-132 as shown in FIGS. 3-25 and receive a response with response type and response message. The personal computer 3-92, would send the response back to the microcontroller through the network 3-91.

The service provider 3-8, in order to process the request message, would forward the request message to the request handler 3-121 to handle the request. The request handler 3-121 then verify the location information in the request message namely the facility ID and the check-point ID. If the facility ID and the check-point ID exists in the service client database 3-127 and if the current status is active then the request handler would forward the request message to authorizing agent 3-122, otherwise the verification process would terminate with response type ‘DENY’ and response message ‘Invalid Location’. The authorizing agent would verify the microcontroller information in the request message namely the dip switch settings 3-77 and/or serial number 3-78 using the body scanner chamber database 3-128. If the value for the field Identifier_Type in body scanner chamber database 3-128 as shown in FIG. 3-12 is ‘D’, then the authorizing agent would locate the scanner chamber number and the side of the door using the dip switch settings, otherwise the authorizing agent would locate the scanner chamber number and the side of the door using the serial number. If the authorizing agent could locate the scanner chamber number and the side of the door then the authorizing agent would add the scanner chamber number and the side of the door to the request message and forward the said request message to the validation tool 3-123, otherwise the verification process would terminate with response type ‘DENY-S’ and response message ‘Invalid scanner chamber and/or door’.

The validation tool, using the facility ID, check-point ID and body scanner chamber number from the request message, would get the latest row from the authorization code database 3-130.

If the side of the door in the request message is ‘unsecured’, then the verification process would continue, otherwise it would terminate, with response type ‘DENY’ and response message ‘Invalid request’.

If Document1_Scanned_YN_is equal to ‘Y’ then, verification process would continue, otherwise verification process would terminate with response type ‘DENY-S’ and with response message ‘Document Scanning is required’.

If the side of the door in the request message is ‘unsecured’ and if UnSecured_Unlocked_YN not equal to ‘Y’, then the verification process would terminate with response type ‘DENY-S’ and response message ‘Invalid request’.

If the side of the door in the request message is ‘unsecured’ and if UnSecured_Locked_YN equal to ‘Y’, then the verification process would terminate, with response type ‘DENY-S’ and response message ‘Invalid request’.

If the verification process continues and the side of the door in the request message is ‘unsecured’ and current date and time minus Unsecured_Unlock_AuthCode_DateTime is more than a preset expiration level, then the verification process would terminate, with response type ‘DENY-S’ and response message ‘Time Expired’.

If the verification process continues and the side of the door in the request message is ‘unsecured’ then the verification process would terminate, with response type ‘APPROVE-S’ and response message ‘Locked’.

If the response type is equal to ‘APPROVE-S’ and the side of the door in the request message is ‘unsecured’, then the service provider 3-8 would update the latest row in the authorization code database 3-130 by setting the value for the fields UnSecured_Locked_YN to ‘Y’.

The response will be sent back to the microcontroller 3-73. If the microcontroller 3-73 receives a response with response type ‘APPROVE-S’ then the microcontroller 3-73 would lock the door 3-46. The microcontroller 3-73 would display the response message received in the response, in the display screen 3-54.

Security Body Scan:

Once the end user 3-12 has entered into the security body scanner chamber and locked the door facing unsecured area from inside then the end users 3-12 would be ready for a body scan for security clearance. Body scan by security body scanners can be done just by pressing ‘B-SCAN’ button 3-55 by the end user 3-12, if ‘B-SCAN’ button 3-55 is accessible to end user 3-12. Alternatively, body scan by security body scanners can always be done by inspectors 3-10, just by pressing ‘B-SCAN’ button 3-55 through a remote switch from outside of the body scanner chamber. When ‘B-SCAN’ button is pressed the microcontroller 3-73 would request the security body scanner to scan the end user and get scanned images. Once the microcontroller 3-73 receives the scanned images from security body scanner, the microcontroller 3-73 would format a request message which consists of scanned images, command which is ‘B-SCAN’, dip switch 3-77 settings and/or serial number 3-78. Then the microcontroller 3-73 would forward the request message to the personal computer 3-92 through the network 3-91. Then the personal computer 3-92 would add check-point specific information like facility ID and security check-point ID to the request message and forward the said request message to the service provider 3-8 through the authorization gateway 3-132 as shown in FIG. 3-25. The service provider 3-8 would verify the request message and send a response back to the personal computer 3-92, which would send the response back to the microcontroller through the network 3-91.

The service provider 3-8, in order to process the request message, would forward the request message to the request handler 3-121 to handle the request. The request handler 3-121 then verify the location information in the request message namely the facility ID and the check-point ID. If the facility ID and the check-point ID exists in the service client database 3-127 and if the current status is active then the request handler would forward the request message to authorizing agent 3-122, otherwise the verification process would terminate with response type ‘DENY’ and response message ‘Invalid Location’. The authorizing agent would verify the microcontroller information in the request message namely the dip switch settings 3-77 and/or serial number 3-78 using the scanner chamber database 3-128. If the value for the field Identifier_Type in body scanner chamber database 3-128 as shown in FIG. 3-12 is ‘D’, then the authorizing agent would locate the scanner chamber number and the side of the door using the dip switch settings, otherwise the authorizing agent would locate the scanner chamber number and the side of the door using the serial number. If the authorizing agent could locate the scanner chamber number and the side of the door then the authorizing agent would add the scanner chamber number and the side of the door to the request message and forward the said request message to the validation tool 3-123, otherwise the verification process would terminate with response type ‘DENY-S’ and response message ‘Invalid scanner chamber and/or door’. If the side of the door is not ‘Unsecured’ then the verification process would terminate with response type ‘DENY’ and response message ‘Invalid door’.

The validation tool 3-123, using the facility ID, check-point ID and scanner chamber number from the request message, would get the latest row from the authorization code database 3-130. If UnSecured_Locked_YN is equal to ‘Y’ then, verification process would continue, otherwise verification process would terminate with response type ‘DENY-S’ and with response message ‘Scanner chamber has to be locked’. If Body_Scanned_YN is equal to ‘Y’ then, verification process would terminate with response type ‘DENY-S’ and with response message ‘Cannot Scan Again’. If verification process has not been terminated then, the service provider 3-8 would update the latest row by setting the value for the fields Body_Scanned_YN to ‘Y’, Body_Scanned_DateTime to current date and time, Body_Scanned_Image to the scanned images in the request message. If the verification process is not terminated, then the service provider 3-8 would terminate with response type ‘APPROVE-S’ and with response message ‘B-Scanned’.

The response will be sent back to the microcontroller 3-73. If the response type is ‘DENY-S’ or ‘APPROVE-S’ then the microcontroller 3-73 would display the response message received in the response, in the display screen 3-54. If the response type is ‘DENY’ then the microcontroller 3-73 would display the response message received in the response, in the display screen 3-49 or 3-62 or 3-68.

Approve/Deny End User Entry:

The inspectors 3-10 would access the form 3-105 as shown in FIG. 3-19. The inspectors 3-10 would enter facility ID, security check-point ID, inspector ID and password into a log in form 3-105L as shown in FIG. 3-19L. If the submitted credentials are valid then the service provider 3-8 would generally continue and present the form 3-19, otherwise it will terminate the process. Every time when the form 3-19 is opened, the service provider 3-8 would build the dropdown scanner chamber number list by accessing all latest rows based on facility ID, body scanner chamber ID and transaction number from authorization code database 3-130 where the value of the field Unsecured_Unlocked_YN is equal to ‘Y’, the value of the field Unsecured_Locked_YN is equal to ‘Y’ and the value of the field Document1_Scanned_YN_is ‘Y’. If dropdown scanner chamber number list count is greater than 0 then the inspectors would be able to select a scanner chamber number, otherwise a message will be displayed and inspectors 3-10 will not be able to select any scanner chamber number. When the inspectors 3-10 select a scanner chamber number from the dropdown list then the service provider 3-8 would update the form by accessing the latest row from authorization code database 3-130 based on facility ID, check-point ID, scanner chamber number and transaction number. If Body_Scanned_YN equal ‘N’ for any row in the list, then the inspector can perform a security body scan of the end users 3-12 in the security body scanner chamber, by pressing the ‘B-SCAN’ button 3-55 remotely and refresh the list.

If Document1_Scanned_YN_is equal to ‘Y’ then Driver's License field will be populated with the text ‘View Driver's License’, otherwise the said field will be populated with blank. If Document1_Verified_YN is equal to ‘Y’ then Driver's License Viewed filed will be populated with the text ‘Viewed’, otherwise the said field will be populated with blank. If Document2_Scanned_YN is equal to ‘Y’ then Boarding Pass field will be populated with the text ‘View Boarding Pass’, otherwise the said field will be populated with blank. If Document2_Verified_YN is equal to ‘Y’ then Boarding Pass Viewed filed will be populated with the text ‘Viewed’, otherwise the said field will be populated with blank. If Body_Scanned_YN is equal to ‘Y’ then Security Body Scanner field will be populated with the text ‘View Scanner Images’, otherwise the said field will be populated with blank. If Body_Scanner_Verified_YN is equal to ‘Y’ then Security Body Scanner Viewed filed will be populated with the text ‘Viewed’, otherwise the said field will be populated with blank. If Body_Scanner_Approved_YN is equal to ‘Y’ then Security Result field will be populated with the text ‘Approved’, otherwise if Body_Scanner_Approved_YN is equal to ‘N’ then Security Result field will be populated with the text ‘Denied’, otherwise the Security Result field will be populated with blank.

If Document1_Scanned_YN_is equal to ‘Y’ and if the inspectors 3-10 clicked on Driver's License field, then the service provider 3-8 would display the Document1_Scanned_Image and Document1_Read_Text on a pop-up window with options ‘DENY’ and ‘APPROVE’. If the inspectors 3-10 clicked on ‘DENY’ option in the pop-up window, then the service provider 3-8 would update the latest row in the authorization code database 3-130 based on facility ID, check-point ID, scanner chamber number and transaction number by setting the value for Document1_Verified_YN to ‘Y’ and setting the value for Document1_Approved_YN to ‘N’ and update the form 3-105 accordingly. If the inspectors 3-10 clicked on ‘APPROVE’ option in the pop-up window, then the service provider 3-8 would update the latest row in the authorization code database 3-130 based on facility ID, check-point ID, scanner chamber number and transaction number by setting the value for Document1_Verified_YN to ‘Y’ and setting the value for Document1_Approved_YN to ‘Y’ and update the form 3-105 accordingly.

If Document2_Scanned_YN is equal to ‘Y’ and if the inspectors 3-10 clicked on Boarding Pass field, then the service provider 3-8 would display the Document2_Scanned_Image and Document2_Read_Text on a pop-up window with options ‘DENY’ and ‘APPROVE’. If the inspectors 3-10 clicked on ‘DENY’ option in the pop-up window, then the service provider 3-8 would update the latest row in the authorization code database 3-130 based on facility ID, check-point ID, scanner chamber number and transaction number by setting the value for Document2_Verified_YN to ‘Y’ and setting the value for Document2_Approved_YN to ‘N’ and update the form 3-105 accordingly. If the inspectors 3-10 clicked on ‘APPROVE’ option in the pop-up window, then the service provider 3-8 would update the latest row in the authorization code database 3-131 based on facility ID, check-point ID, scanner chamber number and transaction number by setting the value for Document2_Verified_YN to ‘Y’ and setting the value for Document2_Approved_YN to ‘Y’ and update the form 3-105 accordingly.

If Body_Scanned_YN is equal to ‘Y’ and if the inspectors 3-10 clicked on Security Body Scanner field, then the service provider 3-8 would display the Body_Scanned_Image on a pop-up window with options ‘DENY’ and ‘APPROVE’. If the inspectors 3-10 clicked on ‘DENY’ option in the pop-up window, then the service provider 3-8 would update the latest row in the authorization code database 3-130 based on facility ID, check-point ID, scanner chamber number and transaction number by setting the value for Body_Scanner_Verified_YN to ‘Y’ and setting the value for Body_Scanner_Approved_YN to ‘N’ and setting the value for Security_Inspector_Id to inspector ID and update the form 3-105 accordingly. If the inspectors 3-10 clicked on ‘APPROVE’ option in the pop-up window, then the service provider 3-8 would update the latest row in the authorization code database 3-130 based on facility ID, check-point ID, scanner chamber number and transaction number by setting the value for Body_Scanner_Verified_YN to ‘Y’ and setting the value for Body_Scanner_Approved_YN to ‘Y’ and setting the value for Security_Inspector_Id to inspector ID and update the form 3-105 accordingly.

1. An authorization system for authorizing access to secured electronic storage boxes, said authorizing system comprising:
a uniquely identifiable electronic storage station with one or more uniquely identifiable electronic storage boxes with one or more uniquely identifiable and remotely controlled electronic doors accessible to one or more master requestors and to one or more sub requestors;
wherein said uniquely identifiable electronic storage box is used to pass goods from master requestors to sub requestors;
an authorization gateway having first of instructions embodied in a computer readable medium, said first set of instructions operable to receive requests from said remotely controlled electronic doors;
a server in communication with said authorization gateway having second set of instructions embodied in a computer readable medium to determine, from the said requests, the identity of the said uniquely identifiable electronic storage station, the identity of the said uniquely identifiable electronic storage box, the identity of the said uniquely identifiable and remotely controlled electronic door, and a command and an authorization code;
wherein said second set of instructions is further operable to evaluate the said identity of the said uniquely identifiable electronic storage station, the said identity of the said uniquely identifiable electronic storage box, the said identity of the said uniquely identifiable and remotely controlled electronic door, the validity of the said command, and the validity of the said authorization code, and based on the evaluation to direct the said uniquely identifiable and remotely controlled electronic door to lock or unlock or make no changes;
a service user interface in communication with said server, said service user interface having third set of instructions embodied in a computer readable medium operable to receive user inputs from said master requestors;
wherein said third set of instructions is further operable to let said master requestors to establish master authorization codes; and
wherein said third set of instructions is further operable to let said master requestors to establish a one-time authorization code for any said uniquely identifiable electronic storage boxes within any said uniquely identifiable electronic storage stations.

2. A one-time authorization credential delivery system for delivering a one-time authorization credential in multiple pieces, said one-time authorization credential delivery system comprising:
a uniquely identifiable electronic storage box which require at least two pieces of information for a sub entity to claim goods from the said uniquely identifiable electronic storage box used for passage of goods from a master entity to a sub entity;
wherein the said master entity does not have contact information of the said sub entity;
wherein the said two pieces of information are a one-time access code to open only one time the said uniquely identifiable electronic storage box and the identification number of the said uniquely identifiable electronic storage box to locate the said uniquely identifiable electronic storage box;
wherein only one piece of information of the said two pieces of information would be readily available at the time the contract between the master entity and the sub entity for passage of goods from master entity to sub entity is concluded;
wherein the delivery to said sub entity of first piece of information of the said two pieces of information cannot wait until the second piece of information of the said two pieces of information is available to said master entity;
wherein a common identifier which is not a piece of information in the said two pieces of information is available with the said first piece of information of the said two pieces of information;
wherein the said common identifier can be included in the delivery by master entity to sub entity of the said first piece of information of the said two pieces of information;
wherein the contact between the said master entity and said sub entity is not possible after the said delivery of said common identifier and the said first piece of information of the said two pieces of information;
wherein the said common identifier can also be included when the said second piece of information of the said two pieces of information is available and posted by said master entity on a publicly visible medium and said publicly visible medium is viewable by sub entity.

3. A method for authorizing access to a secured electronic storage box, said method for authorizing comprising the steps of:
Having a uniquely identifiable electronic storage station with one or more uniquely identifiable electronic storage boxes with one or more uniquely identifiable and remotely controlled electronic doors accessible to one or more master requestors and to one or more sub requestors;
wherein said uniquely identifiable electronic storage box is used to pass goods from master requestors to sub requestors;
receiving at an authorization gateway having first of instructions embodied in a computer readable medium, said first set of instructions operable to receive requests from said remotely controlled electronic doors;
processing requests with a server in communication with said authorization gateway having second set of instructions embodied in a computer readable medium to determine, from the said requests, the identity of the said uniquely identifiable electronic storage station, the identity of the said uniquely identifiable electronic storage box, the identity of the said uniquely identifiable and remotely controlled electronic door, a command, and an authorization code;
wherein said second set of instructions is further operable to evaluate the said identity of the said uniquely identifiable electronic storage station, the said identity of the said uniquely identifiable electronic storage box, the said identity of the said uniquely identifiable and remotely controlled electronic door, the validity of the said command, and the validity of the said authorization code and based on the evaluation to direct the said uniquely identifiable and remotely controlled electronic door to lock or unlock or make no changes;
having a service user interface in communication with said server, said service user interface having third set of instructions embodied in a computer readable medium operable to receive user inputs from said master requestors;
wherein said third set of instructions is further operable to let said master requestors to establish master authorization codes; and
wherein said third set of instructions is further operable to let said master requestors to establish a one-time authorization code for any said uniquely identifiable electronic storage boxes within any said uniquely identifiable electronic storage stations.

4. A method for delivering a one-time authorization credential in two or more pieces, said method of delivery comprising the steps of:
having a uniquely identifiable electronic storage box which require at least two pieces of information for a sub entity to claim goods from the said uniquely identifiable electronic storage box used for passage of goods from a master entity to a sub entity;
wherein the said master entity does not have contact information of the said sub entity;
wherein the said two pieces of information are a one-time access code to open only one time the said uniquely identifiable electronic storage box and the identification number of the said uniquely identifiable electronic storage box to locate the said uniquely identifiable electronic storage box;
wherein only one piece of information of the said two pieces of information would be readily available at the time the contract between the master entity and the sub entity for passage of goods from master entity to sub entity is concluded;
wherein the delivery to said sub entity of first piece of information of the said two pieces of information cannot wait until the second piece of information of the said two pieces of information is available to said master entity;
wherein a common identifier which is not a piece of information in the said two pieces of information is available with the said first piece of information of the said two pieces of information;
wherein the said common identifier can be included in the delivery by master entity to sub entity of the said first piece of information of the said two pieces of information;
wherein the contact between the said master entity and said sub entity is not possible after the said delivery of said common identifier and the said first piece of information of the said two pieces of information; and
wherein the said common identifier can also be included when the said second piece of information of the said two pieces of information is available and posted by said master entity on a publicly visible medium and said publicly visible medium is viewable by sub entity.

5. A self-service goods security clearance system for passage of goods from unsecured area to secured area of security check points, said self-service goods security clearance system comprising:
one or more uniquely identifiable self-service goods security clearance stations with one or more uniquely identifiable self-service goods security clearance scanner chambers and each said uniquely identifiable self-service goods security clearance scanner chamber having one or more uniquely identifiable and remotely controlled electronic doors facing unsecured area, each said door having one or more electronic document scanners and/or readers and one or more electronic security x-ray scanners, one or more uniquely identifiable and remotely controlled electronic doors facing secured area and accessible to one or more security inspectors and to one or more users passing goods from unsecured area to secured area of security check points;
wherein said uniquely identifiable self-service goods security clearance scanner chambers are used to pass goods from unsecured area to secured area of security check points;
an authorization gateway having first of instructions embodied in a computer readable medium, said first set of instructions operable to receive request messages from said uniquely identifiable and remotely controlled electronic doors;
a server in communication with said authorization gateway having second set of instructions embodied in a computer readable medium to determine, from the content of the request messages, the identity of uniquely identifiable self-service goods security clearance station, the identity of uniquely identifiable self-service goods security clearance scanner chamber, the identity of uniquely identifiable and remotely controlled electronic door, a command, content of electronically scanned document images, content of electronically read document texts, content of electronically scanned x-ray images and content of authorization code;
wherein said second set of instructions is further operable to evaluate the identity of the said determined uniquely identifiable self-service goods security clearance station, the identity of the said determined uniquely identifiable self-service goods security clearance scanner chamber, the identity of the said determined uniquely identifiable and remotely controlled electronic door, the said determined command, the said determined electronically scanned document images, the said determined electronically read document texts, the said determined electronically scanned x-ray images, the said determined content of authorization code, and based on the evaluation, process the request and/or save data and/or direct the uniquely identifiable and remotely controlled electronic door to lock or unlock or not to take any action;
a service user interface in communication with said server, said service user interface having third set of instructions embodied in a computer readable medium operable to receive user inputs from said security inspectors;
wherein said third set of instructions is further operable to let said security inspectors to establish master authorization codes; and
wherein said third set of instructions is further operable to let security inspectors to view, examine said saved electronically scanned document images, said saved electronically read document texts, said saved electronically scanned x-ray images and approve or deny passage of said goods from unsecured area to secured area of security check points.

6. A method for providing a self-service security clearance for passage of goods from unsecured area to secured area of security check points said self-service security clearance comprising the steps of:
having a uniquely identifiable self-service goods security clearance station with one or more uniquely identifiable self-service goods security clearance scanner chambers and each said uniquely identifiable self-service goods security clearance scanner chamber having one or more uniquely identifiable and remotely controlled electronic doors facing unsecured area, each said door having one or more electronic document scanners and/or readers and one or more electronic security x-ray scanners, one or more uniquely identifiable and remotely controlled electronic doors facing secured area and accessible, to one or more security inspectors and to one or more users passing goods from unsecured area to secured area of security check points;
wherein said uniquely identifiable self-service goods security clearance scanner chambers are used to pass goods from unsecured area to secured area of security check points;
receiving at an authorization gateway having first of instructions embodied in a computer readable medium, said first set of instructions operable to receive requests from said identifiable and remotely controlled electronic doors;
processing said requests with a server in communication with said authorization gateway having second set of instructions embodied in a computer readable medium to determine, from the said requests, the identity of the said uniquely identifiable self-service security clearance station, the identity of the said uniquely identifiable self-service security clearance scanner chamber, the identity of the said uniquely identifiable and remotely controlled electronic door, the command, the content of electronically scanned document images, the content of electronically read document texts, the content of electronically scanned x-ray images, and the content of authorization code;
wherein said second set of instructions is further operable to evaluate the said determined identity of the said uniquely identifiable self-service security goods clearance station, the said determined identity of the said uniquely identifiable self-service security goods clearance scanner chamber, the said determined identity of the said uniquely identifiable and remotely controlled electronic door, the said determined command, the said determined electronically scanned document images, the said determined electronically read document texts, the said determined electronically scanned x-ray images, the said determined content of authorization code, and based on the evaluation, process the request and/or save data and/or direct the said uniquely identifiable and remotely controlled electronic door to lock or unlock or not to take any action;
having a service user interface in communication with said server, said service user interface having third set of instructions embodied in a computer readable medium operable to receive user inputs from said security inspectors;
wherein said third set of instructions is further operable to let said security inspectors to establish master authorization codes;
wherein said third set of instructions is further operable to let said security inspectors to view, examine said saved electronically read document images, electronically read document texts, electronically scanned x-ray images and approve or deny passage of said goods from unsecured area to secured area of security check points.

7. A self-service security clearance system for user admission from unsecured area to secured area of security check points, said self-service security clearance system comprising:
one or more uniquely identifiable self-service security clearance stations with one or more uniquely identifiable self-service security clearance scanner chambers and each said uniquely identifiable self-service security clearance scanner chamber having
one or more uniquely identifiable and remotely controlled electronic doors having one or more electronic document scanners and/or readers and one or more electronic security body scanners and facing unsecured area,
one or more uniquely identifiable and remotely controlled electronic doors facing secured area and
one or more uniquely identifiable and remotely controlled electronic doors facing holding area
accessible, to one or more security inspectors and to one or more users requesting admission through said uniquely identifiable self-service security clearance scanner chambers from unsecured area to secured area of security check points;
wherein said uniquely identifiable self-service security clearance scanner chambers are used to admit users to move from unsecured area to secured area of security check points;
an authorization gateway having first of instructions embodied in a computer readable medium, said first set of instructions operable to receive request messages from said uniquely identifiable and remotely controlled electronic doors;
a server in communication with said authorization gateway having second set of instructions embodied in a computer readable medium to determine, from the content of the request messages,
the identity of uniquely identifiable self-service security clearance station, the identity of uniquely identifiable security self-service clearance scanner chamber,
the identity of uniquely identifiable and remotely controlled electronic door,
command,
content of electronically scanned document images,
content of electronically read document texts,
content of electronically scanned body images and
content of authorization code;
wherein said second set of instructions is further operable to evaluate
the identity of the said determined uniquely identifiable self-service security clearance station,
the identity of the said determined uniquely identifiable self-service security clearance scanner chamber,
the identity of the said determined uniquely identifiable and remotely controlled electronic door,
the said determined command,
the said determined electronically scanned document images,
the said determined electronically read document texts,
the said determined electronically scanned body images,
the said determined content of authorization code
and based on the evaluation, process the request and/or save data and/or direct the uniquely identifiable and remotely controlled electronic door to lock or unlock or not to take any action;
a service user interface in communication with said server, said service user interface having third set of instructions embodied in a computer readable medium operable to receive user inputs from said security inspectors;
wherein said third set of instructions is further operable to let said security inspectors to establish master authorization codes; and
wherein said third set of instructions is further operable to let security inspectors to view, examine said saved electronically scanned document images, said saved electronically read document texts and said saved electronically scanned body images and approve or deny admissions from unsecured area to secured area of security check points.

8. A method for providing a self-service security clearance for admission from unsecured area to secured area of security check points, said self-service security clearance comprising the steps of:
having a uniquely identifiable self-service security clearance station with one or more uniquely identifiable self-service security clearance scanner chambers and each said uniquely identifiable self-service security clearance scanner chamber having
one or more uniquely identifiable and remotely controlled electronic doors with one or more document scanners and/or readers and one or more security body scanners and facing unsecured area,
one or more uniquely identifiable and remotely controlled electronic doors facing secured area,
one or more uniquely identifiable and remotely controlled electronic doors facing holding area and
accessible, to one or more security inspectors and to one or more users requesting admission, from unsecured to secured area of security check points;
wherein said uniquely identifiable self-service security clearance scanner chambers are used to admit users from unsecured area to secured area of security check points;
receiving at an authorization gateway having first of instructions embodied in a computer readable medium, said first set of instructions operable to receive requests from said identifiable and remotely controlled electronic doors;
processing said requests with a server in communication with said authorization gateway having second set of instructions embodied in a computer readable medium to determine, from the said requests,
the identity of the said uniquely identifiable self-service security clearance station,
the identity of the said uniquely identifiable self-service security clearance scanner chamber,
the identity of the said uniquely identifiable and remotely controlled electronic door,
the command,
the content of electronically scanned document images,
the content of electronically read document texts,
the content of electronically scanned body images and
the content of authorization code;
wherein said second set of instructions is further operable to evaluate
the said determined identity of the said uniquely identifiable self-service security clearance station,
the said determined identity of the said uniquely identifiable self-service security clearance scanner chamber,
the said determined identity of the said uniquely identifiable and remotely controlled electronic door,
the said determined command,
the said determined electronically scanned document images,
the said determined electronically read document texts,
the said determined electronically scanned body images,
the said determined content of authorization code, and based on the evaluation, process the request and/or save data and/or direct the said uniquely identifiable and remotely controlled electronic door to lock or unlock or not to take any action;
having a service user interface in communication with said server, said service user interface having third set of instructions embodied in a computer readable medium operable to receive user inputs from said security inspectors;
wherein said third set of instructions is further operable to let said security inspectors to establish master authorization codes; and
wherein said third set of instructions is further operable to let said security inspectors to view, examine said saved electronically read document images, electronically read document texts and electronically scanned body images and approve or deny admissions from unsecured area to secured area of security check points.
